(19) United States
(12) Patent Application Publication
(10) Pub. No.: US 2025/0178774 A1
(43) Pub. Date: Jun. 5, 2025

(54) DIMENSIONALLY STABLE FOODSTUFF CONTAINER WITH FOLDED PLANAR COMPOSITE, ELEMENT OTHER THAN THE FOLDED PLANAR COMPOSITE, FIRST AND SECOND WALL REGIONS

(71) Applicant: SIG Services AG, Neuhausen am Rheinfall (CH)

(72) Inventors: Thomas Keck, Aachen (DE); Remo Zürcher, Suzhou (CN); Jannis Ochsmann, Heusweiler (DE)

(21) Appl. No.: 18/846,203

(22) PCT Filed: Mar. 11, 2022
(86) PCT No.: PCT/CN2022/080345

§ 371 Date: Sep. 11, 2024

(51) Int. Cl. B65D 5/42; B65D 5/74

(52) U.S. Cl. CPC B65D 5/4279; B65D 5/746

(57) ABSTRACT

The invention pertains to a container comprising a folded planar composite and an element other than the folded planar composite, wherein the folded planar composite comprises a carrier layer, and together with the element forms a container wall, which comprises first and second wall regions; wherein the first wall region comprises first to third plies of the composite; wherein the second ply is joined to the third ply in the first wall region; wherein the second wall region comprises the first to third plies; wherein the first ply is joined to the second ply, which is joined to the third ply in the second wall region; wherein the carrier layer in the first wall region has a greater layer thickness in the third ply than in the first or second ply; wherein the carrier layer in the second wall region has a smaller layer thickness in the second ply than in the first or third ply; wherein the first ply on its inner side is joined to the element other than the folded planar composite in the first or second wall region. The invention further pertains to a process of making a container and to a use of a container precursor and an element other than the folded planar composite.

The present invention refers to a container comprising
a folded planar composite, and
an element other than the folded planar composite;
   wherein the folded planar composite
comprises a carrier layer, and
together with the element other than the folded planar composite forms a container wall at least partially surrounding a container interior;
   wherein the container wall comprises a first wall region and a second wall region; wherein the first wall region comprises, as superimposed layers of a first layer sequence in a direction outward from the container interior, a first ply of the folded planar composite, a second ply of the folded planar composite, and a third ply of the folded planar composite; wherein the second ply is joined to the third ply in the first wall region; wherein the second wall region comprises, as superimposed layers of a second layer sequence in the direction outward from the container interior, the first ply, the second ply, and the third ply; wherein the first ply is joined to the second ply in the second wall region and the second ply is joined to the third ply in the second wall region; wherein the carrier layer in the first wall region has a greater layer thickness in the third ply than in the first ply, or than in the second ply, or than in each of them; wherein the carrier layer in the second wall region has a smaller layer thickness in the second ply than in the first ply, or than in the third ply, or than in each of them; wherein the first ply on its inner side facing the container interior is joined to the element other than the folded planar composite in the first wall region, or in the second wall region, or in each of these two. The invention further pertains to a process of making a container and to a use of a container precursor and an element other than the folded planar composite.

For some time, foodstuffs have been preserved, whether they be foodstuffs for human consumption or else animal feed products, by storing them either in a can or in ajar closed by a lid. In this case, shelf life can be increased firstly by separately and very substantially sterilising the foodstuff and the container in each case, here the jar or can, and then introducing the foodstuff into the container and closing the container. However, these measures of increasing the shelf life of foodstuffs, which have been tried and tested over a long period, have a series of disadvantages, for example the need for another sterilisation later on. Cans and jars, because of their essentially cylindrical shape, have the disadvantage that very dense and space-saving storage is not possible. Moreover, cans and jars have considerable intrinsic weight, which leads to increased energy expenditure in transport. Moreover, production of glass, tinplate or aluminium, even when the raw materials used for the purpose are recycled, necessitates quite a high expenditure of energy. In the case of jars, an aggravating factor is elevated expenditure on transport. The jars are usually prefabricated in a glass factory and then have to be transported to the facility where the foodstuff is dispensed with utilisation of considerable transport volumes. Furthermore, jars and cans can be opened only with considerable expenditure of force or with the aid of tools and hence in a rather laborious manner. In the case of cans, there is a high risk of injury emanating from sharp edges that arise on opening. In the case of jars, it is a repeated occurrence that broken glass gets into the foodstuff in the course of filling or opening of the filled jars, which can lead in the worst case to internal injuries on consumption of the foodstuff. In addition, both cans and jars have to be labelled for identification and promotion of the foodstuff contents. The jars and cans cannot be printed directly with information and promotional messages. In addition to the actual printing, a substrate is thus needed for the purpose, a paper or suitable film, as is a securing means, an adhesive or sealant.

Other packaging systems are known from the prior art, in order to store foodstuffs over a long period with minimum impairment. These are containers made of planar or sheet-like composites, which are often also referred to as laminates. Such laminates are often composed of a thermoplastic layer, a carrier layer often made of cardboard or paper, which gives the container dimensional stability, an adhesion promoter layer, a barrier layer and another plastic layer. Since the carrier layer gives the container made from the laminate dimensional stability, these containers, in contrast to film bags and pouches, are to be seen as a further development of the aforementioned jars and cans.

Although such foodstuff containers made from laminates can be produced and filled in the same machine and thus in one production run, there remains a transport effort for supplying the retail trade with the filled containers. Various disadvantages of the prior art containers have arisen in the context of this long-distance transport.

In preparing the preceding foodstuff containers, the laminate is folded multiple times, with opposite ends of the laminate being sealed one on top of the other to form, in the first instance, a shell- or tube-shaped precursor of a closed container. The end areas sealed one on top of the other form a longitudinal seam, which is also present in the container. Both on the inside and on the outside of the container this longitudinal seam comprises cut edges of the laminate through which moisture can penetrate into the layer structure of the laminate, in particular the carrier layer often consisting of cardboard or paper. On the inside of the longitudinal seam, the ingress of moisture must be prevented because the container is designed to contain food which includes water. For this purpose, in the prior art, the margin which includes the inner laminate edge is often skived and hem-sealed. The hem-seal protects the inner cut edge of the longitudinal seam from moisture.

For containers, the container wall of which consists solely of one piece of laminate, ingress of moisture on the outer side of the longitudinal seam is often not that crucial for the performance of the containers. This is different for containers which, in addition to the laminate and as part of the container wall, include a further component, such as an injection moulded component, which is sealed or glued to a margin of the laminate. Here, the preceding margin includes a cut edge of the laminate. At this cut edge, a section through the longitudinal seam of the container is exposed to the environment. In that case, ingress of moisture in combination with the vibrations, which the containers experience during long-distance transport on the road, has been observed to have a detrimental effect on the tightness and, thus, shelf life of the containers.

In addition, in order to render the transport to retailers as efficient as possible, it is desirable to be able to stack as many containers as possible in one pack, i.e., with as little reinforcing transport material as possible. This stackability is limited by the compression stability of the containers, i.e., by the maximum weight that can be placed on a container without its mechanical integrity failing due to compression. In the prior art, this limit often means that existing transport volumes cannot be used efficiently.

In general, it is an object of the present invention to at least partly overcome a disadvantage arising from the prior art.

A further object of the invention is to provide a dimensionally stable foodstuff container made of laminate which is characterised by an improved shelf life, in particular after long-distance transport of the container on the road.

A further object of the invention is to provide a dimensionally stable foodstuff container made of laminate which, in particular through good stacking behaviour, allows the most efficient utilisation of transport volumes when supplying such foodstuff containers.

Furthermore, it is an object of the invention to provide a dimensionally stable foodstuff container made of laminate, which can be produced in large quantities with as few production interruptions as possible in a filling machine.

According to another object of the invention, one of the above-described advantageous foodstuff containers is particularly suitable for stationary household use, in particular due to its relatively large capacity. According to another object of the invention, one of the above-described advantageous foodstuff containers is particularly suitable for mobile use, especially due to its good grip stiffness.

In accordance with a further object of the invention, one of the advantageous foodstuff containers described above is additionally characterised by good standing stability of the individual container.

A contribution to at least partly fulfilling at least one, preferably more than one, of the abovementioned objects is made by any of the embodiments of the invention.

A 1^{st} embodiment of the invention is a container comprising
a folded planar composite, and
an element other than the folded planar composite;
   wherein the folded planar composite
comprises a carrier layer, and
together with the element other than the folded planar composite forms a container wall at least partially, preferably completely, surrounding a container interior;
   wherein the container wall comprises a first wall region and a second wall region; wherein the first wall region comprises, preferably consists of, as superimposed layers of a first layer sequence in a direction outward from the container interior, a first ply of the folded planar composite, a second ply of the folded planar composite, and a third ply of the folded planar composite; wherein the second ply is joined to the third ply in the first wall region; wherein the second wall region comprises, preferably consists of, as superimposed layers of a second layer sequence in the direction outward from the container interior, the first ply, the second ply, and the third ply; wherein the first ply is joined to the second ply in the second wall region and the second ply is joined to the third ply in the second wall region; wherein the carrier layer in the first wall region has a greater layer thickness in the third ply than in the first ply, or than in the second ply, or than in each of them; wherein the carrier layer in the second wall region has a smaller layer thickness in the second ply than in the first ply, or than in the third ply, or than in each of them; wherein the first ply on its inner side facing the container interior is joined to the element other than the folded planar composite in the first wall region, or in the second wall region, or in each of these two.

Preferably, the container according to the invention is one selected from the group, consisting of a closed container, a foodstuff container, a dimensionally stable container, and a liquid-tight container, or a combination at least two thereof.

In a preferred embodiment of the container the folded planar composite additionally comprises an inner polymer layer; wherein the inner polymer layer superimposes the carrier layer on a first side of the carrier layer such that the inner polymer layer faces the container interior in the first ply and in the third ply relative to the carrier layer. This preferred embodiment is a 2^{nd} embodiment of the invention, that preferably depends on the 1^{st} embodiment of the invention.

In a further preferred embodiment of the container the folded planar additionally comprises a barrier layer; wherein the barrier layer superimposes the carrier layer on a first side of the carrier layer such that the barrier layer faces the container interior in the first ply and in the third ply with respect to the carrier layer. This preferred embodiment is a 3^{rd} embodiment of the invention, that preferably depends on the 1^{st} or 2^{nd} embodiment of the invention.

In a further preferred embodiment of the container the barrier layer is arranged between the carrier layer and the inner polymer layer. This preferred embodiment is a 4^{th} embodiment of the invention, that preferably depends on the 3^{rd} embodiment of the invention.

In a further preferred embodiment of the container the folded planar composite additionally comprises an outer polymer layer; wherein the outer polymer outer layer superimposes the carrier layer on a further side of the carrier layer such that the outer polymer layer in the third ply faces away from the container interior relative to the carrier layer. This preferred embodiment is a 5^{th} embodiment of the invention, that preferably depends on any one of the preceding embodiments of the invention.

Preferably, the outer polymer layer is adjacent to the carrier layer. The outer polymer layer preferably comprises at least 50% by weight, preferably at least 60% by weight, more preferably at least 70% by weight, even more preferably at least 80% by weight, most preferably at least 90% by weight, in each case based on the weight of the outer polymer layer, of a polyolefin, preferably a polyethylene or a polypropylene or both. Preferably, the outer polymer layer is an outermost layer of the planar composite. This means that in no ply of the planar composite a layer of this ply of the planar composite superimposes the outer polymer layer on its side facing away from the carrier layer.

In a further preferred embodiment of the container the outer polymer layer comprises at least 50% by weight, preferably at least 60% by weight, more preferably at least 70% by weight, even more preferably at least 80% by weight, most preferably at least 90% by weight, each based on the weight of the outer polymer layer, of an LDPE. This preferred embodiment is a 6^{th} embodiment of the invention, that preferably depends on the 5^{th} embodiment of the invention.

In a further preferred embodiment of the container the folded planar composite additionally comprises an intermediate polymer layer; wherein the intermediate polymer is arranged between the carrier layer and barrier layer. This preferred embodiment is a 7^{th} embodiment of the invention, that preferably depends on any one of the 3^{rd} to 6^{th} embodiments of the invention.

In a further preferred embodiment of the container the folded planar composite additionally comprises a colour application; wherein the colour application superimposes the carrier layer on a further side of the carrier layer such that the colour application in the third ply faces away from the container interior with respect to the carrier layer. This preferred embodiment is an 8^{th} embodiment of the invention, that preferably depends on any one of the preceding embodiments of the invention.

Preferably, the colour application is adjacent to the carrier layer. Alternatively or additionally preferred, the colour application is adjacent to the outer polymer layer. A preferred colour application is a printed colour application. Preferably, the colour application comprises at least one colourant, more preferably at least 2, more preferably at least 3, more preferably at least 4, still more preferably at least 5, most preferably at least 6, colourants. The aforementioned colourants preferably each have different colours. Preferably, the colour application comprises at least 4% by weight, more preferably at least 6% by weight, more preferably at least 8% by weight, in each case based on the weight of the colour application, of at least one colourant.

In a further preferred embodiment of the container the colour application superimposes the outer polymer layer on a side of the outer polymer layer facing away from the carrier layer. This preferred embodiment is a 9^{th} embodiment of the invention, that preferably depends on the 8^{th} embodiment of the invention.

Preferably, the colour application is not superimposed by any layer of the same ply of the folded planar composite on its side facing away from the outer polymer layer. Alternatively or additionally preferred, the colour application is printed on the outer polymer layer.

In a further preferred embodiment of the container the colour application is arranged between the carrier layer and the outer polymer layer. This preferred embodiment is a 10^{th} embodiment of the invention, that preferably depends on the 8^{th} embodiment of the invention. Preferably, the colour application is printed on the carrier layer.

In a further preferred embodiment of the container an inner side of the folded planar composite
in the first ply faces the container interior,
in the second ply faces away from the container interior, and
in the third ply faces the container interior.

This preferred embodiment is an 11^{th} embodiment of the invention, that preferably depends on any one of the preceding embodiments of the invention.

In a further preferred embodiment of the container one selected from the group consisting of the inner polymer layer, the intermediate polymer layer, and the outer polymer layer, or a combination of at least two thereof, comprises, preferably consists of, a polyolefin, preferably a polyethylene or a polypropylene or a mixture of both. This preferred embodiment is a 12^{th} embodiment of the invention, that preferably depends on any one of the 2^{nd} to 11^{th} embodiments of the invention.

Preferably one selected from the group consisting of the inner polymer layer, the intermediate polymer layer, and the outer polymer layer, or a combination of at least two thereof, comprises the polyolefin, preferably the polyethylene or the polypropylene or a blend thereof, in a proportion of at least 50% by weight, preferably at least 60% by weight, more preferably at least 70% by weight, even more preferably at least 80% by weight, most preferably at least 90% by weight, in each case based on the weight of the respective layer.

In a further preferred embodiment of the container the carrier layer comprises, preferably consists of, one selected from the group consisting of cardboard, paperboard, and paper, or a combination of at least two thereof. This preferred embodiment is a 13^{th} embodiment of the invention, that preferably depends on any one of the preceding embodiments of the invention.

The terms “cardboard”, “paperboard” and “paper” are used herein according to the definitions in the standard DIN 6735:2010. Additionally, paperboard is preferably a material that has a combination of properties of paperboard and paper. Further, cardboard preferably has a basis weight in a range of 150 to 600 g/m².

In a further preferred embodiment of the container the barrier layer comprises, preferably consists of, one selected from the group consisting of a plastic, a metal, and a metal oxide, or a combination of at least two thereof. This preferred embodiment is a 14^{th} embodiment of the invention, that preferably depends on any one of the 3^{rd} to 13^{th} embodiments of the invention.

In a further preferred embodiment of the container the container contains a foodstuff. This preferred embodiment is a 15^{th} embodiment of the invention, that preferably depends on any one of the preceding embodiments of the invention.

In a further preferred embodiment of the container the folded planar composite has at least 2 folds, preferably at least 3 folds, more preferably at least 4 folds. This preferred embodiment is a 16^{th} embodiment of the invention, that preferably depends on any one of the preceding embodiments of the invention.

In a further preferred embodiment of the container wherein the folded planar composite comprises a first longitudinal margin and a further longitudinal margin opposite the first longitudinal margin in a circumferential direction of the container perpendicular to the length of the container; wherein the first longitudinal margin is joined to the further longitudinal margin to form a longitudinal seam of the container. This preferred embodiment is a 17^{th} embodiment of the invention, that preferably depends on any one of the preceding embodiments of the invention.

Preferably, the first longitudinal margin is joined to the further longitudinal margin in the first wall region and the second wall region, or in the first wall region, the second wall region and the third wall region, forming the longitudinal seam of the container.

In a further preferred embodiment of the container the container interior has a capacity in a range of from 100 to 2000 ml, preferably from 100 to 1500 ml, more preferably from 100 to 1200 ml, more preferably from 100 to 1000 ml, more preferably from 100 to 900 ml, more preferably from 100 to 800 ml, more preferably from 100 to 700 ml, more preferably from 100 to 600 ml, more preferably from 100 to 500 ml, more preferably from 100 to 480 ml, more preferably from 100 to 460 ml, more preferably from 100 to 440 ml, more preferably from 100 to 420 ml, more preferably from 100 to 400 ml, more preferably from 100 to 380 ml, more preferably from 100 to 360 ml, more preferably from 110 to 360 ml, more preferably from 120 to 360 ml, more preferably from 130 to 360 ml, more preferably from 140 to 360 ml, more preferably from 150 to 360 ml, more preferably from 160 to 360 ml, still more preferably from 170 to 360 ml. This preferred embodiment is an 18^{th} embodiment of the invention, that preferably depends on any one of the preceding embodiments of the invention.

Further preferably, the container interior has a capacity in a range from 150 to 2000 ml, more preferably from 200 to 2000 ml, more preferably from 250 to 2000 ml, more preferably from 300 to 2000 ml, more preferably from 350 to 2000 ml, more preferably from 400 to 2000 ml, more preferably from 420 to 2000 ml, more preferably from 440 to 2000 ml, more preferably from 460 to 2000 ml, more preferably from 480 to 2000 ml, more preferably from 480 to 1800 ml, more preferably from 480 to 1600 ml, more preferably from 480 to 1400 ml, more preferably from 480 to 1200 ml, most preferably from 480 to 1150 ml, more preferably from 480 to 1100 ml, still more preferably from 490 to 1100 ml.

In a further preferred embodiment of the container the first wall region is adjacent to the second wall region. This preferred embodiment is a 19^{th} embodiment of the invention, that preferably depends on any one of the preceding embodiments of the invention.

In a further preferred embodiment of the container wherein the layer thickness of the carrier layer in the first ply is smaller in the first wall region than in the second wall region. This preferred embodiment is a 20^{th} embodiment of the invention, that preferably depends on any one of the preceding embodiments of the invention.

Preferably, the layer thickness of the carrier layer in the first ply in the first wall region is 0.05 to 0.9-times, preferably 0.1 to 0.85-times, more preferably 0.2 to 0.85-times, more preferably 0.3 to 0.85-times, more preferably 0.4 to 0.85-times, even more preferably 0.5 to 0.8-times, most preferably 0.6 to 0.75-times, as great as in the second wall region. Alternatively or additionally preferred, the layer thickness of the carrier layer in the first ply in the second wall region is 1.1 to 20-times, preferably 1.1 to 15-times, more preferably 1.1 to 10-times, more preferably 1.1 to 5-times, more preferably 1.1 to 3-times, more preferably 1.1 to 2-times, more preferably 1.2 to 1.9-times, still more preferably 1.1 to 1.8-times, most preferably 1.2 to 1.7-times, as great as in the first wall region.

In a further preferred embodiment of the container a minimum layer thickness of the carrier layer in the first wall region in one selected from the group consisting of the first ply, the second ply, and the third ply, or in each ply of a combination of at least two of the foregoing plies, is not more than 50%, preferably not more than 40%, more preferably not more than 30%, most preferably not more than 20%, most preferably not more than 10%, smaller than a maximum layer thickness of the carrier layer in the same ply of the first wall region, based on said maximum layer thickness. This preferred embodiment is a 21^{st} embodiment of the invention, that preferably depends on any one of the preceding embodiments of the invention.

In a further preferred embodiment of the container a minimum layer thickness of the carrier layer in the second wall region in one selected from the group consisting of the first ply, the second ply, and the third ply, or in each ply of a combination of at least two of the foregoing plies, is not more than 50%, preferably not more than 40%, more preferably not more than 30%, most preferably not more than 20%, most preferably not more than 10%, smaller than a maximum layer thickness of the carrier layer in the same ply of the second wall region, based on said maximum layer thickness. This preferred embodiment is a 22^{nd} embodiment of the invention, that preferably depends on any one of the preceding embodiments of the invention.

In a further preferred embodiment of the container the first wall region has a first width in a circumferential direction of the container perpendicular to the length of the container; wherein the first width is in a range from 1 to 10 mm, preferably from 1 to 9 mm, more preferably from 1 to 8 mm, more preferably from 1 to 7 mm, more preferably from 1 to 6 mm, more preferably from 1 to 5 mm, even more preferably from 1 to 4 mm, most preferably from 1 to 3 mm. This preferred embodiment is a 23^{rd} embodiment of the invention, that preferably depends on any one of the preceding embodiments of the invention.

In a further preferred embodiment of the container the second wall region has a second width in a circumferential direction of the container perpendicular to the length of the container; wherein the second width is in a range from 1 to 6 mm, preferably from 1 to 5 mm, more preferably from 1 to 4 mm, most preferably from 1 to 3 mm. This preferred embodiment is a 24^{th} embodiment of the invention, that preferably depends on any one of the preceding embodiments of the invention.

In a further preferred embodiment of the container the layer thickness of the carrier layer in the first wall region in the third ply is 1.1 to 20-times, preferably 1.1 to 15-times, more preferably 1.1 to 10-times, more preferably 1.1 to 5-times, preferably 1.1 to 3-times, more preferably 1.1 to 2-times, more preferably 1.2 to 1.9-times, still more preferably 1.1 to 1.8-times, most preferably 1.2 to 1.7-times, as high as in the first ply, or in the second ply, or in each of these two. This preferred embodiment is a 25^{th} embodiment of the invention, that preferably depends on any one of the preceding embodiments of the invention.

In a further preferred embodiment of the container the layer thickness of the carrier layer in the second wall region in the second ply is 0.05 to 0.9-times, preferably 0.1 to 0.85-times, more preferably 0.2 to 0.85-times, more preferably 0.3 to 0.85-times, more preferably 0.4 to 0.85-times, still more preferably 0.5 to 0.8-times, most preferably 0.6 to 0.75-times, as high as in the first ply, or in the third ply, or in each of these two. This preferred embodiment is a 26^{th} embodiment of the invention, that preferably depends on any one of the preceding embodiments of the invention.

In a further preferred embodiment of the container the first ply is not joined to the second ply in the first wall region. This preferred embodiment is a 27^{th} embodiment of the invention, that preferably depends on any one of the preceding embodiments of the invention.

In a further preferred embodiment of the container the container wall additionally comprises a third wall region; wherein the third wall region comprises, preferably consists of, as superimposed layers of a third layer sequence in the direction outward from the container interior, the first ply and the third ply; wherein the first ply is joined to the third ply in the third wall region. The third layer sequence does not comprise the second ply. This preferred embodiment is a 28^{th} embodiment of the invention, that preferably depends on any one of the preceding embodiments of the invention.

Preferably, the first ply on its inner side facing the container interior is joined to the element other than the folded planar composite in one selected from the group consisting of the first wall region, the second wall region, and the third wall region, or a combination of at least two, preferably all three, thereof.

In a further preferred embodiment of the container the third wall region is adjacent to the second wall region. This preferred embodiment is a 29^{th} embodiment of the invention, that preferably depends on the 28^{th} embodiment of the invention.

In a further preferred embodiment of the container the first wall region, the second wall port region and the third wall region follow one another, preferably adjoin one another, in this order in a circumferential direction of the container extending perpendicularly to the length of the container. This preferred embodiment is a 30^{th} embodiment of the invention, that preferably depends on the 28^{th} or 29^{th} embodiment of the invention.

In a further preferred embodiment of the container the third wall region has a third width in a circumferential direction of the container perpendicular to the length of the container; wherein the third width is in a range from 1 to 12 mm, preferably from 1 to 11 mm, more preferably from 1 to 10 mm, more preferably from 1 to 9 mm, more preferably from 1 to 8 mm, even more preferably from 1 to 7 mm, most preferably from 1 to 6 mm. This preferred embodiment is a 31^{st} embodiment of the invention, that preferably depends on any one of the 28^{th} to 30^{th} embodiments of the invention.

In a further preferred embodiment of the container
the first wall region and the second wall region, or
the first wall region, the second wall region and the third wall region together form a longitudinal seam of the container. This preferred embodiment is a 32^{nd} embodiment of the invention, that preferably depends on any one of the preceding embodiments of the invention.

In a further preferred embodiment of the container the element other than the folded planar composite comprises
a base member, and
a spout arranged on the base member.

This preferred embodiment is a 33^{rd} embodiment of the invention, that preferably depends on any one of the preceding embodiments of the invention.

In a further preferred embodiment of the container the base member comprises
a base plate, and
at least 3, preferably 3 to 12, more preferably 3 to 10, more preferably 3 to 8, more preferably 3 to 6, still more preferably 3 or 4, most preferably exactly 4, side walls;
   wherein the spout is arranged on a first side of the base plate wherein the side walls are arranged on a further side of the base plate opposite to the first side. This preferred embodiment is a 34^{th} embodiment of the invention, that preferably depends on the 33^{rd} embodiment of the invention.

In a further preferred embodiment of the container the side walls are inclined towards each other in a longitudinal direction of the element other than the folded planar composite extending from the base member to the spout; wherein each of the side walls is at an angle in a range from 55 to 70°, preferably from 55 to 69°, more preferably from 55 to 68°, more preferably from 55 to 67°, more preferably from 55 to 66°, more preferably from 55 to 65°, more preferably from 55 to 64°, more preferably from 56 to 63°, more preferably from 57 to 62°, more preferably from 58 to 61°, still more preferably from 58.5 to 60.0°, to the longitudinal direction. This preferred embodiment is a 35^{th} embodiment of the invention, that preferably depends on the 34^{th} embodiment of the invention.

Alternatively preferred, each of the side walls is at an angle in a range from 56 to 70°, more preferably from 57 to 70°, more preferably from 58 to 70°, more preferably from 59 to 70°, more preferably from 60 to 70°, more preferably from 61 to 70°, more preferably from 62 to 69°, more preferably from 63 to 68°, more preferably from 64 to 67°, still more preferably from 65.0 to 66.0°, to the longitudinal direction. Preferably, the longitudinal direction is perpendicular to the base plate. Alternatively or additionally preferred, the longitudinal direction is perpendicular to a circumferential direction of the element other than the folded planar composite. Alternatively or additionally preferred, the longitudinal direction of the element other than the folded planar composite is along a length of the container. Preferably, the element other than the folded planar composite consists of the base member and the spout. A preferred element other than the folded planar composite is formed as a first part of a container wall of the container. Preferably, the folded planar composite forms a further part of the container wall.

In a further preferred embodiment of the container the base plate has a base surface in the form of a polygon. This preferred embodiment is a 36^{th} embodiment of the invention, that preferably depends on the 34^{th} or 35^{th} embodiment of the invention.

A preferred polygon is a regular polygon. Alternatively or additionally preferred, the polygon has 3 to 12, more preferably 3 to 10, more preferably 3 to 8, more preferably 3 to 6, still more preferably 3 or 4, most preferably 4, corners. A preferred polygon with 4 corners is a rectangle. A preferred rectangle is a square. Preferably, the base member has as many side walls as the polygon has corners.

In a further preferred embodiment of the container each 2 of the side walls, which are next to each other in a circumferential direction of the element other than the folded planar composite, adjoin each other forming a side edge of the base member. This preferred embodiment is a 37^{th} embodiment of the invention, that preferably depends on any one of the 34^{th} to 36^{th} embodiments of the invention.

In a further preferred embodiment of the container the first ply on its inner side facing the container interior in the first wall region, or in the second wall region, or in each of these two is glued or sealed or both to the element other than the folded planar composite. This preferred embodiment is a 38^{th} embodiment of the invention, that preferably depends on any one of the preceding embodiments of the invention. Preferably, the first ply, as described above, is sealed to the element other than the folded planar composite with material of the element other than the folded planar composite as sealant, preferably as one of a plurality of sealants.

In a further preferred embodiment of the container the element other than the folded planar composite, preferably the spout, comprises a screw thread. This preferred embodiment is a 39^{th} embodiment of the invention, that preferably depends on any one of the preceding embodiments of the invention.

In a further preferred embodiment of the container the base member and the spout are formed in one piece with each other. This preferred embodiment is a 40^{th} embodiment of the invention, that preferably depends on any one of the 33^{rd} to 39^{th} embodiments of the invention. Preferably, the element other than the folded planar composite is formed in one piece.

In a further preferred embodiment of the container the container further comprises a cap, preferably a screw cap, which is arranged at the element other than the folded planar composite such that the cap covers a pouring aperture of the spout. This preferred embodiment is a 41^{st} embodiment of the invention, that preferably depends on any of the 33^{rd} to 40^{th} embodiments of the invention Preferably, the cap is screwed onto the spout. A preferred cap includes a second polymer composition. Preferably, the cap consists of the second polymer composition. Preferably, the second polymer composition comprises a polyolefin or a polycondensate or both. Preferably the second polymer composition comprises the polyolefin or the polycondensate or both together in a proportion in a range of from 70 to 100% by weight, preferably from 80 to 99% by weight, more preferably from 90 to 98% by weight, each based on the second polymer composition. A preferred polyolefin is a polyethylene or a polypropylene or both. A preferred polyethylene is an HDPE. A preferred polycondensate is a polyester or polyamide (PA) or both. A preferred polyester is a polyethylene terephthalate (PET). A preferred second polymer composition additionally includes a colourant. The second polymer composition preferably has a melting temperature in a range from 90 to 350° C., preferably from 90 to 300° C., more preferably from 90 to 280° C., more preferably from 90 to 260° C., more preferably from 90 to 240° C., more preferably from 90 to 220° C., more preferably from 100 to 200° C., more preferably from 100 to 190° C., more preferably from 100 to 180° C., more preferably from 100 to 170° C., more preferably from 100 to 160° C., more preferably from 110 to 150° C., more preferably from 120 to 140° C., still more preferably from 125 to 140° C., most preferably from 128 to 136° C.

In a further preferred embodiment of the container the container further comprises an opening aid; wherein the opening aid is arranged at the spout, preferably in the spout. This preferred embodiment is a 42^{nd} embodiment of the invention, that preferably depends on any one of the 33^{rd} to 41^{st} embodiments of the invention Preferably, the opening aid is designed and arranged for opening a pouring aperture of the spout.

Alternatively or additionally preferred, the opening aid is arranged at the cap, preferably in the cap. A preferred opening aid is a cutting aid or a tearing aid or both. Alternatively or additionally preferably, the opening aid is annular. A preferred annular cutting aid is a cutting ring. A preferred annular tear aid is a tear ring.

A preferred opening aid comprises a third polymer composition. Preferably, the opening aid consists of the third polymer composition. Preferably, the third polymer composition comprises a polyolefin or a polycondensate or both. Preferably, the third polymer composition comprises the polyolefin or the polycondensate or both together in a proportion in a range from 50 to 100% by weight, more preferably from 60 to 100% by weight, more preferably from 70 to 100% by weight, even more preferably from 80 to 100% by weight, most preferably from 90 to 100% by weight, each based on the third polymer composition. A preferred polyolefin is a polyethylene or a polypropylene or both. A preferred polyethylene is an HDPE. A preferred polycondensate is a polyester or polyamide (PA) or both. A preferred polyester is a polyethylene terephthalate (PET). A preferred third polymer composition additionally includes a colourant. The third polymer composition preferably has a melting temperature in a range from 90 to 350° C., preferably from 90 to 300° C., more preferably from 90 to 280° C., more preferably from 90 to 260° C., more preferably from 90 to 240° C., more preferably from 90 to 220° C., more preferably from 100 to 200° C., more preferably from 100 to 190° C., more preferably from 110 to 180° C., most preferably from 120 to 170° C.

In a further preferred embodiment of the container the opening aid is arranged and configured to open the pouring aperture by removing the cap from the spout. This preferred embodiment is a 43^{rd} embodiment of the invention, that preferably depends on the 42^{nd} embodiment of the invention In a further preferred embodiment of the container the element other than the folded planar composite comprises, preferably consists of, a first polymer composition. This preferred embodiment is a 44^{th} embodiment of the invention, that preferably depends on any of the preceding embodiments of the invention

Alternatively or additionally preferred, the base member or the spout or both comprises the first polymer composition. Preferably, the base member or the spout or both consists of the first polymer composition.

In a further preferred embodiment of the container the first polymer composition comprises a polyolefin or a polycondensate or both. This preferred embodiment is a 45^{th} embodiment of the invention, that preferably depends on the 44^{th} embodiment of the invention.

Preferably, the first polymer composition comprises the polyolefin or the polycondensate or both together in a proportion in a range of from 70 to 100% by weight, preferably from 80 to 99% by weight, more preferably from 90 to 98% by weight, each based on the first polymer composition. A preferred polycondensate is a polyester or polyamide (PA) or both. A preferred polyester is a polyethylene terephthalate (PET).

In a further preferred embodiment of the container the polyolefin is a polyethylene or a polypropylene or both. This preferred embodiment is a 46^{th} embodiment of the invention, that preferably depends on the 45^{th} embodiment of the invention.

In a further preferred embodiment of the container the polyethylene is an HDPE. This preferred embodiment is a 47^{th} embodiment of the invention, that preferably depends on the 46^{th} embodiment of the invention.

In a further preferred embodiment of the container the first polymer composition comprises a colourant. This preferred embodiment is a 48^{th} embodiment of the invention, that preferably depends on any of the 44^{th} to 47^{th} embodiments of the invention.

Preferably, the first polymer composition comprises the colourant in a proportion in a range from 0.5 to 5% by weight, preferably from 0.5 to 4% by weight, more preferably from 0.5 to 3% by weight, in each case based on the first polymer composition.

In a further preferred embodiment of the container the first polymer composition has a melting temperature in a range from 90 to 350° C., preferably from 90 to 300° C., more preferably from 90 to 280° C., more preferably from 90 to 260° C., more preferably from 90 to 240° C., more preferably from 90 to 220° C., more preferably from 100 to 200° C., more preferably from 100 to 190° C., more preferably from 100 to 180° C., more preferably from 100 to 170° C., more preferably from 100 to 160° C., more preferably from 110 to 150° C., more preferably from 120 to 140° C., even more preferably from 125 to 140° C., most preferably from 128 to 136° C. This preferred embodiment is a 49^{th} embodiment of the invention, that preferably depends on any of the 44^{th} to 48^{th} embodiments of the invention.

In a further preferred embodiment of the container the first ply on its inner side facing the container interior is joined to one of the side walls of the base member in the first wall region, or in the second wall region, or in each of these two. This preferred embodiment is a 50^{th} embodiment of the invention, that preferably depends on any of the 34^{th} to 49^{th} embodiments of the invention.

In a further preferred embodiment of the container a first part of the container wall is formed from the element other than the folded planar composite; wherein a further part of the container wall is formed from the folded planar composite; wherein the first part and the further part together form the container wall such that the container is closed. This preferred embodiment is a 51^{st} embodiment of the invention, that preferably depends on any of the preceding embodiments of the invention.

In a further preferred embodiment of the container the further part of the container wall is cup-shaped. This preferred embodiment is an 52^{nd} embodiment of the invention, that preferably depends on the 53^{rd} embodiment of the invention.

In a further preferred embodiment of the container the container comprises a standing base and, in a first direction along a length of the container opposite the standing base, a head portion. This preferred embodiment is a 53^{rd} embodiment of the invention, that preferably depends on any of the preceding embodiments of the invention.

In a further preferred embodiment of the container the head portion comprises, preferably consists of, the first part of the container wall. This preferred embodiment is a 54^{th} embodiment of the invention, that preferably depends on the 53^{rd} embodiment of the invention. Preferably, the element other than the folded planar composite forms a top surface of the head portion of the container. A preferred top surface is the top surface of a regular truncated pyramid.

In a further preferred embodiment of the container the standing bottom of the container is formed from the folded planar composite. This preferred embodiment is a 55^{th} embodiment of the invention, that preferably depends on the 53^{rd} or 54^{th} embodiment of the invention.

In a further preferred embodiment of the container the element other than the folded planar composite bounds the container interior in a first direction extending along a length of the container. This preferred embodiment is a 56^{th} embodiment of the invention, that preferably depends on any of the preceding embodiments of the invention. Preferably, the element other than the folded planar composite forms a top of the container for this purpose.

In a further preferred embodiment of the container the folded planar composite bounds the container interior laterally or in a further direction opposite to the first direction, or both. This preferred embodiment is a 57^{th} embodiment of the invention, that preferably depends on the 56^{th} embodiment of the invention.

In a further preferred embodiment of the container the head portion comprises at least 3, preferably 3 to 12, more preferably 3 to 10, more preferably 3 to 8, more preferably 3 to 6, even more preferably 3 or 4, most preferably exactly 4, preferably planar, head side surfaces formed from the folded planar composite; wherein the head side surfaces are inclined to each other, preferably in the first direction, such that the container tapers at least in sections in the head portion. This preferred embodiment is a 58^{th} embodiment of the invention, that preferably depends on any one of the 53^{rd} to 59^{th} embodiments of the invention.

In a further preferred embodiment of the container a perimeter of each of the head side surfaces is respectively formed by a plurality of side edges of the head portion; wherein each of the pluralities of side edges comprises a base edge which is convexly curved toward the standing base with respect to the head side surface whose perimeter is formed by the side edges of this plurality of side edges. This preferred embodiment is a 59^{th} embodiment of the invention, that preferably depends on the 58^{th} embodiment of the invention. Preferably each of the base edges is arcuately convex, more preferably circularly convex.

In a further preferred embodiment of the container the head side surfaces together form substantially a lateral surface of a regular truncated pyramid. This preferred embodiment is a 60^{th} embodiment of the invention, that preferably depends on the 58^{th} or 59^{th} embodiment of the invention.

In a further preferred embodiment of the container the regular truncated pyramid has a base surface in the form of a polygon. This preferred embodiment is a 61^{st} embodiment of the invention, that preferably depends on the 60^{th} embodiment of the invention.

A preferred polygon is a regular polygon. Alternatively or additionally preferred, the polygon has 3 to 12, more preferably 3 to 10, more preferably 3 to 8, more preferably 3 to 6, still more preferably 3 or 4, most preferably 4, corners. A preferred polygon with 4 corners is a rectangle.

A preferred rectangle is a square. Preferably, the head portion of the container has as many head side faces as the polygon has corners.

A 62^{nd} embodiment of the invention is a process comprising as process steps
a) providing
   a container precursor comprising a folded planar composite, and
   an element other than the folded planar composite;
wherein the folded planar composite comprises
   a carrier layer,
   a first composite region, and
   a second composite region;
wherein the first composite region comprises, as superimposed layers of a first layer sequence in a direction from an inner side of the container precursor to an outer side of the container precursor, a first ply of the folded planar composite, a second ply of the folded planar composite, and a third ply of the folded planar composite;
wherein the second ply is joined to the third ply in the first composite region;
wherein the second composite region comprises, as superimposed layers of a second layer sequence in the direction from the inner side of the container precursor to the outer side of the container precursor, the first ply, the second ply, and the third ply;
wherein the first ply is joined to the second ply in the second composite region and the second ply is joined to the third ply in the second composite region;
wherein the carrier layer in the first composite region has a greater layer thickness in the third ply than in the first ply, or than in the second ply, or than in each of them;
wherein the carrier layer in the second composite region in the second ply has a smaller layer thickness than in the first ply, or than in the third ply, or than in each of them;
b) joining the first ply of the folded planar composite in the first composite region, or in the second composite region, or in each of them, in each case on the inner side of the container precursor, to the element other than the folded planar composite to obtain a container.

The folded planar composite of the container precursor preferably comprises the layers according to any one of the embodiments of the container according to the invention in the indicated order. The folded planar composite of the container precursor preferably has the features of the folded planar composite of the container according to any one of the embodiments of the container according to the invention. Preferably, the element other than the folded planar composite has the features mentioned with respect to the element other than the folded planar composite of the container according to the invention in one of its embodiments. Preferably, the process is a process for manufacturing a container, preferably of manufacturing a container. A preferred container is one selected from the group, consisting of a closed container, a foodstuff container, a dimensionally stable container, and a liquid-tight container, or a combination at least two thereof. Alternatively or additionally preferred, the process is a process for manufacturing the container according to the invention according to any one of its embodiments, preferably of manufacturing the container according to the invention according to any one of its embodiments.

In a preferred embodiment of the process the folded planar composite and the element other than the folded planar composite in the process step b) are pressed to each other in a first pressing step at a first contact pressure and in a further pressing step at a further contact pressure; wherein the first contact pressure is less than the further contact pressure, preferably by at least 100 mbar, more preferably by at least 200 mbar, more preferably by at least 300 mbar, more preferably by at least 400 mbar, more preferably by at least 500 mbar, more preferably by at least 600 mbar, more preferably by at least 700 mbar, more preferably by at least 800 mbar, even more preferably by at least 900 mbar, most preferably by at least 1,000 mbar. This preferred embodiment is a 63^{rd} embodiment of the invention, that preferably depends on the 62^{nd} embodiment of the invention.

Preferably, the first pressing step is conducted prior to the further pressing step. Alternatively, the first pressing step is conducted after the further pressing step. Alternatively, the first pressing step is conducted in temporal overlap with the further pressing step or simultaneously to the further pressing step. Additionally or alternatively preferred, the first pressing step includes pressing in one or two first pressing directions and the further pressing step includes pressing in one or two further pressing directions which are different from the first pressing directions. In the case of two first pressing directions, these are preferably opposite to one another. In the case of two further pressing directions, these are preferably opposite to one another. Preferably, each first pressing direction is substantially perpendicular to each further pressing direction. Additionally or alternatively preferred, the first contact pressure is in the range from 800 to 3,000 mbar, preferably from 1,000 to 2,800 mbar, more preferably from 1,200 to 2,600 mbar. Additionally or alternatively preferred, the further contact pressure is in the range from 2,000 to 4,000 mbar, preferably from 2,200 to 3,800 mbar, more preferably from 2,400 to 3,600 mbar. Additionally or alternatively preferred, in the first pressing step, the folded planar composite and the element other than the folded planar composite are pressed to each other on a first pair of opposite sides of the element other than the folded planar composite; wherein the element other than the folded planar composite is not pressed to any of the first composite region and the second composite region in the first pressing step at the first contact pressure. Additionally or alternatively preferred, in the first pressing step, the folded planar composite is pressed to 2 side walls of the base member, which are opposite to one another. Additionally or alternatively preferred, in the further pressing step, the folded planar composite and the element other than the folded planar composite are pressed to each other on a further pair of opposite sides of the element other than the folded planar composite; wherein the element other than the folded planar composite is pressed to the first composite region, or the second composite region, or both in the further pressing step at the further contact pressure. The sides of the further pair of opposite sides are different from the sides of the first pair of opposite sides. Preferably, in the further pressing step, the blank is pressed to 2 side walls of the base member, which are opposite to one another.

In a further preferred embodiment of the process the joining in the process step b) is conducted as gluing or sealing or both. This preferred embodiment is a 64^{th} embodiment of the invention, that preferably depends on the 62^{nd} or 63^{rd} embodiment of the invention.

A preferred sealing is a heat sealing or an ultrasonic sealing or both. A preferred heat sealing involves heating the folded planar composite or the element other than the folded planar composite or both by contact with a solid or a gas or both.

In a further preferred embodiment of the process part of the folded planar composite, or part of the element other than the folded planar composite, or both is heated to a temperature in the range from 220 to 420° C., preferably from 240 to 400° C., more preferably from 260 to 380° C., in the process step b). This preferred embodiment is a 65^{th} embodiment of the invention, that preferably depends on any of the 62^{nd} to 64^{th} embodiments of the invention.

In a further preferred embodiment of the process the sealing is performed with a sealant provided at least in part by the element other than the folded planar composite. This preferred embodiment is a 66^{th} embodiment of the invention, that preferably depends on the 64^{th} or 65^{th} embodiment of the invention. Preferably, in addition to the element other than the folded planar composite, the sealant is partially provided by the folded planar composite, preferably by the inner polymer layer.

In a further preferred embodiment of the process the element other than the folded planar composite is partially melted for the joining in the method step b). This preferred embodiment is a 67^{th} embodiment of the invention, that preferably depends on any one of the 62^{nd} to 66^{th} embodiments of the invention.

In a further preferred embodiment of the process the element other than the folded planar composite comprises
a base member, and
a spout arranged on the base member.

This preferred embodiment is a 68^{th} embodiment of the invention, that preferably depends on any one of the 62^{nd} to 67^{th} embodiments of the invention.

In a further preferred embodiment of the process the base member comprises
a base plate, and
at least 3, preferably 3 to 12, more preferably 3 to 10, more preferably 3 to 8, more preferably 3 to 6, still more preferably 3 or 4, most preferably exactly 4, side walls;
   wherein the spout is arranged on a first side of the base plate; wherein the side walls are arranged on a further side of the base plate opposite to the first side. This preferred embodiment is a 69^{th} embodiment of the invention, that preferably depends on the 68^{th} embodiment of the invention.

In a further preferred embodiment of the process the joining of the first ply of the folded planar composite in the first composite region, or in the second composite region, or in each of these two, in each case on the inner side of the container precursor, is effected in the method step b) to one of the side walls of the base member, preferably each side wall. This preferred embodiment is a 70^{th} embodiment of the invention, that preferably depends on the 69^{th} embodiment of the invention.

In a further preferred embodiment of the process in the process step b) a, preferably closed, head portion of the container is obtained. This preferred embodiment is a 71^{st} embodiment of the invention, that preferably depends on any one of the 62^{nd} to 70^{th} embodiments of the invention. The container obtained in the process step b) is preferably open at an end opposite to the head portion.

In a further preferred embodiment of the process the process additionally comprises a process step of
c) further folding and joining of folding surfaces of the folded planar composite to obtain a standing base.

This preferred embodiment is a 72^{nd} embodiment of the invention, that preferably depends on any one of the 62^{nd} to 71^{st} embodiments of the invention. Preferably, the container is closed in the process step c). Preferably, the standing base is arranged at an end of the container opposite to the head region.

In a further preferred embodiment of the process the container according to any one of claims 1 to 63 is obtained in the process step c). This preferred embodiment is a 73^{rd} embodiment of the invention, that preferably depends on the 72^{nd} embodiment of the invention.

In a further preferred embodiment of the process the process comprises filling the container with a foodstuff after the process step b), and preferably before the process step c). This preferred embodiment is a 74^{th} embodiment of the invention, that preferably depends on any one of the 62^{nd} to 73^{rd} embodiments of the invention.

In a further preferred embodiment of the process an inner side of the folded planar composite
in the first ply faces the container interior,
in the second ply faces away from the container interior, and
in the third ply faces the interior of the container.

This preferred embodiment is a 75^{th} embodiment of the invention, that preferably depends on any one of the 62^{nd} to 74^{th} embodiments of the invention.

In a further preferred embodiment of the process the folded planar composite in the process step a) comprises at least 2 folds, preferably at least 3 folds, more preferably at least 4 folds. This preferred embodiment is a 76^{th} embodiment of the invention, that preferably depends on any one of the 62^{nd} to 75^{th} embodiments of the invention.

In a further preferred embodiment of the process the folded planar composite in the process step a) comprises a first longitudinal margin and a further longitudinal margin opposite the first longitudinal margin in a circumferential direction of the container precursor perpendicular to the length of the container precursor; wherein the first longitudinal margin is joined to the further longitudinal margin to form a longitudinal seam of the container precursor. This preferred embodiment is a 77^{th} embodiment of the invention, that preferably depends on any one of the 62^{nd} to 76^{th} embodiments of the invention.

Preferably, the first longitudinal margin is joined to the further longitudinal margin in the first composite region and the second composite region, or in the first composite region, the second composite region and the third composite region, forming the longitudinal seam of the container precursor.

In a further preferred embodiment of the process the first composite region is adjacent to the second composite region. This preferred embodiment is a 78^{th} embodiment of the invention, that preferably depends on any one of the 62^{nd} to 77^{th} embodiments of the invention.

In a further preferred embodiment of the process the layer thickness of the carrier layer in the first ply in the first composite region is smaller than in the second composite region. This preferred embodiment is a 79^{th} embodiment of the invention, that preferably depends on any one of the 62^{nd} to 78^{th} embodiments of the invention.

Preferably, the layer thickness of the carrier layer in the first ply in the first composite region is 0.05 to 0.9-times, preferably 0.1 to 0.85-times, more preferably 0.2 to 0.85-times, more preferably 0.3 to 0.85-times, more preferably 0.4 to 0.85-times, even more preferably 0.5 to 0.8-times, most preferably 0.6 to 0.75-times, as large as in the second wall region. Alternatively or additionally preferred, the thickness of the carrier layer in the first ply in the second wall region is 1.1 to 20-times, preferably 1.1 to 15-times, more preferably 1.1 to 10-times, more preferably 1.1 to 5 times, more preferably 1.1 to 3-times, more preferably 1.1 to 2-times, more preferably 1.2 to 1.9-times, still more preferably 1.1 to 1.8-times, most preferably 1.2 to 1.7-times, as great as in the first composite region.

In a further preferred embodiment of the process a minimum layer thickness of the carrier layer in the first wall region in one selected from the group consisting of the first ply, the second ply, and the third ply, or in each ply of a combination of at least two of the foregoing plies, is not more than 50%, preferably not more than 40%, more preferably not more than 30%, most preferably not more than 20%, most preferably not more than 10%, smaller than a maximum layer thickness of the carrier layer in the same ply of the first wall region, based on said maximum layer thickness. This preferred embodiment is an 80^{th} embodiment of the invention, that preferably depends on any one of the 62^{nd} to 79^{th} embodiments of the invention.

In a further preferred embodiment of the process a minimum layer thickness of the carrier layer in the second wall region in one selected from the group consisting of the first ply, the second ply, and the third ply, or in each ply of a combination of at least two of the foregoing plies, is not more than 50%, preferably not more than 40%, more preferably not more than 30% most preferably not more than 20%, most preferably not more than 10%, smaller than a maximum layer thickness of the carrier layer in the same ply of the second wall region, based on said maximum layer thickness. This preferred embodiment is an 81^{st} embodiment of the invention, that preferably depends on any one of the 62^{nd} to 80^{th} embodiments of the invention.

In a further preferred embodiment of the process the first composite region has a first width in a circumferential direction of the container precursor perpendicular to the length of the container precursor; wherein the first width is in a range from 1 to 10 mm, preferably from 1 to 9 mm, more preferably from 1 to 8 mm, more preferably from 1 to 7 mm, more preferably from 1 to 6 mm, more preferably from 1 to 5 mm, even more preferably from 1 to 4 mm, most preferably from 1 to 3 mm. This preferred embodiment is an 82^{nd} embodiment of the invention, that preferably depends on any one of the 62^{nd} to 81^{st} embodiments of the invention.

In a further preferred embodiment of the process the second composite region has a second width in a circumferential direction of the container precursor perpendicular to the length of the container precursor; wherein the second width is in a range from 1 to 6 mm, preferably from 1 to 5 mm, more preferably from 1 to 4 mm, most preferably from 1 to 3 mm. This preferred embodiment is an 83^{rd} embodiment of the invention, that preferably depends on any one of the 62^{nd} to 82^{nd} embodiments of the invention.

In a further preferred embodiment of the process the thickness of the carrier layer in the first composite region in the third ply is 1.1 to 20-times, preferably 1.1 to 15-times, more preferably 1.1 to 10-times, more preferably 1.1 to 5-times, preferably 1.1 to 3-times, more preferably 1.1 to 2-times, more preferably 1.2 to 1.9-times, still more preferably 1.1 to 1.8-times, most preferably 1.2 to 1.7-times, as high as in the first ply, or in the second ply, or in each of these two. This preferred embodiment is an 84^{th} embodiment of the invention, that preferably depends on any one of the 62^{nd} to 83^{rd} embodiments of the invention.

In a further preferred embodiment of the process the layer thickness of the carrier layer in the second composite region in the second ply is 0.05 to 0.9-times, preferably 0.1 to 0.85-times, more preferably 0.2 to 0.85-times, more preferably 0.3 to 0.85-times, more preferably 0.4 to 0.85-times, still more preferably 0.5 to 0.8-times, most preferably 0.6 to 0.75-times, as high as in the first ply, or in the third ply, or in each of these two. This preferred embodiment is an 85^{th} embodiment of the invention, that preferably depends on any one of the 62^{nd} to 84^{th} embodiments of the invention.

In a further preferred embodiment of the process the first ply is not joined to the second ply in the first composite region. This preferred embodiment is an 86^{th} embodiment of the invention, that preferably depends on any one of the 62^{nd} to 85^{th} embodiments of the invention.

In a further preferred embodiment of the process the folded planar composite in the process step a) additionally comprises a third composite region; wherein the third composite region comprises, as superimposed layers of a third layer sequence in the direction from the inner side of the container precursor to the outer side of the container precursor, the first ply and the third ply; wherein the first ply is joined to the third ply in the third composite region. This preferred embodiment is an 87^{th} embodiment of the invention, that preferably depends on any one of the 62^{nd} to 86^{th} embodiments of the invention.

In a further preferred embodiment of the process the third composite region is adjacent to the second composite region. This preferred embodiment is an 88^{th} embodiment of the invention, that preferably depends on the 87^{th} embodiment of the invention.

In a further preferred embodiment of the process the first composite region, the second composite port region and the third composite region follow one another, preferably adjoin one another, in this order in a circumferential direction of the container precursor extending perpendicularly to the length of the container precursor. This preferred embodiment is an 89^{th} embodiment of the invention, that preferably depends on the 87^{th} or 88^{th} embodiment of the invention.

In a further preferred embodiment of the process the third composite region has a third width in a circumferential direction of the container precursor perpendicular to the length of the container precursor; wherein the third width is in a range from 1 to 12 mm, preferably from 1 to 11 mm, more preferably from 1 to 10 mm, more preferably from 1 to 9 mm, more preferably from 1 to 8 mm, even more preferably from 1 to 7 mm, most preferably from 1 to 6 mm. This preferred embodiment is a 90^{th} embodiment of the invention, that preferably depends on any one of the 87^{th} to 89^{th} embodiments of the invention.

In a further preferred embodiment of the process
the first composite region and the second composite region, or
the first composite region, the second composite region and the third composite region together form a longitudinal seam of the container precursor. This preferred embodiment is a 91^{st} embodiment of the invention, that preferably depends on any one of the 62^{nd} to 90^{th} embodiments of the invention.

A 92^{nd} embodiment of the invention is a use of a container precursor and an element other than a folded planar composite for producing a foodstuff container; wherein the container precursor comprises the folded planar composite; wherein the folded planar composite comprises
a carrier layer
first composite region, and
second composite region;
   wherein the first composite region comprises, as superimposed layers of a first layer sequence in a direction from an inner side of the container precursor to an outer side of the container precursor, a first ply of the folded planar composite, a second ply of the folded planar composite, and a third ply of the folded planar composite; wherein the second ply is joined to the third ply in the first composite region; wherein the second composite region comprises, as superimposed layers of a second layer sequence in the direction from the inner side of the container precursor to the outer side of the container precursor, the first ply, the second ply, and the third ply; wherein the first ply is joined to the second ply in the second composite region and the second ply is joined to the third ply in the second composite region; wherein the carrier layer in the first composite region has a greater layer thickness in the third ply than in the first ply, or than in the second ply, or than in each of them; wherein the carrier layer in the second composite region in the second ply has a smaller layer thickness than in the first ply, or than in the third ply, or than in each of them. Preferably, the element other than the folded planar composite has the features of the element other than the folded planar composite of the container according to the invention mentioned in one of the embodiments of the container according to the invention.

In a preferred embodiment of the use the producing comprises joining the first ply of the folded planar composite in the first composite region, or in the second composite region, or in each of these two, in each case on the inner side of the container precursor, to the element other than the folded planar composite. This preferred embodiment is a 93^{rd} embodiment of the invention, that preferably depends on any the 92^{nd} embodiment of the invention.

Features described as preferred in one category of the invention, for example according to the container, are analogously preferred in an embodiment of the other categories according to the invention, such as the process and the use. Furthermore, the features described below are preferred in connection with each category of the invention.

### Planar Composites

All of the below references to planar composites aim, in particular, at the folded planar composite of the container according to the invention. This holds beyond this “Planar composites”-section.

All laminates, in particular sheet-like laminates, which are conceivable within the context of the invention and which appear to the person skilled in the art to be suitable in the context of the invention for the production of dimensionally stable foodstuff containers are to be considered as planar composites. Planar composites for the manufacture of foodstuff containers are also referred to as laminates. Such planar composites have a sequence of layers superimposing each other in a planar manner. The planar composites are often composed of a thermoplastic polymer layer, referred to herein as the outer polymer layer, a carrier layer, often made of cardboard or paper, which gives the container its dimensional stability, an optional thermoplastic polymer layer, referred to herein as the intermediate polymer layer and/or an optional adhesion promoter layer, a barrier layer and a further thermoplastic polymer layer, referred to herein as the inner polymer layer.

Generally, the term “planar composite” is a generic term that includes both semi-endless roll material and a blank of such roll material. The blank is preferably designed to produce a single container. The folded planar composite of the container according to the invention is such a blank. Thus, the folded planar composite is a blank, which is cut to size to provide the further part of the container wall. The planar composite can be a flat or three-dimensional object. The latter is, in particular the case, if the planar composite has been folded or rolled up. In any case, the planar composite is sheet-like. Therefore, the planar composite may also be referred to as sheet-like composite.

The layers of the planar composite that form a sequence of layers are joined to each other over their entire surface. Two layers are joined together when their adhesion to each other exceeds Van der Waals forces of attraction. Preferably, layers joined with one another are one selected from the group consisting of joined with one another by coating, laminated together, sealed together, glued together, and pressed together, or a combination of at least two thereof. Layers joined with one another by coating are preferably joined with one another by melt coating or by vapour deposition. A preferred melt coating is a melt extrusion coating.

Unless otherwise specified, in a layer sequence the layers or plies may follow each other indirectly, i.e., with one or at least two intermediate layers or plies, or directly, i.e. without an intermediate layer or ply. This is particularly the case in the formulation in which one layer or ply superimposes another layer or ply. A formulation in which a layer sequence includes enumerated layers or plies means that at least the specified layers or plies are present in the specified order. This formulation does not necessarily mean that these layers or plies immediately follow each other. A formulation in which two layers or plies are adjacent to each other means that these two layers or plies follow each other immediately and thus without an intermediate layer or ply. However, this formulation does not say anything about whether the two layers or plies are joined or not. Rather, these two layers or plies may be in contact with each other. Preferably, however, these two layers or plies are joined with one another, preferably in a planar manner.

### Outer Side

The outer side of the planar composite or container precursor is a surface of the planar composite or container precursor which is intended to be in contact with the environment of the container in a container to be made with the planar composite or container precursor. This is not precluded by the fact that in individual areas of the container, the outer surfaces of different areas of the composite are folded on top of each other or joined to each other, for example sealed to each other.

### Inner Side

The inner side of the planar composite or container precursor is a surface of the planar composite or container precursor which is intended to be in contact with the contents of the container, preferably a foodstuff, in a container to be made with the planar composite or container precursor.

### Polymer Layers

In the following, the term “polymer layer” refers in particular to the inner polymer layer, the intermediate polymer layer and the outer polymer layer. The polymer layers are each based on a polymer or a polymer blend, i.e., the polymer layers comprise a majority of the polymer or polymer blend. A preferred polymer is a thermoplastic polymer, more preferably a polyolefin. The polymer layers are preferably incorporated or applied into the planar composite material in an extrusion process, preferably by melt extrusion coating. In addition to the polymer or polymer blend, each polymer layer may comprise further components. The further constituents of the polymer layers are preferably constituents which do not adversely affect the behaviour of the polymer melt when applied as a layer. The further constituents may be, for example, inorganic compounds, such as metal salts, or further plastics, such as further thermoplastics.

In general, suitable polymers for the polymer layers are in particular those which are easy to process due to good extrusion behaviour. Among these, polymers obtained by chain polymerisation are suitable, in particular polyolefins, whereby cyclic olefin co-polymers (COC), polycyclic olefin co-polymers (POC), in particular polyethylene and polypropylene, are particularly preferred and polyethylene is especially preferred. Among the polyethylenes, HDPE (high density polyethylene), MDPE (medium density polyethylene), LDPE (low density polyethylene), LLDPE (linear low density polyethylene) and VLDPE (very low density polyethylene) as well as blends of at least two of them are preferred. Suitable polymers, preferably, have a melt flow rate (MFR) in a range from 1 to 25 g/10 min, preferably in a range from 2 to 20 g/10 min and particularly preferably in a range from 2.5 to 15 g/10 min. Additionally or alternatively preferred, suitable polymer layers have a density in a range of 0.890 g/cm³ to 0.980 g/cm³, preferably in a range of 0.895 g/cm³ to 0.975 g/cm³, and more preferably in a range of 0.900 g/cm³ to 0.970 g/cm³. The polymer layers preferably have at least one melting temperature in a range from 80 to 155° C., preferably in a range from 90 to 145° C., and more preferably in a range from 95 to 135° C.

### Inner Polymer Layer

The inner polymer layer is based on at least one thermoplastic polymer, wherein the inner polymer layer may comprise a particulate inorganic solid. However, it is preferred that the inner polymer layer comprises at least 70% by weight, preferably at least 80% by weight and particularly preferably at least 95% by weight, in each case based on the total weight of the inner polymer layer, of one or more thermoplastic polymers. Preferably, the polymer or polymer blend of the inner polymer layer has a density (according to ISO 1183-1:2004) in a range from 0.900 to 0.980 g/cm³, more preferably in a range from 0.900 to 0.960 g/cm³ and most preferably in a range from 0.900 to 0.940 g/cm³. Preferably, the polymer is a polyolefin. Preferably, the inner polymer layer comprises a polyethylene or a polypropylene or both. Here, a particularly preferred polyethylene is an LDPE.

Preferably, the inner polymer layer comprises the polyethylene or the polypropylene or both together in a proportion of at least 30% by weight, more preferably at least 40% by weight, most preferably at least 50% by weight, each based on the total weight of the inner polymer layer. Additionally or alternatively, the inner polymer layer preferably comprises an HDPE, preferably in an amount of at least 5% by weight, more preferably at least 10% by weight, more preferably at least 15% by weight, most preferably at least 20% by weight, each based on the total weight of the inner polymer layer. In addition or alternatively to one or more of the aforementioned polymers, the inner polymer layer preferably comprises a polymer produced by means of a metallocene catalyst, preferably an mPE. Preferably, the inner polymer layer comprises the mPE in a proportion of at least 3% by weight, more preferably at least 5% by weight, in each case based on the total weight of the inner polymer layer. Here, the inner polymer layer may comprise 2 or more, preferably 2 or 3, of the aforementioned polymers in a polymer blend, for example at least a proportion of the LDPE and the mPE, or at least a proportion of the LDPE and the HDPE. Further preferably, the inner polymer layer may comprise 2 or more, preferably 3, sublayers superimposing each other, which preferably form the inner polymer layer. These sub-layers are preferably layers obtained by co-extrusion.

In a preferred embodiment, the inner polymer layer comprises, in the direction from an outer side of the folded planar composite to an inner side of the folded planar composite, a first sub-layer comprising an LDPE in an amount of at least 50% by weight, preferably at least 60% by weight, more preferably at least 70% by weight, even more preferably at least 80% by weight, most preferably at least 90% by weight, each based on the weight of the first sub-layer; and a further sub-layer comprising a blend, wherein the blend comprises an LDPE in a proportion of at least 30% by weight, preferably at least 40% by weight, more preferably at least 50% by weight, more preferably at least 60% by weight, most preferably at least 65% by weight, and an mPE in a proportion of at least 10% by weight, preferably at least 15% by weight, more preferably at least 20% by weight, most preferably at least 25% by weight, in each case based on the weight of the blend. In this case, the further sublayer preferably comprises the blend in a proportion of at least 50% by weight, preferably at least 60% by weight, more preferably at least 70% by weight, even more preferably at least 80% by weight, most preferably at least 90% by weight, in each case based on the weight of the further sublayer. Particularly preferably, the further sub-layer consists of the blend.

In a further preferred embodiment, the inner polymer layer comprises, in the direction from an outer side of the folded planar composite to an inner side of the folded planar composite, a first sub-layer comprising an HDPE in an amount of at least 30% by weight, preferably at least 40% by weight, more preferably at least 50% by weight, more preferably at least 60% by weight, most preferably at least 70% by weight, and an LDPE in an amount of at least 10% by weight, preferably at least 15% by weight, more preferably at least 20% by weight, in each case based on the weight of the first sub-layer; a second sub-layer comprising an LDPE in an amount of at least 50% by weight, preferably at least 60% by weight, more preferably at least 70% by weight, still more preferably at least 80% by weight, most preferably at least 90% by weight, in each case based on the weight of the second sub-layer; and a third sub-layer comprising a blend, wherein the blend comprises an LDPE in an amount of at least 30% by weight, preferably at least 40% by weight, more preferably at least 50% by weight, even more preferably at least 60%, most preferably at least 65% by weight, and an mPE in a proportion of at least 10%, preferably at least 15%, more preferably at least 20%, most preferably at least 25%, by weight, each based on the weight of the blend. Here, the third sub-layer preferably comprises the blend in a proportion of at least 50% by weight, preferably at least 60% by weight, more preferably at least 70% by weight, even more preferably at least 80% by weight, most preferably at least 90% by weight, in each case based on the weight of the third sub-layer. Particularly preferably, the third sub-layer consists of the blend.

### Outer Polymer Layer

The outer polymer layer preferably comprises a polyethylene or a polypropylene or both. Preferred polyethylenes are LDPE and HDPE as well as mixtures thereof. A preferred outer polymer layer comprises at least 50% by weight, preferably at least 60% by weight, more preferably at least 70% by weight, even more preferably at least 80% by weight, most preferably at least 90% by weight, in each case based on the weight of the outer polymer layer, of one or more LDPE.

### Intermediate Polymer Layer

The intermediate polymer layer preferably comprises at least one polyethylene or at least one polypropylene or both. Here, particularly preferred polyethylenes are LDPE. Preferably, the intermediate polymer layer comprises the at least one polyethylene or the at least one polypropylene or both together in a proportion of at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, in each case based on the total weight of the intermediate polymer layer. Additionally or alternatively, the intermediate polymer layer preferably includes an HDPE, preferably in a proportion of at least 10% by weight, more preferably at least 20% by weight, more preferably at least 30% by weight, more preferably at least 40% by weight, more preferably at least 50% by weight, more preferably at least 60% by weight, more preferably at least 70% by weight, more preferably at least 80% by weight, most preferably at least 90% by weight, each based on the total weight of the intermediate polymer layer. Here, the intermediate polymer layer preferably comprises the aforementioned polymers in a polymer blend.

### Barrier Layer

The barrier layer can be any material which seems suitable to the skilled person for this purpose, which has a sufficient barrier effect, especially against oxygen. For this purpose, the barrier layer preferably has an oxygen permeation rate of less than 50 cm³/(m²·day·atm), preferably less than 40 cm³/(m²·day·atm), more preferably less than 30 cm³/(m²·day·atm), more preferably less than 20 cm³/(m²·day·atm), more preferably less than 10 cm³/(m²·day·atm), even more preferably less than 3 cm³ (m²·day·atm), most preferably not more than 1 cm³ (m²·day·atm). The barrier layer preferably additionally exhibits a barrier effect against water vapour. Accordingly, the barrier layer is preferably an oxygen barrier layer and further preferably additionally a water vapour barrier layer. In addition, the barrier layer preferably has a barrier effect against visible light, i.e. it is additionally a light barrier layer.

The barrier layer is preferably selected from
a. a plastic layer;
b. a metal layer;
c. an oxide layer; or
d. a combination of at least two from a. to c.

If the barrier layer according to alternative a. is a plastic layer, this preferably comprises at least 70% by weight, particularly preferably at least 80% by weight and most preferably at least 95% by weight of at least one plastic which is known to the person skilled in the art for this purpose, in particular because of aroma or gas barrier properties suitable for packaging containers. Plastics, in particular thermoplastics, which can be considered here are N- or O-bearing plastics both by themselves and in mixtures of two or more. According to the invention, it may prove advantageous if the plastic layer has a melting temperature in a range of more than 155 to 300° C., preferably in a range of 160 to 280° C. and particularly preferably in a range of 170 to 270° C.

Further preferably, the plastic layer has a basis weight in a range from 2 to 120 g/m², preferably in a range from 3 to 60 g/m², particularly preferably in a range from 4 to 40 g/m² and more preferably from 6 to 30 g/m². Further preferably, the plastic layer is obtainable from melts, for example by extrusion, in particular layer extrusion. Furthermore, preferably, the plastic layer can also be introduced into the planar composite by lamination. In this case, it is preferred that a film is incorporated into the planar composite. According to another embodiment, plastic layers can also be selected which are obtainable by deposition from a solution or dispersion of plastics.

Suitable polymers are preferably those having a weight average molecular weight, determined by gel permeation chromatography (GPC) using light scattering, in a range of 3·10³ to 1·10⁷ g/mol, preferably in a range of 5·10³ to 1·10⁶ g/mol and particularly preferably in a range of 6·10³ to 1·10⁵ g/mol. Suitable polymers are in particular polyamide (PA) or polyethylene vinyl alcohol (EVOH) or a mixture thereof. Among the polyamides, all PAs which appear to the person skilled in the art to be suitable for use according to the invention can be considered. All EVOHs that appear suitable to the person skilled in the art for use according to the invention can be considered as EVOH. Examples of these are commercially available under the trade names EVAL™ of EVAL Europe NV, Belgium in a variety of different versions, for example the grades EVAL™ F104B or EVAL™ LR171B. Preferred EVOH have at least one, two, multiple or all of the following properties:
an ethylene content in a range from 20 to 60 mol-%, preferably from 25 to 45 mol-%;
a density in a range from 1.0 to 1.4 g/cm³, preferably from 1.1 to 1.3 g/cm³;
a melting point in a range of more than 155° C. and up to 235° C., preferably from 165 to 225° C.;
an MFR value (210° C./2.16 kg when T_{S(EVOH})<210° C.; 230° C./2.16 kg when 210° C.<T_{S(EVOH})<230° C.) in a range from 1 to 25 g/10 min, preferably from 2 to 20 g/10 min;
an oxygen permeation rate in a range of 0.05 to 3.2 cm³·20 μm/(m²·day·atm), preferably in a range of 0.1 to 1 cm³·20 μm/(m²·day·atm).

Preferably, at least one polymer layer, more preferably the inner polymer layer, or preferably all polymer layers have a melting temperature below the melting temperature of the barrier layer.

This is particularly true if the barrier layer is formed of a plastic. In this case, the melting temperature of the at least one polymer layer, in particular the inner polymer layer, and the melting temperature of the barrier layer preferably differ by at least 1 K, particularly preferably by at least 10 K, even more preferably by at least 50 K, and furthermore preferably by at least 100 K. The temperature difference should preferably only be selected so high that it does not result in a melting of the barrier layer, in particular not in a melting of the plastic layer, during folding.

According to alternative b., the barrier layer is a metal layer. In principle, all layers with metals known to the skilled person and capable of creating a high light and oxygen impermeability are suitable as a metal layer. According to a preferred embodiment, the metal layer can be present as a foil or as a deposited layer, e.g. after physical vapour deposition. Preferably, the metal layer is an uninterrupted layer. According to a further preferred embodiment, the metal layer has a thickness in a range from 3 to 20 μm, preferably in a range from 3.5 to 12 μm and particularly preferably in a range from 4 to 10 μm.

Preferred metals are aluminium, iron or copper. A steel layer, e.g., in the form of a foil, may be preferred as the iron layer. Further preferably, the metal layer is a layer with aluminium, preferably an aluminium layer, further preferably an aluminium foil. The aluminium layer can suitably consist of an aluminium alloy, for example AlFeMn, AlFe1.5Mn, AlFeSi or AlFeSiMn. The purity is often 97.5% and higher, preferably 98.5% and higher, based on the entire aluminium layer. In a particular embodiment, the metal layer consists of an aluminium foil. Suitable aluminium foils have a ductility of more than 1%, preferably more than 1.3% and particularly preferably more than 1.5%, and/or a tensile strength of more than 30 N/mm², preferably more than 40 N/mm² and particularly preferably more than 50 N/mm². Suitable aluminium foils show a drop size in the pipette test of more than 3 mm, preferably more than 4 mm and particularly preferably more than 5 mm. Suitable alloys for creating aluminium layers or foils are commercially available under the designations EN AW 1200, EN AW 8079 or EN AW 8111 from Hydro Aluminium Deutschland GmbH or Amcor Flexibles Singen GmbH. In the case of a metal layer as a barrier layer, an adhesion promoter layer can be provided on one or both sides of the metal layer, preferably adjacent to the metal layer on its respective side.

Furthermore, an oxide layer can be selected as the barrier layer according to alternative c. All oxide layers that are familiar to the person skilled in the art and appear suitable for achieving a barrier effect against light, vapour and/or gas can be considered as oxide layers. A preferred oxide layer is a semi-metal oxide layer or a metal oxide layer or both. A preferred semi-metal oxide layer is a layer based on one or more silicon oxide compounds (SiOx layer). Preferred metal oxide layers are layers based on the previously mentioned metals aluminium, iron or copper, as well as such metal oxide layers based on titanium oxide compounds, whereby an aluminium oxide layer (AlOx layer) is particularly preferred. According to a preferred embodiment, the oxide layer may be present as a deposited layer. A deposited oxide layer is exemplarily produced by vapour deposition of the oxide layer on a barrier substrate. A preferred process for this is physical vapour deposition (PVD) or chemical vapour deposition (CVD), preferably plasma-assisted. The oxide layer is preferably an uninterrupted layer.

The barrier substrate can consist of any material which appears to the skilled person to be suitable for use as a barrier substrate according to the invention. In this case, the barrier substrate is preferably suitable for being coated with an oxide layer. Preferably, a layer surface is sufficiently smooth for this purpose. Further preferably, the barrier substrate has a thickness in a range from 2 to 30 μm, preferably from 2 to 28 μm, more preferably from 2 to 26 μm, more preferably from 3 to 24 μm, more preferably from 4 to 22 μm, most preferably from 5 to 20 μm. Furthermore, the barrier substrate preferably exhibits a barrier effect against oxygen or water vapour or both. Preferably, a barrier effect of the barrier substrate against permeation of oxygen is greater than a barrier effect of the oxide layer against permeation of oxygen. Preferably, the barrier substrate has an oxygen permeation rate in a range from 0.1 to 50 cm³/(m²·d·bar), preferably from 0.2 to 40 cm³/(m²·d·bar), more preferably from 0.3 to 30 cm³/(m²·d·bar). A preferred barrier substrate includes, more preferably consists of, cellulose or a polymer or both. A preferred polymer here is an oriented polymer. Preferably, the oriented polymer is mono-axially oriented or bi-axially oriented. A preferred polymer is a thermoplastic polymer. Preferably, the barrier substrate consists of the polymer. Preferably, the barrier substrate comprises a polymer selected from the group consisting of a polycondensate, a polyethylene, a polypropylene, a polyvinyl alcohol, or a combination of at least two of them in a proportion of at least 50% by weight, preferably at least 60% by weight, more preferably at least 70% by weight, more preferably at least 80% by weight, most preferably at least 90% by weight, each based on the weight of the barrier substrate. More preferably, the barrier substrate consists of the aforementioned polymer. A preferred polypropylene is oriented, in particular monoaxially oriented (oPP) or biaxially oriented (BoPP). A preferred polycondensate is a polyester or polyamide (PA) or both. A preferred polyester is one selected from the group consisting of a polyethylene terephthalate (PET), a polylactide (PLA), and a vinyl polymer, or a combination of at least two thereof. A preferred vinyl polymer is a vinyl alcohol copolymer or a polyvinyl alcohol or both. A preferred polyvinyl alcohol is a vinyl alcohol copolymer. A preferred vinyl alcohol copolymer is an ethylene-vinyl alcohol copolymer.

### Carrier Layer

The carrier layer can be any material suitable to the skilled person for this purpose, which has sufficient strength and rigidity to give the container sufficient stability that the container substantially retains its shape when filled. In particular, this is a necessary feature of the carrier layer as the invention relates to the technical field of dimensionally stable containers. Such dimensionally stable containers are fundamentally to be distinguished from bags and pouches, which are usually made of thin films. In addition to a number of plastics, plant-based fibrous materials, in particular cellulose, preferably sized, bleached and/or unbleached cellulose, are preferred, with paper and cardboard being particularly preferred. Accordingly, a preferred carrier layer includes a plurality of fibres. The basis weight of the carrier layer is preferably in a range of 120 to 450 g/m², more preferably in a range of 130 to 400 g/m² and most preferably in a range of 150 to 380 g/m². A preferred cardboard generally has a single or multi-layer structure and may be coated on one or both sides with one or more top layers. Furthermore, a preferred cardboard has a residual moisture content of less than 20% by weight, preferably from 2 to 15% by weight and particularly preferably from 4 to 10% by weight based on the total weight of the cardboard. A particularly preferred cardboard has a multi-layer structure. Furthermore, the cardboard preferably has on the surface facing the environment at least one, but particularly preferably at least two, plies of a cover layer known to the skilled person as a “paper coating”. Furthermore, a preferred cardboard has a Scott-Bond value (according to Tappi 569) in a range from 100 to 360 J/m², preferably from 120 to 350 J/m² and particularly preferably from 135 to 310 J/m². The above ranges make it possible to provide a composite from which a container can be folded with high tightness, easily and to low tolerances.

The carrier layer preferably has a bending stiffness in a first direction in a range from 70 to 700 mN, more preferably from 80 to 650 mN. In the case of a carrier layer comprising a plurality of fibres, the first direction is preferably an orientation direction of the fibres. A carrier layer comprising a plurality of fibres further preferably has a bending stiffness in a further direction perpendicular to the first direction in a range from 10 to 350 mN, more preferably from 20 to 300 mN. A preferred planar composite with the carrier layer has a bending stiffness in the first direction in a range of 100 to 700 mN. Further preferably, the aforementioned planar composite has a bending stiffness in the further direction in a range of 50 to 500 mN.

Preferably, the carrier layer comprises at least 2, more preferably at least 3, particularly preferably exactly 3 or 5, sub-layers, each of a fibre-containing material, wherein the sub-layers are superimposed to one another and joined to one another. The fibre-containing materials of the individual sub-layers may differ at least partially from one another or may all be the same. A further particularly preferred carrier layer comprises, as superimposed and interconnected sublayers of a sub-layer sequence, preferably in a direction from an outer side of the carrier layer to an inner side of the carrier layer, a first sub-layer comprising a fibrous material, a second sub-layer comprising a fibrous material and a third sub-layer comprising a fibrous material. The fibre-containing materials of the first to third sub-layers may be the same or different from each other. Furthermore, in addition to the aforementioned layer sequence, a preferred carrier layer includes at least one cover layer as a further sub-layer. Preferably, the layer sequence of first to third sub-layers is superimposed on an outer side of the carrier layer with at least one cover layer as a further sub-layer. Alternatively or additionally preferred, the layer sequence of first to third sub-layers is superimposed on an inner side of the carrier layer with at least one cover layer as a further sub-layer. Preferably, an average fibre length of the plurality of fibres of the fibrous material of the first sub-layer is less than an average fibre length of the plurality of fibres of the fibrous material of the third sub-layer, preferably by 0.1 to 3 mm, more preferably by 0.5 to 2.5 mm, most preferably by 1 to 2.0 mm.

### Cover Layer

A preferred cover layer is a “paper coating”. In papermaking, a “paper coating” is a cover layer comprising inorganic solid particles, preferably pigments and additives. The “paper coating” is preferably applied as a liquid phase, preferably as a suspension or dispersion, to a surface of a paper- or cardboard-comprising layer. A preferred dispersion is an aqueous dispersion. A preferred suspension is an aqueous suspension. Another preferred liquid phase includes inorganic solid particles, preferably pigments; a binder; and additives. A preferred pigment is selected from the group consisting of calcium carbonate, kaolin, talc, silicate, a plastic pigment and titanium dioxide. A preferred kaolin is a calcined kaolin. A preferred calcium carbonate is one selected from the group consisting of marble, chalk and a precipitated calcium carbonate (PCC) or a combination of at least two thereof. A preferred silicate is a layered silicate. A preferred plastic pigment is spherical, preferably hollow spherical. A preferred binder is one selected from the group consisting of styrene-butadiene, acrylate, acrylonitrile, a starch and a polyvinyl alcohol or a combination of at least two thereof, acrylate being preferred. A preferred starch is one selected from the group consisting of cationically modified, anionically modified, and fragmented or a combination of at least two thereof. A preferred additive is one selected from the group consisting of a rheology modifier, a shade dye, an optical brightener, a carrier, a flocculant, a deaerator, and a surface energy modifier, or a combination of at least two thereof. A preferred deaerator is a coating colour deaerator, preferably silicone-based or fatty acid-based or both. A preferred surface energy modifier is a surfactant.

### Fibrous Material

Here, the terms “fibrous material” and “fibre-containing material” are synonymous and encompass any material or layer, which comprises a plurality of fibres, such as preferred carrier layers. Thus, the fibrous material includes a plurality of fibres, and preferably at least one further constituent. A preferred further constituent is a sizing agent. A preferred sub-layer of a fibrous material includes a plurality of fibres and at least one sizing agent.

### Fibres

The fibres of a fibre-containing material can be any fibre which appears to the skilled person to be suitable for use in accordance with the invention, in particular any fibre known in the manufacture of paper, cardboard or paperboard. Fibres are linear, longitudinally extended structures having a ratio of length to diameter or thickness of at least 3:1. For some fibres, the aforementioned ratio is not greater than 100:1. For use in this document, long fibres have an average fibre length in a range of 3 to 4 mm and short fibres have an average fibre length in a range of 0.4 to 2 mm.

Preferred fibres are plant fibres. Plant fibre is a collective term for fibres of plant origin, i.e. fibres obtained from plants. Plant fibres occur in plants as conducting bundles in the stem or trunk, the bark (for example as bast) and as seed appendages. A subdivision is made according to DIN 60001-1: 2001-05 Textile fibre materials—Part 1: “Naturalfibres and abbreviations”, Beuth Verlag, Berlin 2001, p. 2 into seed fibres, bast fibres and hard fibres or according to DIN EN ISO 6938: 2015-01 “Textiles—Naturalfibres—Generic names and definitions”, Beuth Verlag, Berlin 2015, p. 4. into seed fibres, bast fibres, leaf fibres and fruit fibres, which thus makes a subdivision of the hard fibres. In the context of the invention, preferred plant fibres are predominantly produced from the wood of trees. A preferred wood in this respect is a coniferous wood, i.e., a wood of a coniferous tree, or a deciduous wood, i.e. a wood of a deciduous tree. In the case of coniferous wood, tracheids are preferred. In the case of deciduous wood, libriforms are preferred.

In the context of the invention, preferred fibres comprise cellulose pulp or a wood pulp, or both, and preferably the fibres consist thereof. A preferred wood pulp is one selected from the group consisting of groundwood pulp, pressure groundwood pulp, and a thermo-mechanical pulp (TMP), or a combination of at least two thereof. A preferred thermo-mechanical pulp is a chemithermo-mechanical pulp (CTMP). In this case, the wood pulp is characterised by a greater proportion of lignin compared to the cellulose pulp, which can be detected by means of red colouring with phloroglucin solution. In the context of the invention, preferred fibres are obtained from the wood of a tree selected from the group consisting of spruce, pine, birch, and eucalyptus, or a combination of at least two thereof. The fibres of the plurality of fibres of a preferred fibre-containing material have at least one of the following properties:
A) an average fibre length in a range from 0.2 to 6 mm, preferably from 0.2 to 4.5 mm, more preferably from 0.5 to 4.0 mm, more preferably from 1.0 to 4.0, even more preferably from 2.0 to 4.0, most preferably from 3.0 to 4.0 mm,
B) a coarseness in a range from 50 to 400 μg/m, preferably from 100 to 300 μg/m, more preferably from 120 to 300 μg/m, even more preferably from 120 to 250 μg/m, most preferably from 130 to 200 μg/m,
C) an average wall thickness in a range from 2 to 10 μm, preferably from 3 to 9 μm, more preferably from 4 to 9 μm, more preferably from 5 to 8 μm, even more preferably from 6 to 8 μm, most preferably from 6 to 7 μm,
D) a mean outer diameter in a range from 10 to 50 μm, more preferably from 10 to 45 μm, more preferably from 20 to 45 μm, more preferably from 25 to 45 μm, more preferably from 30 to 45 μm, still more preferably from 30 to 40 μm, most preferably from 32 to 40 μm.

Here, the above property under point A) is particularly preferred.

### Polyolefin

A preferred polyolefin is a polyethylene (PE) or a polypropylene (PP) or both. A preferred polyethylene is one selected from the group consisting of an LDPE, an LLDPE, and an HDPE, or a combination of at least two thereof. Another preferred polyolefin is an mPolyolefin (polyolefin produced by means of a metallocene catalyst). Suitable polyethylenes have a melt flow rate (MFI—melt flow index=MFR—melt flow rate) in a range from 1 to 25 g/10 min, preferably in a range from 2 to 20 g/10 min and particularly preferably in a range from 2.5 to 15 g/10 min, and/or a density in a range of 0.910 g/cm³ to 0.935 g/cm3, preferably in a range of 0.912 g/cm³ to 0.932 g/cm³, and more preferably in a range of 0.915 g/cm³ to 0.930 g/cm³.

mPolymer

An mPolymer is a polymer produced by means of a metallocene catalyst. A metallocene is an organometallic compound in which a central metal atom is located between two organic ligands, such as cyclopentadienyl ligands. A preferred mPolymer is an mPolyolefin, preferably an mPolyethylene or an mPolypropylene or both. A preferred mPolyethylene is one selected from the group consisting of an mLDPE, an mLLDPE, and an mHDPE, or a combination of at least two thereof. A preferred mPolyolefin is characterised by at least a first melting temperature and a second melting temperature. Preferably, the mPolyolefin is characterised by a third melting temperature in addition to the first and second melting temperatures. A preferred first melting temperature is in a range from 84 to 108° C., preferably from 89 to 103° C., more preferably from 94 to 98° C. A preferred second melting temperature is in a range from 100 to 124° C., preferably from 105 to 119° C., more preferably from 110 to 114° C.

### Adhesion/Adhesion Promoter Layer

An adhesion promoter layer is a layer of the planar composite that includes at least one adhesion promoter in a sufficient amount such that the adhesion promoter layer improves adhesion between layers adjacent to the adhesion promoter layer. For this purpose, the adhesion promoter layer preferably comprises an adhesion promoter polymer. Accordingly, the adhesion promoter layers are preferably polymeric layers. An adhesion promoter layer may be located between layers of the planar composite which are not directly adjacent to each other, preferably between the barrier layer and the inner polymer layer. Suitable adhesion promoters in an adhesion promoter layer are all plastics which, by functionalisation by means of suitable functional groups, are suitable for producing a firm bond by forming ionic bonds or covalent bonds to a surface of a respective adjacent layer. Preferably, these are functionalised polyolefins, in particular acrylic acid copolymers obtained by co-polymerisation of ethylene with acrylic acids such as acrylic acid, methacrylic acid, crotonic acid, acrylates, acrylate derivatives or double bond-bearing carboxylic acid anhydrides, for example maleic anhydride, or at least two thereof. Among these, polyethylene-maleic anhydride graft polymers (EMAH), ethylene-acrylic acid copolymers (EAA) or ethylene-methacrylic acid copolymers (EMAA) are preferred, which are marketed for example under the trade names Bynel® and Nucrel 0609HSA® by DuPont or Escor 6000 ExCo® by ExxonMobile Chemicals.

Ethylene-alkyl acrylate copolymers are also preferred as adhesion promoters. The alkyl group preferably selected is a methyl, ethyl, propyl, i-propyl, butyl-, i-butyl or a pentyl group. Further preferably, the adhesion promoter layer may comprise blends of two or more different ethylene alkyl acrylate copolymers. Equally preferably, the ethylene alkyl acrylate copolymer may have two or more different alkyl groups in the acrylate function, e.g., an ethylene alkyl acrylate copolymer in which both methyl acrylate units and ethyl acrylate units are present in the same copolymer.

According to the invention, it is preferred that the adhesion between the carrier layer, a polymer layer or the barrier layer to the respective next layer is at least 0.5 N/15 mm, preferably at least 0.7 N/15 mm and particularly preferably at least 0.8 N/15 mm. In one embodiment according to the invention, it is preferred that the adhesion between a polymer layer and a carrier layer is at least 0.3 N/15 mm, preferably at least 0.5 N/15 mm and particularly preferably at least 0.7 N/15 mm. Furthermore, it is preferred that the adhesion between the barrier layer and a polymer layer is at least 0.8 N/15 mm, preferably at least 1.0 N/15 mm and particularly preferably at least 1.4 N/15 mm. In the case that the barrier layer indirectly follows a polymer layer via an adhesion promoter layer, it is preferred that the adhesion between the barrier layer and the adhesion promoter layer is at least 1.8 N/15 mm, preferably at least 2.2 N/15 mm and particularly preferably at least 2.8 N/15 mm. In an embodiment, the adhesion between the individual layers is so strong that the adhesion test results in a tearing of the carrier layer, in particular, in the case of cardboard as the carrier layer in a so-called cardboard fibre tear.

### Container Precursor

A container precursor is a preliminary stage of the container that is created during the production of a container. In this case, the container precursor comprises a planar composite. The planar composite can be unfolded or folded. A preferred container precursor is cut to size and designed to produce a single, preferably closed, container. A preferred container precursor which is cut to size and designed to produce a single container is also referred to as a sleeve. Here the sleeve includes the planar composite folded, preferably along at least 2 longitudinal folds, more preferably along 4 longitudinal folds. These longitudinal folds are preferably, but not necessarily, arranged and configured to form longitudinal edges of a container formed in part from the container precursor. Further, the sleeve includes a longitudinal seam along which a first longitudinal margin of the planar composite is joined to a further longitudinal margin. Here, the sleeve is open in a top region and a bottom region. A preferred container precursor is formed in one piece.

### Container

The container according to the invention is preferably one selected from the group, consisting of a closed container, a foodstuff container, a dimensionally stable container, and a liquid-tight container, or a combination at least two thereof. The container wall of the container according to the invention is thus preferably dimensionally stable, i.e., substantially retains its shape during filling of the container and handling for transport as well as for storage. Preferably, the container according to the invention includes a standing base and a head portion opposite the standing base in the longitudinal direction of the container. Preferably, a central portion of the container is arranged between the standing base and the head portion. Preferably, the central portion is at least partially, preferably completely, substantially prism-shaped, preferably cuboid-shaped. Preferably, the head portion is at least partially substantially in the shape of a regular truncated pyramid. Preferably, the standing base is adjacent to the central portion. Alternatively or additionally preferred, the central portion is adjacent to the head portion. Preferably, the container interior of a container according to the invention contains a foodstuff. Preferably, the container wall is liquid-tight.

The container wall may consist of different materials. The container wall comprises the folded planar composite and the element other than the folded planar composite. A preferred element other than the folded planar composite is a non-planar component, preferably a moulded component, preferably made of plastic. The container wall may comprise one or more further non-planar components, such as one or more further moulded components, which are preferably made of plastic. Such further moulded component can be used in particular in the head portion or the standing base. In any case, however, it is preferred that at least 50%, preferably at least 60%, more preferably at least 70%, particularly preferably at least 80%, and furthermore preferably at least 90%, of the surface of the container wall facing away from the container interior (outer surface) consists of the folded planar composite.

In a preferred embodiment of the invention, the folded planar composite includes a first transverse margin and a further transverse margin opposite the first transverse margin in a longitudinal direction of the container; wherein the further transverse margin is joined to the element other than the folded planar composite; wherein an edge of the further transverse margin surrounds the element other than the folded planar composite at least partially, preferably along an entire circumference of the element other than the folded planar composite. Preferably, the edge faces the surroundings of the container. Additionally or alternatively preferred, the edge is not fully covered, preferably not at all covered, by any part of the container.

In a preferred embodiment of the invention, a bending stiffness of the folded planar composite is greater for bending in a first composite direction than for bending in a further composite direction perpendicular to the first composite direction; wherein the folded planar composite includes a first transverse margin and a further transverse margin opposite the first transverse margin in a longitudinal direction of the container; wherein the further transverse margin is joined to the element other than the folded planar composite; wherein an edge of the further transverse margin extends along at least 50%, preferably at least 60%, more preferably at least 70% more preferably at least 80%, more preferably at least 90%, still more preferably at least 95% most preferably 100%, of its length at an angle in an angular range of ±30°, preferably ±25°, more preferably ±20°, more preferably ±15°, more preferably ±10°, more preferably 5°, still more preferably ±3°, most preferably 0°, about the first composite direction. Preferably, the further transverse margin, preferably the edge of the further transverse margin, surrounds the element other than the folded planar composite, preferably along an entire circumference of the element other than the folded planar composite.

The edge of the further transverse margin, concerned in the above embodiments, is preferably a cut edge of the folded planar composite. The cut edge is to be distinguished from an edge formed by a fold. Preferably, the head portion of the container has an opening surrounded by the edge. Preferably, the edge forms a perimeter of this opening. In the container, the opening is preferably closed by the element other than the folded planar composite. Generally, the first composite direction as well as the further composite direction lie in a plane of planar extension of the folded planar composite.

In a further preferred embodiment of the invention, the carrier layer comprises a plurality of fibres; wherein the plurality of fibres has an orientation in the first composite direction. Alternatively or additionally preferred, a length of at least 55% of the fibres of the plurality of fibres extends in an angular range of 30°, more preferably ±25°, more preferably ±20°, more preferably ±15°, more preferably 10°, more preferably ±5°, still more preferably 3°, most preferably 0°, about the first composite direction.

In a further preferred embodiment of the invention, the bending stiffness of the folded planar composite, with respect to a direction of bending of the folded planar composite, has a maximum for bending in the first composite direction.

In a further preferred embodiment of the invention, the folded planar composite has a first bending stiffness for bending in the first composite direction and a further bending stiffness for bending in the further composite direction. Preferably, a ratio of the further bending stiffness to the first bending stiffness is in a range from 1:10 to 1:1.5 preferably from 1:9 to 1:1.5, more preferably from 1:8 to 1:1.5, more preferably from 1:7 to 1:1.5, more preferably from 1:6 to 1:1.5, even more preferably from 1:5 to 1:1.5, most preferably from 1:5 to 1:2. Alternatively or additionally preferred, the first bending stiffness is greater than the further bending stiffness by at least 10 mN, more preferably by at least 20 mN, more preferably by at least 30 mN, more preferably by at least 40 mN, more preferably by at least 50 mN, more preferably by at least 60 mN, more preferably by at least 70 mN, more preferably by at least 80 mN, more preferably by at least 90 mN, still more preferably by at least 100 mN, most preferably by at least 150 mN.

Alternatively or additionally preferred, the first bending stiffness is in the range from 50 to 800 mN, more preferably from 50 to 750 mN. Alternatively preferred, the first bending stiffness is in the range from 60 to 800 mN, more preferably from 70 to 800 mN, more preferably from 80 to 800 mN, more preferably from 90 to 800 mN, more preferably from 100 to 800 mN, most preferably from 100 to 750 mN. Alternatively or additionally preferred, the further bending stiffness is in the range from 50 to 750 mN, more preferably from 100 to 700 mN.

Preferably, the container includes a standing base including the first transverse margin and, in the longitudinal direction of the container opposite the standing base, a head portion including the further transverse margin. Preferably, the standing base is formed entirely from the folded planar composite.

In a further preferred embodiment of the invention, the container includes a standing base and, in a longitudinal direction, extending along a length of the container, opposite the standing base, a head portion; wherein the head portion includes at least 3, preferably from 3 to 12, more preferably from 3 to 10, more preferably from 3 to 8, more preferably from 3 to 6, still more preferably 3 or 4, most preferably 4, preferably planar, head side surfaces formed from the folded planar composite, wherein the head side surfaces are inclined to each other in the longitudinal direction of the container, such that each of the head side surfaces is at an angle in a range from 55 to 70°, preferably from 55 to 69°, more preferably from 55 to 68°, more preferably from 55 to 67°, more preferably from 55 to 66°, more preferably from 55 to 65°, more preferably from 55 to 64°, more preferably from 56 to 63°, more preferably from 57 to 62°, more preferably from 58 to 61°, still more preferably from 58.5 to 60.0°, to the longitudinal direction of the container. Alternatively preferred, the preceding angle is in a range from 56 to 70°, more preferably from 57 to 70°, more preferably from 58 to 70°, more preferably from 59 to 70°, more preferably from 60 to 70°, more preferably from 61 to 70°, more preferably from 62 to 69°, more preferably from 63 to 68°, more preferably from 64 to 67°, still more preferably from 65.0 to 66.0°.

In a further preferred embodiment of the invention, the container includes a standing base and, in a longitudinal direction, extending along a length of the container, opposite the standing base, a head portion; the head portion including at least 3, preferably 4, preferably planar, head side surfaces formed of the folded planar composite, the head side surfaces being inclined to each other in the longitudinal direction such that the container tapers at least in sections in the head portion; wherein a perimeter of each of the head side surfaces is respectively formed by a plurality of side edges of the head portion; wherein each of the plurality of side edges includes a pair of steep edges opposite to each other in a circumferential direction of the closed container perpendicular to the longitudinal direction; wherein the steep edges of each pair of steep edges of each of the head side surfaces lie in a plane of the respective head side surface and, in this plane of the respective head side surface, run at an angle in the range of from 40 to 60°, preferably from 41 to 59°, more preferably from 42 to 58°, more preferably from 43 to 57°, more preferably from 44 to 57°, more preferably from 45 to 57°, more preferably from 46 to 57°, more preferably from 47 to 57°, more preferably from 48 to 57°, more preferably from 49 to 57°, more preferably from 50 to 57°, more preferably from 51 to 57°, more preferably from 52 to 57°, more preferably from 53 to 56°, more preferably from 53.5 to 55.5°, still more preferably from 54.0 to 55.0°, to one other.

Alternatively preferably, the steep edges of each pair of steep edges of each of the head side surfaces lie in a plane of the respective head side surface and, in this plane of the respective head side surface, run at an angle in the range of from 43 to 56°, more preferably from 43 to 55°, more preferably from 43 to 54°, more preferably from 43 to 53°, more preferably from 43 to 52°, more preferably from 43 to 51°, more preferably from 43 to 50°, more preferably from 43 to 49°, more preferably from 43 to 48°, more preferably from 43 to 47°, more preferably from 44.0 to 46.0°, still more preferably from 44.5 to 45.5°, to one other.

In a further preferred embodiment of the invention, the container has 4 longitudinal edges, each longitudinal edge, each longitudinal edge of the container extending along the length of the container from the standing base to the head portion, wherein the container has a square cross-section along its length between the standing base and the head portion at least in sections, preferably continuously, wherein the shortest of the 4 longitudinal edges has a length 1, wherein a ratio of the length 1 to an edge length a of the square cross-section lies in a range from 1.3 to 2.95, preferably from 1.35 to 2.95, more preferably from 1.38 to 2.8, most preferably from 1.39 to 2.8. The length 1 is the height of the container excluding its head portion. Preferably, the 4 longitudinal edges are of equal length. In principle, however, it is also possible that, for example, 2 longitudinal edges are shorter than the other two longitudinal edges. In this case, the length 1 designates the shorter longitudinal edges.

In a further preferred embodiment of the container according to the invention, the element other than the folded planar composite forms a first part of the container wall; wherein the folded planar composite comprises a plurality of grooves and has been folded along the grooves of the plurality of grooves and portions of the folded planar composite have been joined to one another to form a further part of the container wall.

In a further preferred embodiment of the container, the folded planar composite includes a first transverse margin and a further transverse margin opposite the first transverse margin in a longitudinal direction of the container; wherein a standing base of the container has been formed by folding along grooves of the plurality of grooves in the first transverse margin and joining portions of the folded planar composite to one another; wherein the plurality of grooves comprises at least one auxiliary groove, preferably at least 2 auxiliary grooves, more preferably at least 3 auxiliary grooves, most preferably 4 auxiliary grooves; wherein each auxiliary groove is arranged next to a longitudinal groove of the plurality of grooves in the first transverse margin such that a bending radius of a longitudinal fold along this longitudinal groove is increased at least in sections of the longitudinal fold.

In a preferred embodiment of the process according to the invention, the element other than the folded planar composite is designed to form a first part of a container wall surrounding a container interior of the container; wherein the folded planar composite of the container precursor in the process step a) comprises a plurality of grooves arranged and configured such that by further folding the folded planar composite along the grooves of the plurality of grooves and joining portions of the folded planar composite to one another a further part of the container wall is obtainable.

In a further preferred embodiment of the process, the folded planar composite includes a first transverse margin and a further transverse margin opposite the first transverse margin in a longitudinal direction of the container; wherein a standing base of the container is obtainable by folding along grooves of the plurality of grooves in the first transverse margin and joining portions of the folded planar composite to one another; wherein the plurality of grooves comprises at least one auxiliary groove, preferably at least 2 auxiliary grooves, more preferably at least 3 auxiliary grooves, most preferably 4 auxiliary grooves; wherein each auxiliary groove is arranged next to a longitudinal groove of the plurality of grooves in the transverse margin such that a bending radius of a longitudinal fold along this longitudinal groove is increased at least in sections of the longitudinal fold.

For the container and the process of the invention it is preferred that, each auxiliary groove curves away from the respective longitudinal groove. Additionally or alternatively preferred, each auxiliary groove is arranged on a side of the respective longitudinal groove which faces away from a centre of the folded planar composite, based on a circumferential direction of the container which is perpendicular to the longitudinal direction of the container.

Element Other than the Folded Planar Composite/Non-Planar Component

In principle, any element which appears suitable to the person skilled in the art in the context of the invention can be used as an element other than the folded planar composite. A preferred element other than the folded planar composite is a non-planar component. The non-planar component is three-dimensional, i.e., not planar or sheet-like. A preferred non-planar component is a moulded component. A preferred moulded component is an injection moulded component. Alternatively or additionally preferred, the element other than the folded planar composite is made of plastic. An alternatively or additionally preferred element other than the folded planar composite is formed in one piece. Preferably, the element other than the folded planar composite forms a top surface of the head portion of the container according to the invention. A preferred top surface is the top surface of a regular truncated pyramid. Preferably, the element other than the folded planar composite forms a first part of the container wall of the container, while the folded planar composite forms a further part of the container wall of the container.

Preferably, the element other than the folded planar composite includes a base member and a spout arranged on the base member. A spout is a component, the shape of which is intended to facilitate the targeted pouring of liquid. A preferred spout takes the form of a tube. Preferably, the tube includes a screw thread on its outer side. Preferably, the spout has a pouring aperture which is closed by a closure element. A preferred closure element is planar. A preferred planar closure element is a laminate or a foil. A preferred foil is a plastic foil. The base member preferably includes a base plate, and at least 3, preferably 3 to 12, more preferably 3 to 10, more preferably 3 to 8, more preferably 3 to 6, still more preferably 3 or 4, most preferably exactly 4, side walls; the spout being arranged on a first side of the base plate; the side walls being arranged on a further side of the base plate opposite the first side. Preferably, the further side of the base plate in the container faces the container interior and the first side of the base plate in the container faces away from the container interior. The base plate preferably has a base surface in the form of a polygon. A preferred polygon here is a regular polygon. Alternatively or additionally preferred, the polygon has 3 to 12, more preferably 3 to 10, more preferably 3 to 8, more preferably 3 to 6, still more preferably 3 or 4, most preferably exactly 4, corners. A preferred polygon with 4 corners is a rectangle. A preferred rectangle is a square. Preferably, the base member has as many side walls as the polygon has corners. Preferably, each 2 of the side walls which follow one another in the circumferential direction of the element other than the folded planar composite adjoin one another, forming a side edge of the base member. Preferably, the base member and the spout are in one piece with one another. Preferably, the element other than the folded planar composite is formed in one piece.

Preferably, the folded planar composite and the element other than the folded planar composite are glued or sealed together or both. Preferably, the further transverse margin of the folded planar composite is glued or sealed or both to the element other than the folded planar composite. Preferably the folded planar composite is joined to one of the side walls, preferably each of the side walls, of the element other than the folded planar composite, preferably directly. A preferred element other than the folded planar composite, preferably the spout, includes a screw thread. A pouring aperture of the spout is preferably closed. Preferably, an opening aid is arranged in the spout. In this case, the container preferably also includes the opening aid. A preferred opening aid is a cutting aid or a tearing aid or both. Alternatively or additionally preferred, the opening aid is annular. A preferred annular cutting aid is a cutting ring. A preferred annular tear aid is a tear ring. A cap, preferably a screw cap, is preferably arranged on the element other than the folded planar composite in such a way that the pouring aperture of the spout is covered by the cap. Preferably, the cap is screwed onto the spout. In this case, the closed container preferably also includes the cap.

### Grooves

In the context of the invention, a groove, is a linear material modification intended to facilitate folding of the planar composite along the groove. In particular, the groove is intended to allow a fold to be produced as precisely as possible along the groove. Accordingly, a container can be formed from a planar composite having a corresponding groove pattern consisting of grooves by folding along the grooves. This groove pattern is also referred to herein as the plurality of grooves.

Along the groove, the planar composite preferably has a depression, preferably in the form of a material displacement, on one side, preferably its outer side. On the opposite side, preferably the inner side, the planar composite preferably has a bulge along the groove.

In addition to the aforementioned folding, the production of the container includes the joining of areas of the folded planar composite that have been contacted by way of the folding. Grooving tools are used to introduce the grooves into the planar composite, a process known as grooving. A grooving tool in the context of the invention may be any tool suitable for grooving a planar composite or a carrier layer. For grooving, the grooving tool preferably includes a linear elevation which has a shape of the linear depression. By contacting the planar composite or carrier layer with the linear elevation, the linear depression can be introduced into the planar composite or carrier layer. Thus, the grooving tool can also be referred to as a pressing tool. As a counterpart to the aforementioned positive tool, the grooving tool may also include a negative tool. The negative tool includes a linear recess, which may also be referred to as groove-shaped. The linear recess preferably has, in a direction of its linear extension, the shape of the linear elevation of the positive tool and is further configured to at least partially receive material of the planar composite or carrier layer displaced by the positive tool during grooving.

### Joining

Any joining method which appears to the skilled person to be suitable for use according to the invention and by which a sufficiently strong joint can be obtained may be considered in the context of the invention. A preferred joining method is a material-to-material joining method. A material-to-material joint is understood herein to be a joint between joining partners which is produced by attractive forces between materials or within a material. A distinction must be made between this and, in particular, form-fitting and friction-fitting joints that are created by geometric shapes or frictional forces. A preferred material-to-material joining method may be one selected from the group consisting of a sealing, a welding, a gluing, and a pressing, or a combination of at least two of them. In the cases of sealing and welding, the joint is created by means of a liquid and its solidification. In the case of gluing, chemical bonds are formed between the surfaces of the two objects to be joined, which create the joint. It is often advantageous in the case of sealing, welding or gluing to press the surfaces to be joined together. A preferred pressing of two layers is a pressing of a respective first surface of a first of the two layers onto a second surface of the second of the two layers facing the first surface over at least 20%, preferably at least 30%, more preferably at least 40%, more preferably at least 50% more preferably at least 60%, more preferably at least 70%, still more preferably at least 80% still more preferably at least 90%, most preferably at least 95%, of the first surface. A particularly preferred joining is a sealing or welding. A preferred sealing or welding includes as steps a contacting, a heating and a pressing, wherein the steps are preferably performed in this sequence. Another sequence is also conceivable, in particular the sequence of heating, contacting and pressing.

A preferred heating is a heating of a polymer layer, preferably a thermoplastic layer, more preferably a polyethylene layer or a polypropylene layer or both. Another preferred heating is a heating of a polyethylene layer to a temperature in a range from 80 to 140° C., more preferably from 90 to 130° C., most preferably from 100 to 120° C. Another preferred heating is a heating of a polypropylene layer to a temperature in a range from 120 to 200° C., more preferably from 130 to 180° C., most preferably from 140 to 170° C. Another preferred heating is to a sealing temperature of the polymer layer. A further preferred heating is a heating of an element other than the folded planar composite, preferably of at least one side wall of a base member, preferably to a temperature above a melting temperature of the first polymer composition. Preferred heating may be by friction, by radiation, by hot gas, by hit solid contact, by mechanical vibration, preferably by ultrasound, by convection, or by a combination of at least two of these.

### Extruding/Extruder

In the context of the invention, every extruder known to the skilled person and which appears to him to be suitable for purposes of the invention comes into consideration. An extruder is a device for shaping a mass, preferably a polymer mass, by pressing through a shaping orifice. A preferred extruder is a screw extruder. A melt extrusion coating is an application of a mass by pressing a melt, forming the mass, through the shaping orifice of an extruder onto a substrate so that a planar layer of the mass superimposing the substrate is obtained. In the case of a polymer composition as a mass, the mass is preferably melted for extrusion coating. During extrusion, the polymers are typically heated to temperatures of 210 to 350° C., measured at the molten polymer film below the exit at the extruder die. Extrusion can be carried out by means of commercially available extrusion tools known to the person skilled in the art, such as extruders, extruder screws, feedblocks, etc. At the end of the extruder there is preferably an orifice through which the polymer melt is pressed. The orifice can have any shape that allows the polymer melt to be extruded. For example, the orifice may be angular, oval or round. Preferably, the orifice has the shape of a slot of a funnel. After the melt layer has been applied to the substrate by means of the method described above, the melt layer is allowed to cool for the purpose of heat-setting, this cooling preferably being effected by quenching via contact with a surface maintained at a temperature in a range from 5 to 50° C., more preferably in a range from 10 to 30° C.

Subsequently, at least the flanks are separated from the surface. The separation can be carried out in any way that is familiar to the skilled person and appears suitable in order to separate the flanks quickly, as accurately as possible and cleanly. Preferably, the separation is carried out by means of a knife, laser beam or water jet, or a combination of two or more of these, whereby the use of knives, in particular a pot knife, is particularly preferred.

### Laminating

According to the invention, the superimposing the carrier layer with the barrier layer can be carried out by laminating. In this case, the prefabricated carrier and barrier layers are joined with the aid of a suitable laminating agent. A preferred laminating agent comprises, preferably consists of, an intermediate polymer composition, from which an intermediate polymer layer is preferably obtained.

### Foodstuff

All food products known to the skilled person for human consumption and also animal feed may be considered as foodstuffs. Preferred foodstuff is liquid above 5° C., for example dairy products, soups, sauces and, preferably non-carbonated, beverages.

### Edges

Edges are defined herein as both the linear regions of the container wall of the container according to the invention, which are formed by a folding of the planar composite and at which in each case two, preferably flat, regions of the folded planar composite adjoin each other, and edges which delimit the dimensions of the folded planar composite. The first-mentioned edges are folding edges. These include the side edges of the head portion of the container according to the invention and its longitudinal edges. The second-mentioned edges are cut edges. These include in particular the edge of the further transverse margin. The term “cut edge” herein does not necessarily mean that the planar composite has been cut by a knife. Rather, the planar composite can also have been punched out of a web, for example.

### Directions

The longitudinal direction of the container runs from the standing base to the head portion. Here, the longitudinal direction runs along a straight line. Preferably, the longitudinal direction of the container runs along a height of the container. The longitudinal direction of the container is also referred to as first direction herein. The circumferential direction of the container is perpendicular to the longitudinal direction. Since the circumferential direction runs along the circumference of the container, it does not follow a straight line. The planar composite has directions corresponding to the longitudinal direction and the circumferential direction of the container. On the planar composite, if it is unfolded to a flat state, the longitudinal direction and the circumferential direction are still perpendicular to each other, but here both directions run along straight lines that lie in the plane of planar extension of the planar composite.

The first composite direction and the further composite direction are perpendicular to each other. Both composite directions lie in the plane of planar extension of the planar composite. The plane of planar extension of the planar composite is not necessarily plane in Cartesian coordinates. In particular, if the planar composite is bent or folded, the plane follows this bend or fold. This is particularly the case for the folded planar composite of the container according to the invention.

The longitudinal direction of the element other than the folded planar composite runs along a straight line from the base element to the spout. Preferably, the longitudinal direction of the element other than the folded planar composite runs along a height of the element other than the folded planar composite. Additionally or alternatively preferred, the longitudinal direction of the element other than the folded planar composite runs along a longitudinal axis of the spout. Additionally or alternatively preferred, the longitudinal direction of the element other than the folded planar composite is perpendicular to the base plate. The circumferential direction of the element other than the folded planar composite is perpendicular to its longitudinal direction. Since the circumferential direction runs along the circumference of the element other than the folded planar composite, it does not follow a straight line. Preferably, in the container according to the invention, the longitudinal directions of the container and of the element other than the folded planar composite are identical. Additionally or alternatively preferred, in the container according to the invention, the circumferential directions of the container and of the element other than the folded planar composite are identical.

### Process Steps

The process steps of the process according to the invention are carried out in the order of their symbols. In principle, process steps with immediately successive symbols can be carried out one after the other, at the same time or overlapping in time.

### Colourant

Both solid and liquid colourants known to the person skilled in the art and suitable for the present invention may be considered. According to DIN 55943:2001-10, colourant is the collective term for all colouring substances, in particular for dyes and pigments. A preferred colourant is a pigment. A preferred pigment is an organic pigment. Pigments of note in the context of the invention are, in particular, those described in DIN 55943:2001-10 and those described in “Industrial Organic Pigments, Third Edition”. (Willy Herbst, Klaus Hunger Copyright© 2004 WILEY-VCH Verlag GmbH & Co. KGaA, Weinheim ISBN: 3-527-30576-9). A pigment is a colourant that is preferably insoluble in the application medium. A dye is a colourant that is preferably soluble in the application medium.

### Skiving

Skiving is a method step known to the skilled person for reducing a layer thickness of a layer, preferably a carrier layer, more preferably a carrier layer of a material selected from the group consisting of cardboard, paperboard and paper, or a combination of at least two of them. The skiving is preferably carried out using a machining tool, preferably a skiving tool or a cutting tool or both. A further preferred machining tool is a rotating tool. A preferred rotating tool is a knife, preferably a pot knife, or a milling tool, or both. A further preferred machining tool is a knife, preferably a rotating knife, more preferably a pot knife, or a milling tool, or both.

### Measurement Methods

The following measurement methods were used within the scope of the invention. Unless otherwise stated, the measurements were carried out at an ambient temperature of 23° C., an ambient air pressure of 100 kPa (0.986 atm) and a relative humidity of 50%.

### Separating Individual Layers

If individual layers of a laminate—such as the barrier layer—are to be examined, the layer to be examined is first separated from the laminate as described below. Three sample pieces of the laminate are cut to size. For this purpose, unfolded and ungrooved areas of the laminate are used, unless otherwise specified. Unless otherwise specified, the sample pieces shall be 4 cm×4 cm. If other dimensions of the layer to be examined are necessary for the examination to be carried out, sufficiently large sample pieces are cut from the laminate. The sample pieces are placed in an acetic acid bath heated to 60° C. (30% acetic acid solution: 30% by weight CHCOOH₃, remainder to 100% by weight H₂O) for 30 minutes. This detaches the layers from each other. Here, if necessary, the layers can also be carefully peeled off from each other manually. If the desired layer cannot be detached sufficiently well, alternatively new sample pieces are used and these are treated in an ethanol bath (99% ethanol) as described above. If there are remnants of the carrier layer (especially in the case of a cardboard layer as carrier layer) on the layer to be examined (for example the outer polymer layer or the intermediate polymer layer), these are carefully removed with a brush. From each of the three films prepared in this way, a sample of sufficient size for the test to be carried out is cut out (unless otherwise specified, with an area of 4 cm²). These samples are then stored at 23° C. for 4 hours and thus dried. The three samples can then be examined. Unless otherwise stated, the test result is the arithmetic mean of the results for the three samples.

### MFR Value

The MFR value is measured according to ISO 1133-1:2012, method A (mass determination method), unless otherwise stated at 190° C. and 2.16 kg).

### Density

The density is measured according to the ISO 1183-1:2013 standard.

### Scott Bond Value

The Scott Bond value is determined in accordance with Tappi 569.

### Melting Temperature

The melting temperature is determined using the DSC method ISO 11357-1, -3. The device is calibrated according to the manufacturer's instructions using the following measurements:
Temperature Indium—Onset Temperature,
Heat of fusion Indium,
Temperature Zinc—Onset Temperature.

The recorded measurement curve can show multiple local maxima (melting peaks), i.e., multiple melting temperatures. If a melting temperature above a certain value is required herein, this condition is fulfilled if one of the measured melting temperatures is above this value. Where reference is made herein to a melting temperature of a polymer layer, a polymer composition or a polymer, the highest melting temperature is always meant in the case of multiple measured melting temperatures (melting peaks), unless otherwise stated.

### Viscosity Number of PA

The viscosity number of PA is measured in 95% sulphuric acid according to the standard DIN EN ISO 307 (2013).

### Molecular Weight Distribution

The molecular weight distribution is measured by gel permeation chromatography using light scattering: ISO 16014-3/-5 (2009-09).

### Residual Moisture Content of Cardboard

The residual moisture content of the cardboard is measured according to the ISO 287:2009 standard.

### Oxygen Permeation Rate

The oxygen permeation rate is determined according to ASTM D3985-05 (2010). The layer thickness of the test specimen is 90 μm±2 μm. The area of the test specimen is 50 cm². The measurements are carried out at an ambient temperature of 23° C., an ambient air pressure of 100 kPa (0.986 atm) and a relative humidity of 50%. The tester is an Ox-Tran 2/22 from Mocon, Neuwied, Germany.

### Detection of Colourants

Detection of organic colourants can be carried out according to the methods described in “Industrial Organic Pigments, Third Edition”. (Willy Herbst, Klaus Hunger Copyright© 2004 WILEY-VCH Verlag GmbH & Co. KGaA, Weinheim ISBN: 3-527-30576-9).

### Adhesion

To determine the adhesion of two adjacent layers, they are fixed on a 90° peel test device, for example from the company Instron “German rotating wheel fixture”, on a rotating roller that rotates at 40 mm/min during the measurement. The samples were previously cut into 15 mm wide strips. On one side of the sample, the layers are detached from each other and the detached end is clamped in a pulling device that points vertically upwards. A measuring device is attached to the pulling device to determine the pulling force. When the roller is rotated, the force required to separate the layers from each other is measured. This force corresponds to the adhesion of the layers to each other and is given in N/15 mm. The separation of the individual layers can be done mechanically, for example, or by a specific pre-treatment, for example by soaking the sample for 3 min in 60° C. warm, 30% acetic acid.

### Bending Stiffness

The following devices are used to determine the bending stiffness of a sheet-like material, in particular a planar composite or cardboard:
bending stiffness tester L&W Bending Tester Code 160, type 977682 from Lorentzen & Wettre, Sweden,
punching machine for bending stiffness samples.

The material to be tested is climatised for 24 h in a standard climate (23° C., 50% relative humidity). The measurement is also carried out in a standard climate. Specimens with a width of 38.1 mm and a length of 69.85 mm are punched out of the material to be tested. In the case of roll material, the specimens are taken at 5 positions distributed over the width of the web. In any case, for each bending direction of the material to be tested, 2 specimens with their length in the corresponding bending direction of the material are punched out of the material at each specimen-taking position. Specimens may only be taken from areas of the material to be tested which neither have grooves nor folds.

Per bending direction to be considered, the bending stiffness (in mN) of the outer side and the opposite inner side is determined. For this purpose, the specimen is placed in the bending stiffness tester with the side to be measured facing forwards and the measurement is started by pressing the green button. For each combination of bending direction and material side (outer side or inner side), the same number of specimens is measured. A 2-point bending test is carried out by the bending stiffness measuring device. In this test, the specimen clamped at one end is deflected at its other end by a measuring edge through a bending angle of 15°. Here, a direction in which the material has the bending stiffness, i.e., the bending direction, is the direction of a straight line connecting the two points at which bending forces are exerted to the specimen in the 2-point bending test. In the case of the bending stiffness tester, this direction is the direction of the shortest straight line from the clamp to the measuring edge. In this direction, the specimen forms a curve during bending. Perpendicular to this direction, a straight fold line would form if the specimen were bent far enough for this. The free clamping length of the specimen is 50 mm. Each specimen may only be used for one measurement. Measurements of the outer side and the inner side on the same specimen are not permitted. The individual measured values are read from the display.

If multiple specimens were measured for each of the combinations of bending direction and material side, the arithmetic mean over the specimens is calculated for each of the combinations individually. The arithmetic mean values are then used as values for each of the combinations of bending direction and material side. The bending stiffness in a specific bending direction is the geometric mean over the values for the combinations of this bending direction/outer side and this bending direction/inner side.

### Transport Simulation

The containers to be tested are placed on as many pallets as necessary to have all the containers on a pallet without stacking containers. Each pallet separately is subjected to a vibration test. For this, the pallet is placed on a vibrating test stand of the type KF 458 05-09 from konzept GmbH, Duren, Germany. The vibrating test stand is activated for 30 minutes at a frequency of 60 Hz. During the vibration test, the pallet is lifted by 22 mm. This is the amplitude of the vibrations. Liquid tightness of the containers is tested 14 days after the transport simulation.

### Liquid Tightness

Crystal oil 60 from Shell Chemicals with methylene blue is used as the test agent for testing the liquid tightness of a container. In order to determine if a certain container type is liquid-tight, 250 identical containers of this container type are tested. Each of the 250 containers is cut open along its circumference so as to obtain a first open cup-like container part containing the sealed container bottom and a second open cup-like container part containing the sealed container top. The first container part with the container bottom and the second container part with the container top are each first emptied and then filled with an amount of the test agent sufficient to completely cover the bottom of the respective cup-like container part. Then the container parts are stored for 24 hours. After the storage time, each container part is examined on its outer side with the naked eye to see whether the test agent has produced a blue discolouration there in the event of a leak. If in this test not more than 1 of the 500 container parts of the 250 identical containers shows such a discolouration, these containers are considered to be liquid-tight.

If different container types are to be compared in terms of the liquid tightness of their head portions, for each of these container types 1,000 identical containers are tested. Here, the second open cup-like container parts with the container tops are prepared and filled with an amount of the test agent as described above. Then the second container parts are stored for 24 hours. After the storage time, each second container part is examined on its outer side with the naked eye to see whether the test agent has produced a blue discolouration there in the event of a leak. For each of the container types to be compared, out of the 1,000 second container parts, the number of second container parts which show blue discolourations is counted. The fewer second container parts show blue discolourations, the better the respective container type performs in terms of liquid tightness.

### Compression Stability

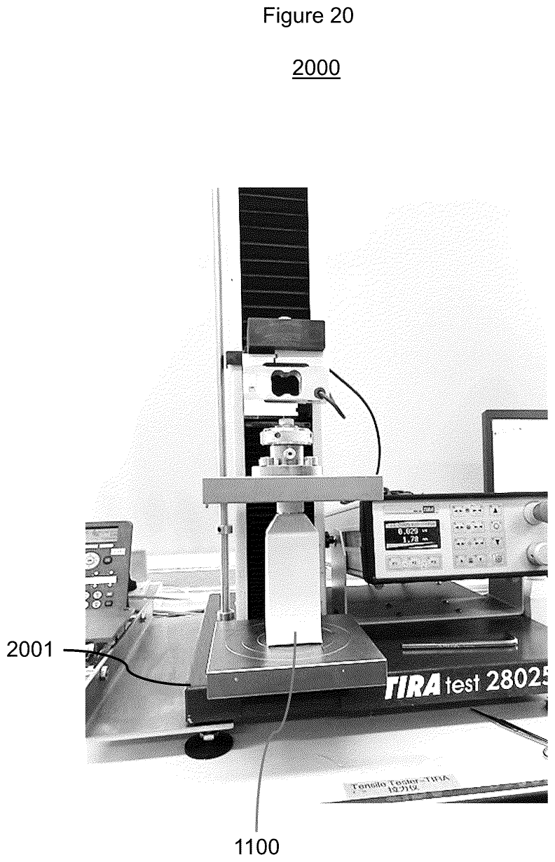

For this test, 5 containers are manufactured and filled with water before closing. The test serves to determine the stability of the container against compression along its longitudinal axis and can be used to evaluate the load capacity of filled containers in the static case of storage and in the dynamic case of transport. The test is carried out on the individual containers in accordance with DIN EN ISO12048. The previous storage of the containers is carried out according to DIN EN ISO 2233:2000. A TIRA test 28025 with force transducer 1000 N (Tira GmbH; Eisfelder Strasse 23/25; 96528 Schalkau, Germany) is used as measuring instrument. The mean value of the maximum breaking load (load value) is determined. This describes the value that leads to the failure of the container. The test setup is shown in FIG. 20.

### Grip Stiffness

In this test, 2 non-elastic plastic balls grip the closed container at opposite pressure points and exert a specified force on the container in the lateral direction. It is determined how far the closed container is compressed laterally by this force (distance in mm). This simulates the stiffness of the container during manual gripping.

The following tools are used for the test:
Universal tensile testing machine TIRA test 28025 (Tira GmbH; Eisfelder Strasse 23/25; 96528 Schalkau, Germany) with force transducer: 1000 N
XY-coordinate table
non-elastic plastic balls with diameter of 18 mm

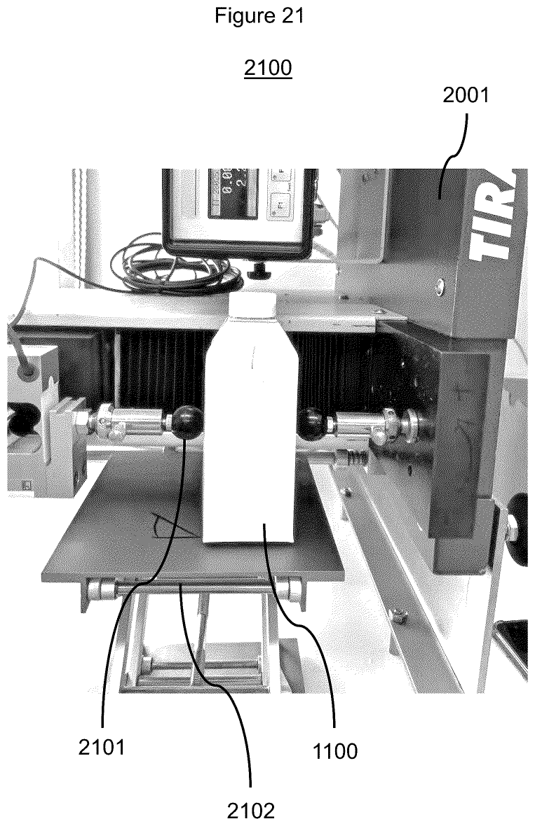

The tensile testing machine is equipped with the plastic balls. Containers of the same weight and filling level are always to be compared with the test. The test setup is shown in FIG. 21.

For each type of container to be examined, 10 containers are subjected to the test. The grip stiffness in the middle of the closed container, with respect to its total height, is determined. Corresponding pressure points, at which the plastic balls are to grip, are marked on the outside of the container before the measurement. The two pressure points are located on opposite side surfaces of the container, namely laterally in the middle of the respective side surface and in the middle of the total height of the container. After marking the pressure points, the container is aligned on the XY-coordinate table on the tensile testing machine between the two non-elastic plastic balls. The container must not yet touch the fixed plastic ball. The result of the grip stiffness test is the distance travelled when the force corresponding to the weight force of the closed container multiplied by 1.5 is reached.

### Angle (α) Between Steep Edges

In order to determine the angle α at which the steep edges of a pair of steep edges of a head side surface run to each other on a container, the container is prepared as follows.

The container is opened below its (possibly truncated pyramid-shaped) head portion with a knife by a lateral cut through 3 of the 4 sides of the container and then emptied. Furthermore, the bottom of the container is unfolded. For this purpose, the sealing of the ears on the bottom is first loosened manually. The seam that closes the bottom of the container is not yet released.

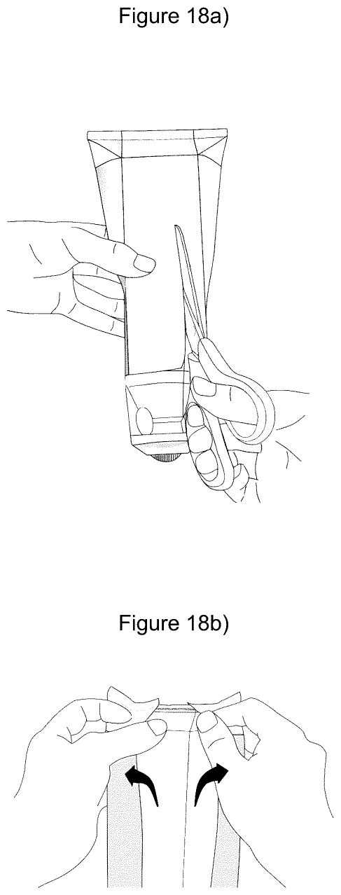

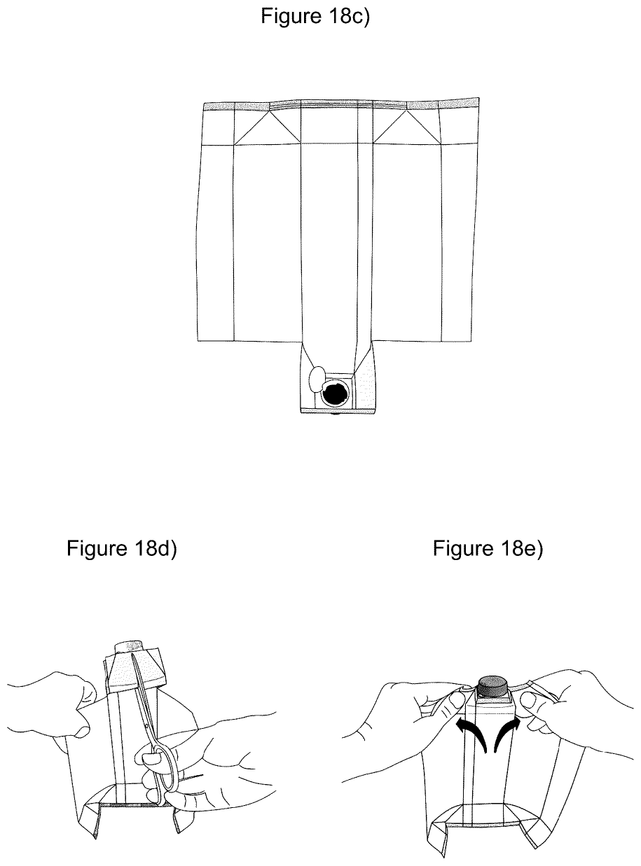

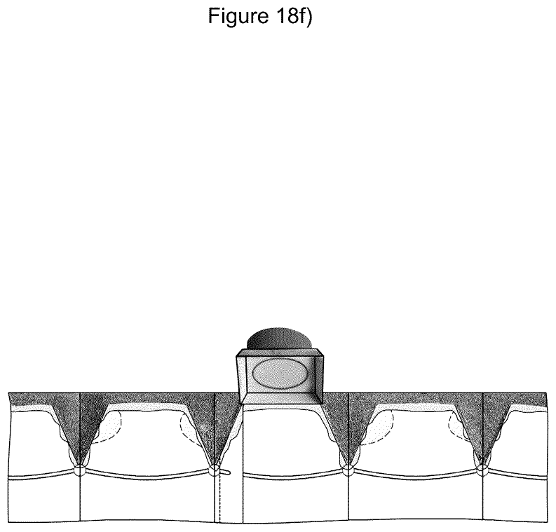

Next, the container is cut open along its length with scissors. The cut is made on the side of the container opposite its longitudinal seam. The cut begins at the cut edge below the head portion which has been obtained described above. The cut is made in the direction of the bottom of the container. This is illustrated in FIG. 18a). Then the seam closing the bottom is slowly loosened manually from the inside to the outside. This is illustrated in FIG. 18b). The sample thus obtained is illustrated in FIG. 18c). Further, as shown in FIG. 18d), the head portion on the side opposite the longitudinal seam is cut with the scissors in the longitudinal direction up to the element other than the planar composite or blank. Then the seam joining the composite to the element is slowly released manually starting from the cut. This is illustrated in FIG. 18e). The part of the composite below the head portion is now cut off. The remaining sample is shown schematically in FIG. 18f).

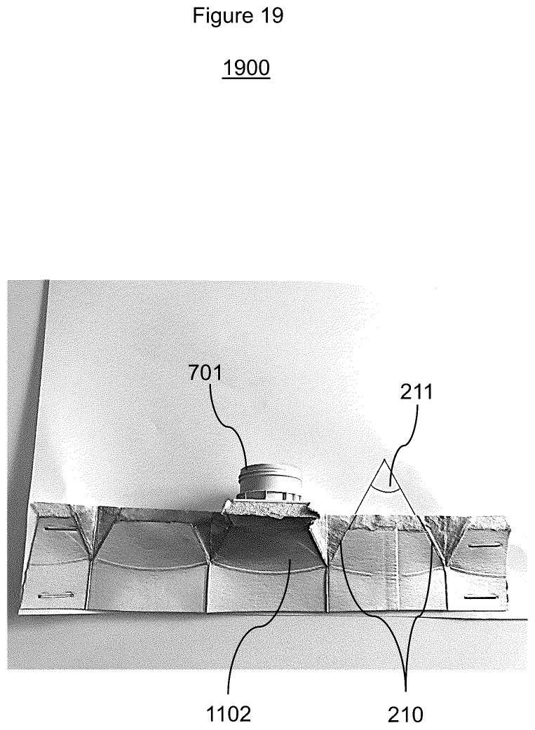

The sample prepared as described above is now fixed flat on a white sheet of paper. For this purpose, the composite can be stapled to the sheet of paper. Then the two grooves for the pair of steep edges are extended in a straight line on the sheet of paper with a pencil so that the extensions intersect. Now the angle at which one groove and its extension, one the one hand, runs to the other groove and its extension, on the other hand, is measured with a geometry set square. FIG. 19 shows the measuring arrangement.

### Angle (β) of the Inclination of the Head Side Surfaces to the Height of the Container

In order to determine the angle β of inclination of the head side faces of a container (the side faces of the truncated pyramid), the container is fixed flat with one side on a white sheet of paper. Then one steep edge of the head side surface, whose angle of inclination is to be determined, and the adjoining longitudinal edge of the container are transferred as straight lines onto the sheet of paper with a pencil. Now measure the angle between the straight lines representing the steep edge and the longitudinal edge on the sheet of paper with a geometry set square. This measuring process is repeated for the other steep edge of the same head side surface. The angle of inclination of this head side surface is then the mean value of the angles determined for the two steep edges.

### Angle (γ) of the Inclination of the Side Walls of the Base Member to its Longitudinal Direction

The angle γ of inclination of the side walls of the base member of the element other than the folded planar composite is determined with respect to the longitudinal direction of the element other than the folded planar composite, which runs from the base member to the spout. A flat object with a plane surface is positioned on the side wall of the base member in such a way that the plane surface makes the same angle with the longitudinal direction as the side wall. In addition, the lower edge of a geometry set square is placed on the underside of the element other than the folded planar composite (the side opposite the spout) in such a way that the angle of the plane surface to the longitudinal direction can be read off the geometry set square as the angle γ.

The invention is described in more detail below by means of examples and drawings, whereby the examples and drawings do not imply any limitation of the invention. Furthermore, the drawings are not to scale unless otherwise indicated.

### Laminate Structure

In the examples (according to the invention) and comparative examples (not according to the invention), laminates with the layer structure shown in Table 1 below are used for container production.

TABLE 1
Structure of the laminates of the examples
and the comparative examples

| | | Basis weight |
|---|---|---|
| Layer | Material | [g/m²] |
| Outer polymer | LDPE 23L430 from Ineos GmbH, | 15 |
| layer | Cologne, Germany | |
| Carrier layer | Cardboard: Stora Enso Natura T Duplex | 220 |
| | double paper coating, Scott-Bond 20 | |
| | J/m², residual moisture content 7.5% | |
| Intermediate | LDPE 23L430 from Ineos GmbH, | 18 |
| polymer layer | Cologne, Germany | |
| Adhesion | Escor 6000 HSC from Exxon Mobil | 3 |
| promoter layer | Corporation | |
| Barrier layer | Aluminium, EN AW 8079 from Hydro | here: |
| | Aluminium Deutschland GmbH | thickness 6 μm |
| Inner polymer | LDPE 23L430 from Ineos | 45 |
| layer | GmbH, Cologne, Germany | |

### Laminate Production

The laminates for the examples and comparative examples are produced using a melt extrusion coating line from Davis Standard. Here, the extrusion temperature is in a range of approx. 280 to 330° C. In the first step, a hole is made in the carrier layer, which is provided as roll material, for each container to be produced, and then the outer polymer layer is applied to the full surface of the carrier layer by melt extrusion coating. Furthermore, the barrier layer, together with the adhesion promoter layer and the intermediate polymer layer as laminating agents, is applied over the entire surface of the carrier layer previously coated with the outer polymer layer. Subsequently, the inner polymer layer is extrusion coated over the entire surface of the barrier layer. To apply the individual layers by melt extrusion coating, the polymers are melted in an extruder. When applying a polymer in a layer, the resulting melt is transferred via a feed block into a die and extruded onto the carrier layer.

### Container Production

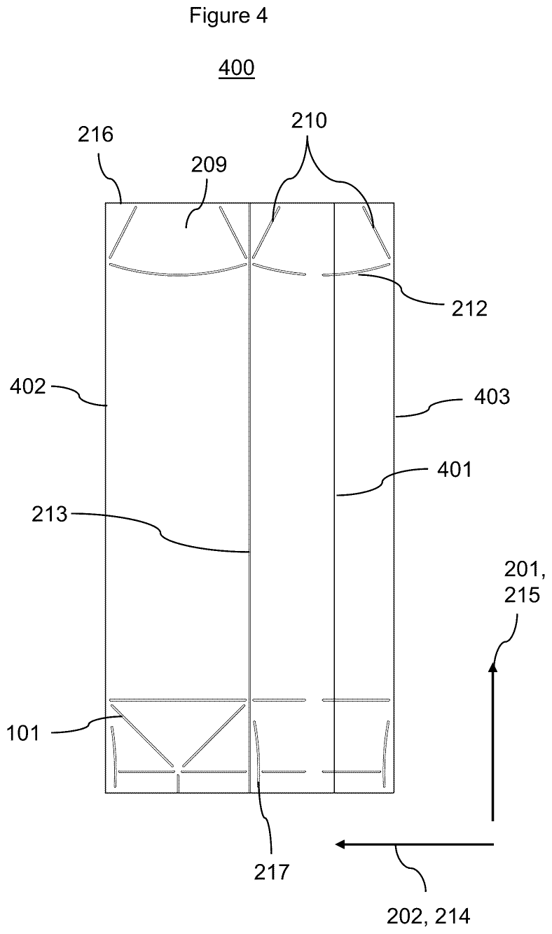

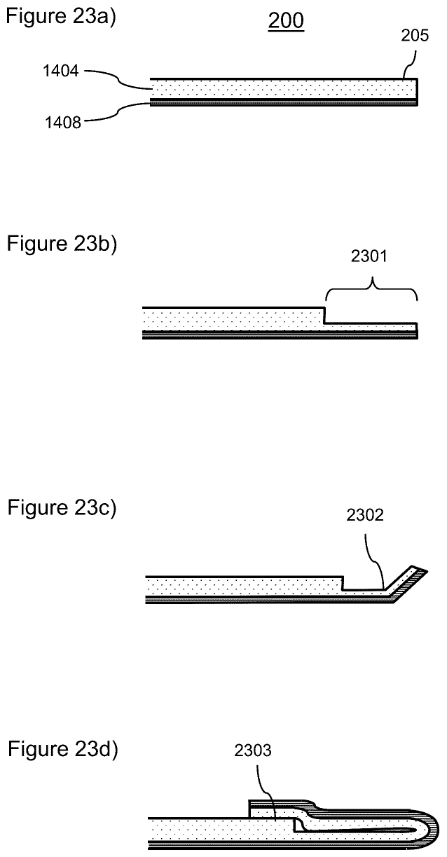

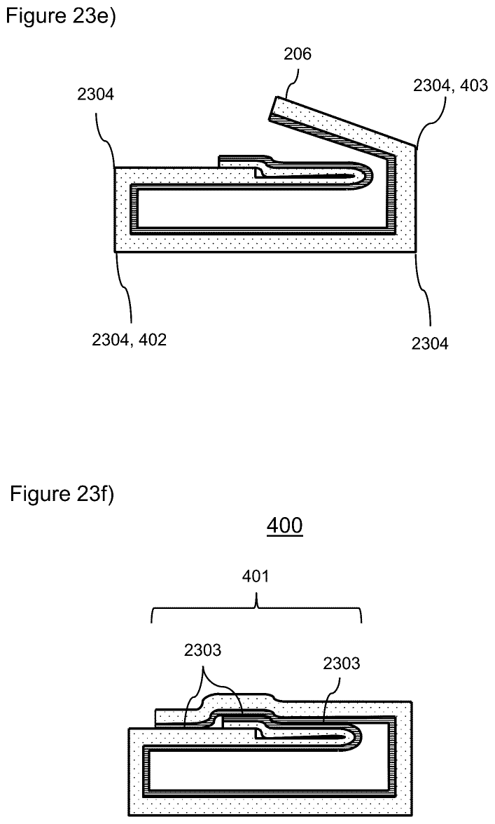

Groove patterns are introduced into the web-shaped laminate obtained as described above on the outer side. Each groove pattern consists of a plurality of grooves with 4 longitudinal grooves of equal length. Further, the grooved web-shaped laminate is divided into blanks for individual containers, each blank having one of the above holes and one of the groove patterns. One of the longitudinal margins of the blank is skived on its outer side using the rotating pot knife of a Model VN 50 from Fortuna Spezialmaschinen GmbH, Weil der Stadt, Germany. Thereby the outer polymer layer is removed in the skived region and the thickness of the carrier layer is reduced to half to its original thickness. The skived region is hem-sealed as, generally, illustrated in FIGS. 23a) to 23f). Thus, by folding along longitudinal grooves of the groove pattern of each blank, folding the skived region and sealing the skived longitudinal margin to the opposite longitudinal margin of the blank, a longitudinal seam is obtained. The blank with the longitudinal seam forms a sleeve-like container precursor as, generally, depicted in FIGS. 4 to 6 and 23f).

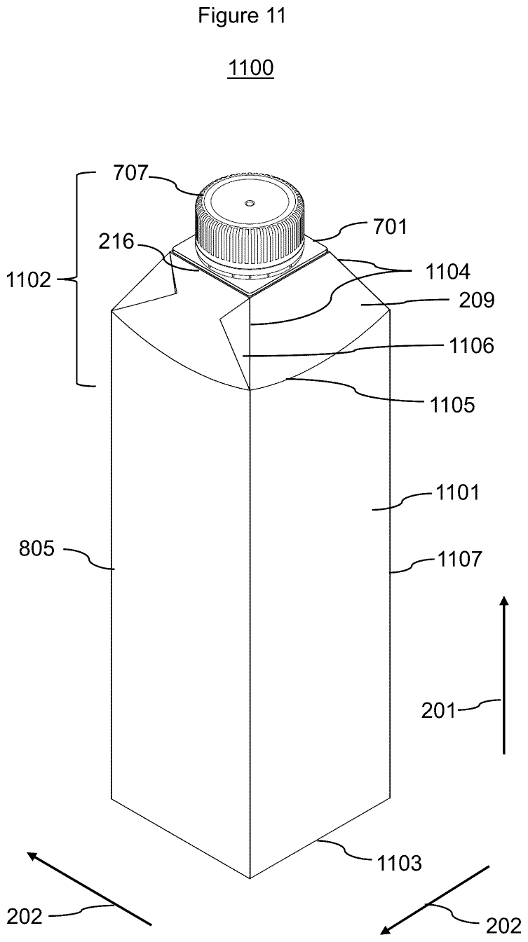

In each case, closed containers are produced from the container precursors as described above. Within the scope of the comparative examples and examples, both cuboid-shaped containers and containers with a cuboid-shaped body and a truncated pyramid-shaped head portion arranged thereon are produced. The latter container shape is basically shown in FIG. 11. The body of both container shapes has a square cross-section with edge length a. For both container shapes, containers with edge lengths of a=67.5 mm and a=47.5 mm are produced.

The following filling machines are used for the production of the various containers.

TABLE 2
Filling machines to be used for the
comparative examples and examples

| Container shape | | |
|---|---|---|
| [cuboid | | |
| with/without | Edge length a | |
| truncated pyramid] | [mm] | Filling machine |
| without truncated | 67.5 | CFA 812-36, SIG Combibloc, |
| pyramid | | Linnich |
| without truncated | 47.5 | CFA 1724-37, SIG Combibloc, |
| pyramid | | Linnich |
| with truncated | 67.5 | CDA 1012-36, SIG Combibloc, |
| pyramid | | Linnich |
| with truncated | 47.5 | CDA 2012-39, SIG Combibloc, |
| pyramid | | Linnich |

To produce the cuboid-shaped containers without a truncated pyramid-shaped head portion, the sleeve-like container precursor is first folded into a cuboid shape and a bottom area is created by folding, which is closed by heat sealing with hot air. This creates a cup that is open at the top. The cup is sterilised with hydrogen peroxide. Furthermore, the cup is filled with water. The top area of the cup, which contains the hole, is closed by folding and ultrasonic sealing. Then the head portion is formed by folding in such a way that a closed container in cuboid shape is obtained. The fold protrusions, called ears, are sealed to the body of the container with hot air. An opening aid is glued onto the container in the area of the hole.

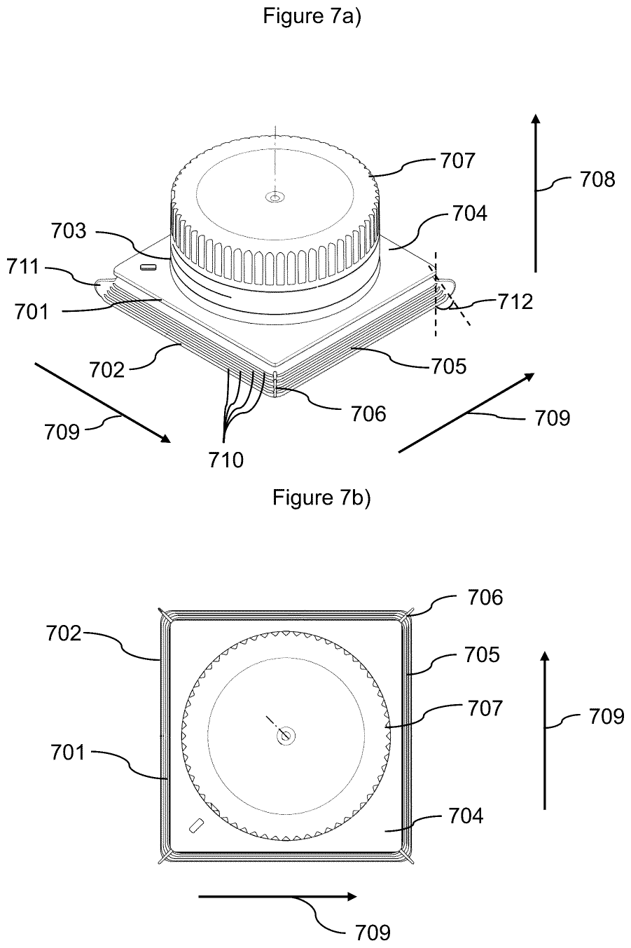

To produce the cuboid-shaped containers with a truncated pyramid-shaped head portion, the sleeve-like container precursor is also first folded into a cuboid shape. Then the truncated pyramid-shaped head portion is folded and joined to an injection moulded component of the shape shown in FIGS. 7a) and 7b) by heat sealing with hot air. In this process, the fold protrusions, called ears, are sealed to the side surfaces of the head portion. The resulting container, open at the bottom, is sterilised with hydrogen peroxide. Furthermore, the open container (upside down) is filled with water. The bottom area of the container is closed by folding and ultrasonic sealing, thus obtaining a closed container in the shape of a cuboid with a truncated pyramid-shaped head portion.

### Evaluation

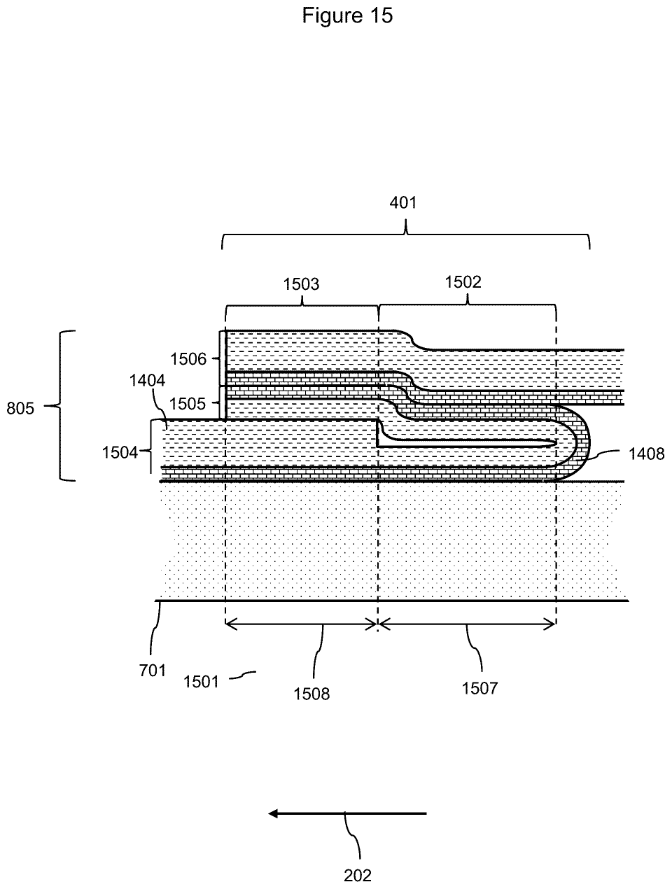

In the Examples 1 to 4 and Comparative Examples 1 and 2, only cuboid-shaped containers with truncated pyramid-shaped head portion are studied. These containers are prepared as generally described above to have longitudinal seam geometries as shown in FIGS. 15, 16 and 24.

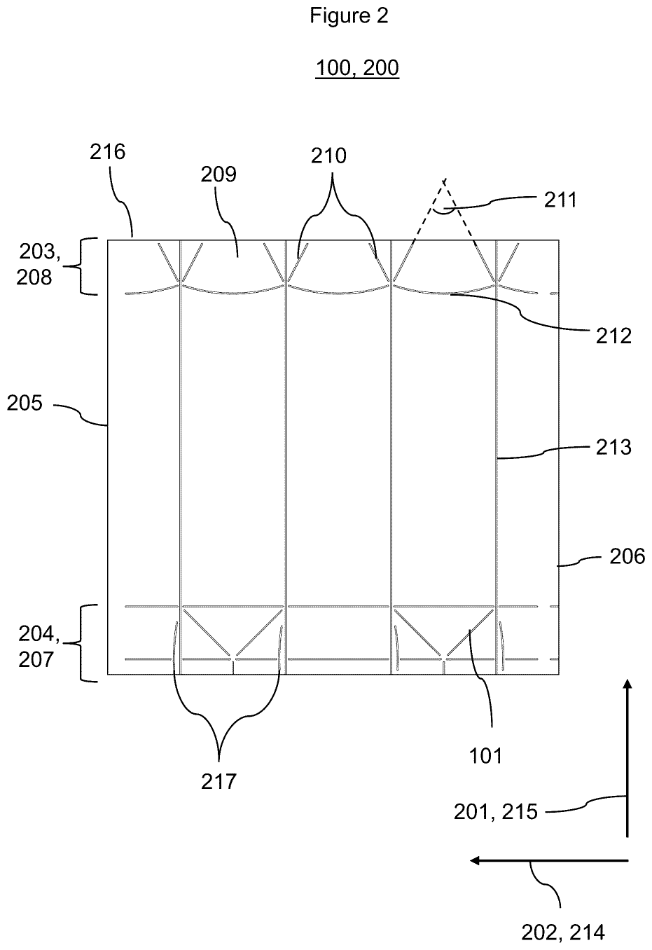

As given in Table 1, the carrier layer is made of cardboard. The latter is a material with an orientation direction. The cardboard fibres are mainly oriented in the machine direction (MD) of the cardboard production. The carrier layer, and thus the laminate containing it, has a greater bending stiffness for bending in the orientation direction of the cardboard fibres than for bending perpendicular to it. More precisely, the bending stiffness of the laminate for bending in the orientation direction has a maximum, related to the bending direction. Here, the orientation direction of the carrier layer refers to the direction of predominant orientation of the fibres of the carrier layer being either substantially perpendicular or substantially parallel to the upper edge of the laminate in the container. The upper laminate edge in this case is the edge of the laminate that runs around the moulded component (cf. 216 in FIGS. 2 to 6 and 11). In essence, if the fibre orientation is substantially perpendicular to the upper laminate edge, the bending stiffness of the laminate has a minimum for bending in the direction of the upper laminate edge. If the fibre orientation is substantially parallel to the upper laminate edge, the bending stiffness of the laminate has a maximum for bending in the direction of the upper laminate edge, i.e., the bending stiffness of the laminate for bending about the direction of the upper laminate edge is greater than the bending stiffness for bending of the laminate in any other direction.

Each of the closed and filled containers of the Examples 1 to 4 and the Comparative Examples 1 and 2 is stored for 48 hours at 23° C. and 90% relative humidity. Directly afterwards, the containers are subjected to the transport simulation as described above in the “Measurement methods”-section. This simulation mimics the vibrations which the containers experience during transport on a truck for about 500 km. Subsequently, the head portions of the containers are tested for their liquid tightness. The results of these tests are summarised in Table 3.

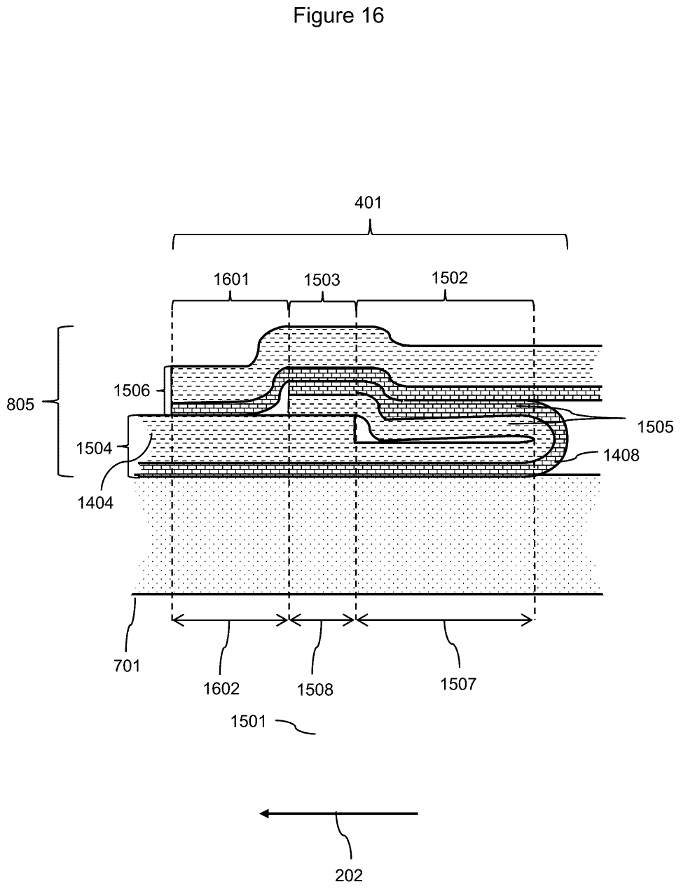

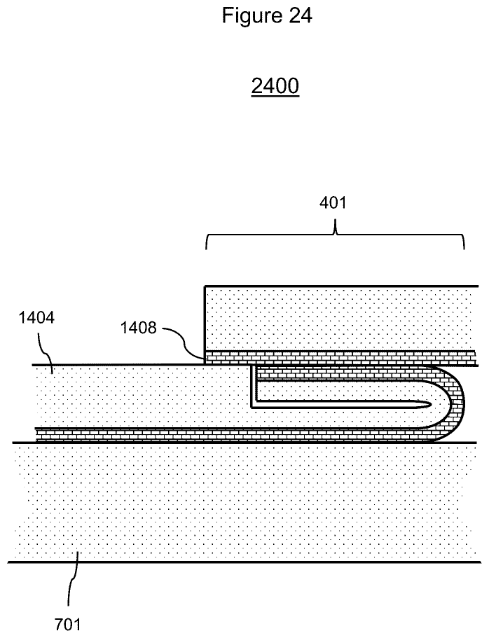

TABLE 3
On the influence of the longitudinal seam geometry and the orientation
of the carrier layer in the container on the liquid tightness
of the head portion after transport simulation

| | | Fibre direction | Liquid tightness |
|---|---|---|---|
| | Longitudinal | to the upper | of the head portion after |
| | seam geometry | laminate edge | transport simulation |
| Comparative | FIG. 24 | perpendicular | − |
| Example 1 | | | |
| Comparative | FIG. 24 | parallel | − |
| Example 2 | | | |
| Example 1 | FIG. 15 | perpendicular | + |
| Example 2 | FIG. 15 | parallel | ++ |
| Example 3 | FIG. 16 | perpendicular | ++ |
| Example 4 | FIG. 16 | parallel | +++ |

The results in Table 3 show that the longitudinal seam geometries of FIGS. 15 and 16 are superior to the longitudinal seam geometry of FIG. 24 in terms of liquid tightness of the head portion after the transport simulation. Here, the containers with the longitudinal seam geometry of FIG. 16 show the best results. Alignment of the fibre direction substantially parallel to the upper laminate edge, i.e., substantially perpendicular to the container height, has a further advantageous effect on the liquid tightness of the head portion after the transport simulation with respect to a fibre direction substantially perpendicular to the upper laminate edge. Production tolerances in the orientation of the carrier layer show that the fibre direction does not need to be exactly parallel to the upper laminate edge to achieve the advantageous effect on the shelf life. An improvement in liquid tightness after transport simulation means that the shelf life of the containers is reduced less by transporting the containers from the filler to the retailer.

In all of the below further examples and comparative examples, the longitudinal seam geometry of FIG. 15 is used. Further, the predominant fibre direction of the carrier layer is selected to be substantially perpendicular to the height of the containers. In the case of containers with truncated pyramid-shaped head portion, this means that the predominant fibre direction is substantially parallel to the upper laminate edge.

The influence of the length 1 of the longitudinal edges of the container formed along the longitudinal grooves on basic usage properties of the container is studied while the edge length a remains constant. The length 1 is determined as the length of the longitudinal grooves in the groove pattern of the respective container. It denotes the height of the container without considering the truncated pyramid-shaped head portion. The Table 4 below summarises the results for both edge lengths a considered, for containers with a truncated pyramid-shaped head portion as well as without a truncated pyramid-shaped head portion. The data in Table 4 for containers with edge length a=67.5 mm thus refer to both, containers with a truncated pyramid-shaped head portion and those without a truncated pyramid-shaped head portion. Likewise, the data for containers with an edge length of a=47.5 mm refer to both, containers with a truncated pyramid-shaped head portion and those without a truncated pyramid-shaped head portion.

TABLE 4
On the influence of the height of the container
body on the use properties of the container

| a | | | Standing | | |
|---|---|---|---|---|---|
| [mm] | l [mm] | l/a | stability | Capacity | Grip stiffness |
| 67.5 | 87.5 | 1.296 | ++ | − | + |
| 67.5 | 94.0 | 1.393 | + | + | + |
| 67.5 | 189 | 2.8 | + | − | + |
| 67.5 | 202.5 | 3.0 | − | ++ | + |
| 47.5 | 61.5 | 1.295 | ++ | −− | ++ |
| 47.5 | 66 | 1.389 | + | 0 | ++ |
| 47.5 | 133 | 2.8 | + | 0 | ++ |
| 47.5 | 142.5 | 3.0 | − | + | ++ |

It is found that a ratio 1/a of less than 1.3 leads to low capacities. A ratio 1/a of more than 2.95 always has a detrimental effect on the standing stability of the containers, i.e., the containers tend to fall over easily. Containers with a ratio 1/a in the range of 1.35 to 2.95 are always sufficiently standing-stable and have sufficient capacities. In this range, i.e., with sufficient standing stability, the larger edge length a allows a larger capacity. On the other hand, the smaller edge length a allows a particularly good grip stiffness with sufficient standing stability. These containers are particularly easy to handle. While containers with a larger edge length a are particularly suitable for stationary household use, containers with a smaller edge length a are particularly suitable for mobile use.

In the following, the influence of the angle α on the compression stability of containers with sufficient stability as well as on the sealing of the fold protrusions (1106 in FIG. 11), often referred to as ears by those skilled in the art, is considered. The angle α is the angle that is included by the two steep edges of each side face of the truncated pyramid-shaped head portion in the plane of the respective side face. This angle is measured as described above. The containers with a truncated pyramid-shaped head portion to be considered here all have exclusively straight, i.e., not curved, base edges of the head portion.

The results summarised in Table 5 show that containers with a truncated pyramid-shaped head portion and angle α in a specific range are more compression-resistant along their length than conventional rectangular containers without a truncated pyramid-shaped head portion. This makes such containers more suitable for stacking for transport. This helps to make the transport of filled containers to retailers more efficient. Furthermore, selection of a suitable angle α improves the sealing of the ears. If the angle α is suitable, errors in the sealing of the ears occur more frequently, which can lead to ears not being fully attached. This can lead to production errors in the filling machine and thus to interruptions in production.

TABLE 5
On the influence of the angle α on the compression stability and the sealing of the ears

| | Container shape [Cuboid | | | | | | |
|---|---|---|---|---|---|---|---|
| | with/without | | | | | Sealing of | Compression |
| | truncated pyramid] | a [mm] | l [mm] | l/a | α [°] | the ears | stability |
| Comparative | without truncated | 67.5 | 94.0 | 1.393 | / | + | − |
| Example 3 | pyramid | | | | | | |
| Comparative | without truncated | 67.5 | 189 | 2.8 | / | + | − |
| Example 4 | pyramid | | | | | | |
| Comparative | without truncated | 47.5 | 66 | 1.389 | / | + | − |
| Example 5 | pyramid | | | | | | |
| Comparative | without truncated | 47.5 | 133 | 2.8 | / | + | − |
| Example 6 | pyramid | | | | | | |
| Example 5 | with truncated | 67.5 | 94.0 | 1.393 | 39 | − | − |
| | pyramid | | | | | | |
| Example 6 | with truncated | 67.5 | 94.0 | 1.393 | 40 | + | 0 |
| | pyramid | | | | | | |
| Example 7 | with truncated | 67.5 | 94.0 | 1.393 | 45 | ++ | ++ |
| | pyramid | | | | | | |
| Example 8 | with truncated | 67.5 | 94.0 | 1.393 | 54 | + | + |
| | pyramid | | | | | | |
| Example 9 | with truncated | 67.5 | 94.0 | 1.393 | 60 | + | 0 |
| | pyramid | | | | | | |
| Example 10 | with truncated | 67.5 | 94.0 | 1.393 | 61 | − | − |
| | pyramid | | | | | | |
| Example 11 | with truncated | 67.5 | 189 | 2.8 | 39 | − | − |
| | pyramid | | | | | | |
| Example 12 | with truncated | 67.5 | 189 | 2.8 | 40 | + | 0 |
| | pyramid | | | | | | |
| Example 13 | with truncated | 67.5 | 189 | 2.8 | 45 | ++ | ++ |
| | pyramid | | | | | | |
| Example 14 | with truncated | 67.5 | 189 | 2.8 | 54 | + | + |
| | pyramid | | | | | | |
| Example 15 | with truncated | 67.5 | 189 | 2.8 | 60 | + | 0 |
| | pyramid | | | | | | |
| Example 16 | with truncated | 67.5 | 189 | 2.8 | 61 | − | − |
| | pyramid | | | | | | |
| Example 17 | with truncated | 47.5 | 66 | 1.389 | 39 | − | − |
| | pyramid | | | | | | |
| Example 18 | with truncated | 47.5 | 66 | 1.389 | 40 | + | 0 |
| | pyramid | | | | | | |
| Example 19 | with truncated | 47.5 | 66 | 1.389 | 45 | + | + |
| | pyramid | | | | | | |
| Example 20 | with truncated | 47.5 | 66 | 1.389 | 54 | ++ | ++ |
| | pyramid | | | | | | |
| Example 21 | with truncated | 47.5 | 66 | 1.389 | 60 | + | 0 |
| | pyramid | | | | | | |
| Example 22 | with truncated | 47.5 | 66 | 1.389 | 61 | − | − |
| | pyramid | | | | | | |
| Example 23 | with truncated | 47.5 | 133 | 2.8 | 39 | − | − |
| | pyramid | | | | | | |
| Example 24 | with truncated | 47.5 | 133 | 2.8 | 40 | + | 0 |
| | pyramid | | | | | | |
| Example 25 | with truncated | 47.5 | 133 | 2.8 | 45 | + | + |
| | pyramid | | | | | | |
| Example 26 | with truncated | 47.5 | 133 | 2.8 | 54 | ++ | ++ |
| | pyramid | | | | | | |
| Example 27 | with truncated | 47.5 | 133 | 2.8 | 60 | + | 0 |
| | pyramid | | | | | | |
| Example 28 | with truncated | 47.5 | 133 | 2.8 | 61 | − | − |
| | pyramid | | | | | | |

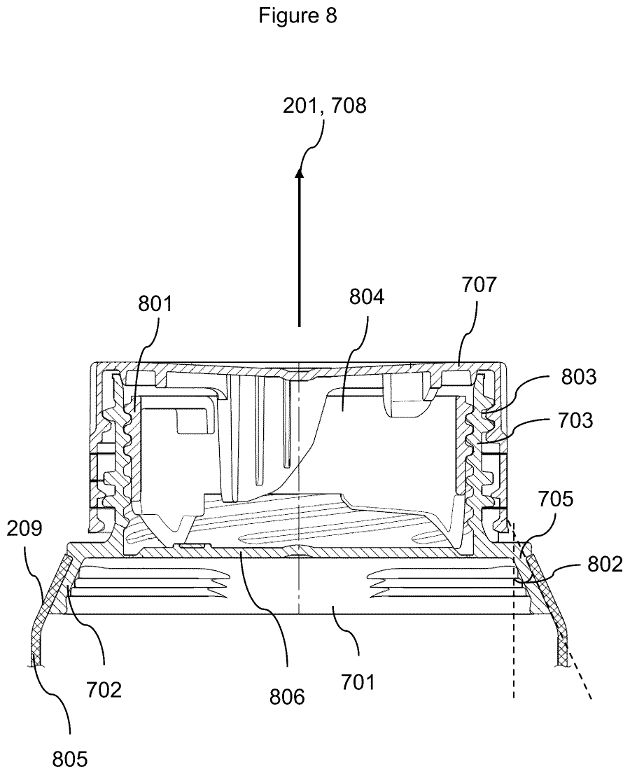

In further examples, the influence of a curvature of the base edges of the truncated pyramid-shaped head portion on the shelf life of the containers and the sealing of the ears as well as on the effects on the production process described above are examined. For this purpose, containers with a truncated pyramid-shaped head portion with a straight base edge are compared with containers with a truncated pyramid-shaped head portion whose base edges are convexly curved in relation to the respective side surface of the head portion (cf. 1105 in FIG. 11). The angle β (cf. 802 in FIG. 8), which indicates the inclination of the side surfaces of the truncated pyramid-shaped head portion of the container in relation to the longitudinal direction (height) of the container, is always 550 here, so that an influence of this angle on the examinations can be excluded (cf. also Tables 7 and 8). The angle γ (cf. 712 in FIG. 7a)) which indicates the inclination of the side walls of the moulded component to the longitudinal direction of the moulded component (same as the longitudinal direction of the container in the container), is also set to 55° in each of the examples in Table 6. No transport simulation is applied here before testing the liquid tightness.

The test results in the Table 6 show that convexly curved base edges improve the liquid tightness of the head portions of the containers and, thus, increase the shelf life of the containers. In addition, containers with convexly curved base edges show a better sealing of the ears and, thus, less interruptions of container production.

TABLE 6
On the influence of a curvature of the base edges of the truncated pyramid-
shaped head portion on the shelf life and the sealing of the ears

| | | | | | | Liquid | |
|---|---|---|---|---|---|---|---|
| | | | | | | tightness | |
| | | | | | | of the | Sealing of |
| | a [mm] | l [mm] | l/a | α [°] | Base edges | head portion | the ears |
| Example 29 | 67.5 | 94.0 | 1.393 | 45 | straight | 0 | ++ |
| Example 30 | 67.5 | 189 | 2.8 | 45 | straight | 0 | ++ |
| Example 31 | 67.5 | 94.0 | 1.393 | 45 | convexly curved | + | +++ |
| Example 32 | 67.5 | 189 | 2.8 | 45 | convexly curved | + | +++ |
| Example 33 | 47.5 | 66 | 1.389 | 54 | straight | 0 | ++ |
| Example 34 | 47.5 | 133 | 2.8 | 54 | straight | 0 | ++ |
| Example 35 | 47.5 | 66 | 1.389 | 54 | convexly curved | + | +++ |
| Example 36 | 47.5 | 133 | 2.8 | 54 | convexly curved | + | +++ |

Furthermore, the influence of the angle 3, at which the side surfaces of the truncated pyramid-shaped head portion of the container are inclined to the longitudinal direction (height) of the container (cf. 802 in FIG. 8), on the shelf life of the containers is considered. For this purpose, containers with truncated pyramid-shaped head portions with curved base edges are manufactured according to Examples 31, 32, 35 and 36, whereby their angle β is varied. The angle γ (cf. 712 in FIG. 7a)) of the moulded component reflects the angle β of the head side surfaces. The angle γ indicates the inclination of the side walls of the moulded component to the longitudinal direction of the moulded component (same as the longitudinal direction of the container in the container). Again, no transport simulation is applied before testing the liquid tightness.

TABLE 7
On the influence of the angles β and γ on the shelf life
of containers with edge length a = 67.5 mm

| | | | Liquid tightness of |
|---|---|---|---|
| | a, l, l/a, α, base edges | β and γ [°] | the head portion |
| Example 37 | see example 31 | 54 | − |
| Example 38 | see example 31 | 55 | + |
| Example 39 | see example 31 | 59 | ++ |
| Example 40 | see example 31 | 66 | +++ |
| Example 41 | see example 31 | 70 | + |
| Example 42 | see example 31 | 71 | − |
| Example 43 | see example 32 | 54 | − |
| Example 44 | see example 32 | 55 | + |
| Example 45 | see example 32 | 59 | ++ |
| Example 46 | see example 32 | 66 | +++ |
| Example 47 | see example 32 | 70 | + |
| Example 48 | see example 32 | 71 | − |

Table 8: On the influence of the angles β and γ on the shelf
life of containers with edge length a = 47.5 mm

| | a, l, l/a, α, | | Liquid tightness of |
|---|---|---|---|
| | base edges | β and γ [°] | the head portion |
| Example 49 | see example 35 | 54 | − |
| Example 50 | see example 35 | 55 | + |
| Example 51 | see example 35 | 59 | +++ |
| Example 52 | see example 35 | 66 | ++ |
| Example 53 | see example 35 | 70 | + |
| Example 54 | see example 35 | 71 | − |
| Example 55 | see example 36 | 54 | − |
| Example 56 | see example 36 | 55 | + |
| Example 57 | see example 36 | 59 | +++ |
| Example 58 | see example 36 | 66 | ++ |
| Example 59 | see example 36 | 70 | + |
| Example 60 | see example 36 | 71 | − |

It is found that angles β and γ in the range from 55 to 700 are advantageous for the shelf life of the containers. Analyses of the containers show that angles β and γ outside the aforementioned range promote the formation of so-called pockets, i.e., unsealed cavities, on the interfaces between the laminate and the moulded component in the head portion. Such cavities reduce the tightness of the head portion. This can be proven with the “liquid tightness” test described above. Furthermore, germs can increasingly hold and multiply in such cavities. Both reduced tightness and increased germ growth shorten the shelf life of the containers.

In the above Tables 3 to 8:
“+++” means a more favourable result than “++”
“++” means a more favourable result than “+”
“+” means a more favourable result than “0”,
“0” means a more favourable result than “−”, and
“−” means a more favourable result than“−−”.

Unless otherwise stated in the description or the respective figure, the figures schematically and not to scale show:

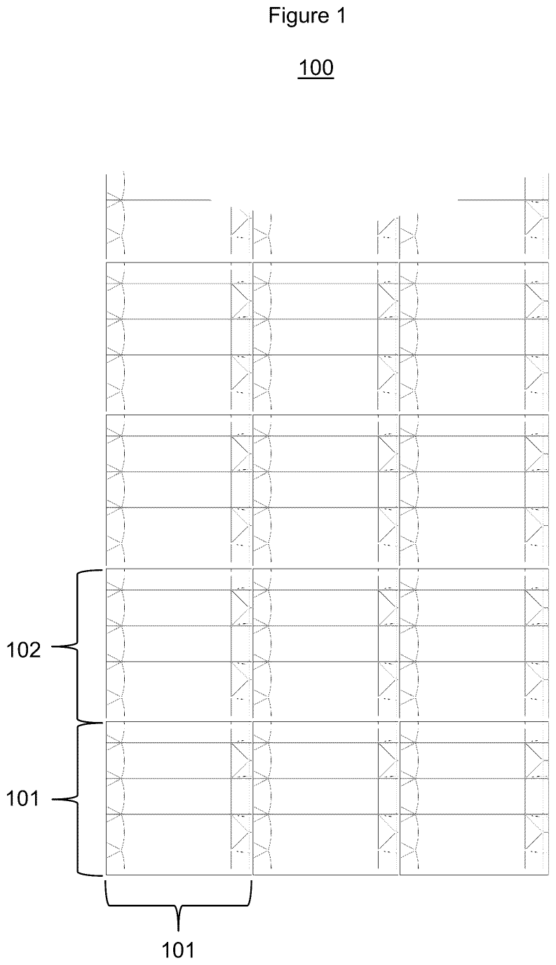

FIG. 1 a schematic representation of a planar composite;

FIG. 2 a schematic representation of a further planar composite;

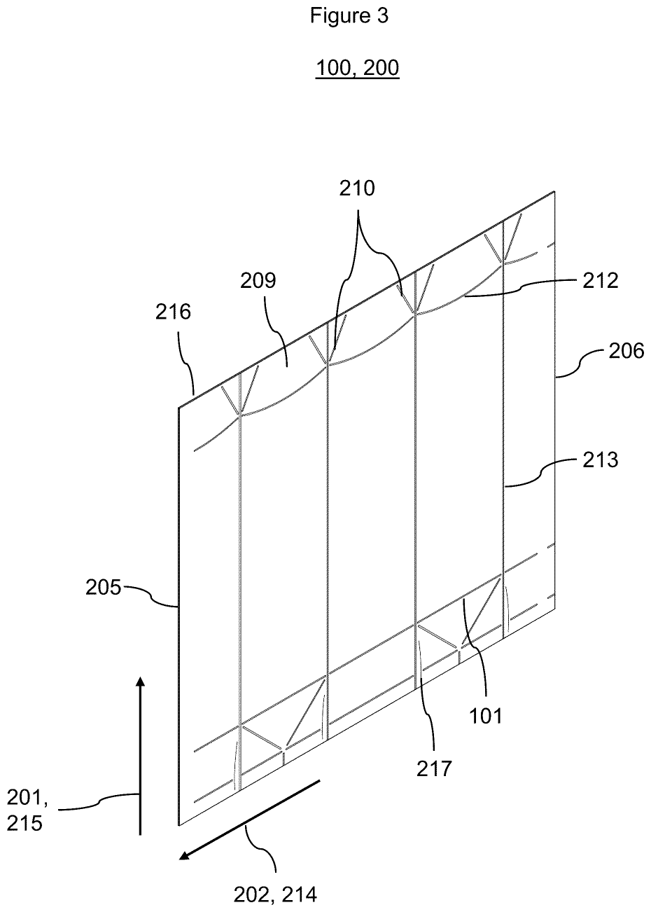

FIG. 3 a further schematic representation of the planar composite of FIG. 2;

FIG. 4 a schematic representation of a container precursor;

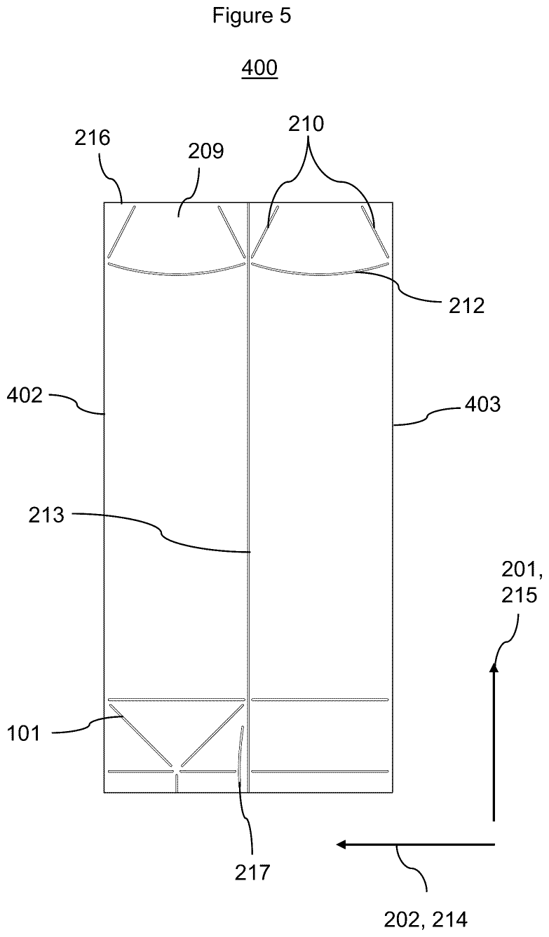

FIG. 5 a further schematic representation of the container precursor of FIG. 4;

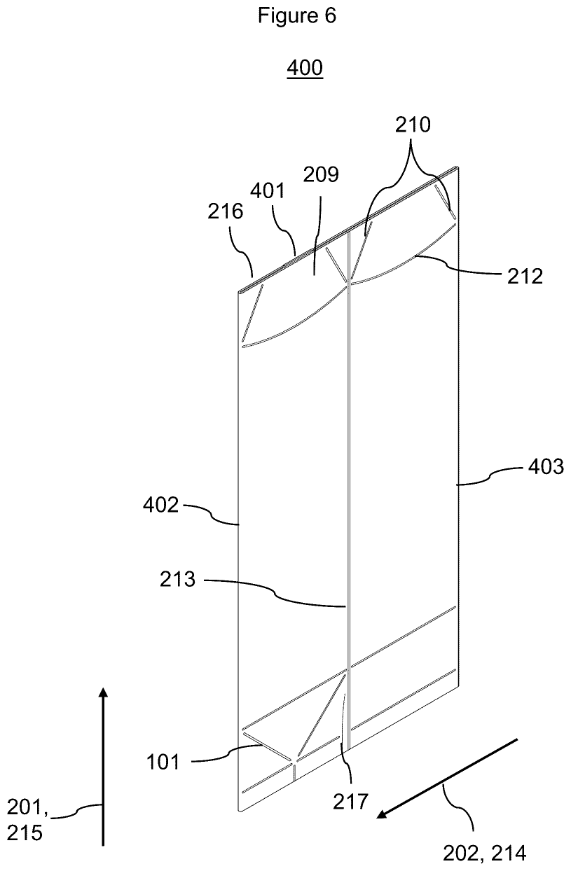

FIG. 6 a further schematic representation of the container precursor of FIG. 4;

FIG. 7a) a schematic perspective view of an element other than the folded planar composite;

FIG. 7b) a schematic top view of the element other than the folded planar composite of FIG. 7a);

FIG. 8 a schematic sectional view of the element other than the folded planar composite of FIG. 7a);

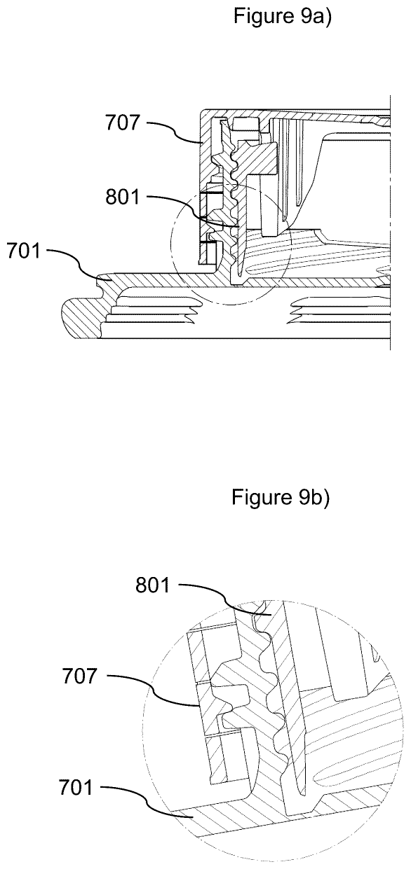

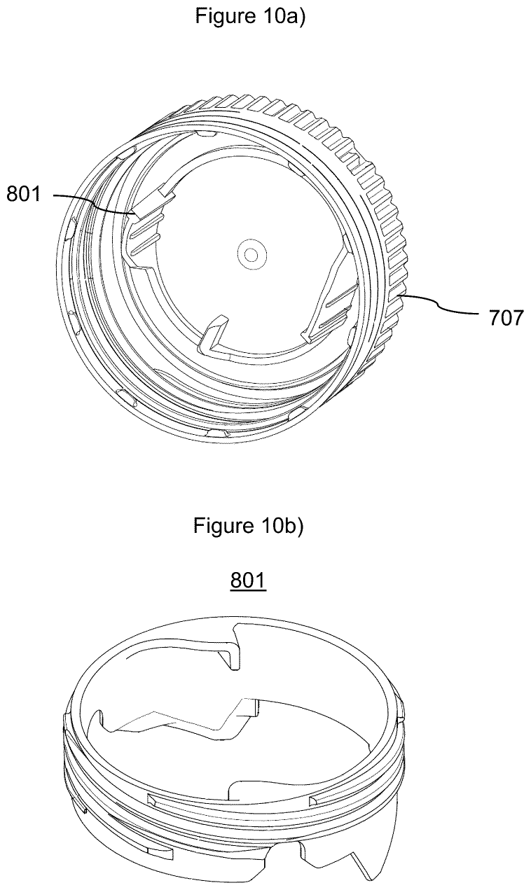

FIG. 9a) a schematic partial view of a further section through the element other than the folded planar composite of FIG. 7a);

FIG. 9b) an enlarged partial representation of FIG. 9a);

FIG. 10a) a schematic representation of the cap of FIG. 7a) with opening aid;

FIG. 10b) a schematic representation of the opening aid from FIG. 10a);

FIG. 11 a schematic perspective view of a container according to the invention;

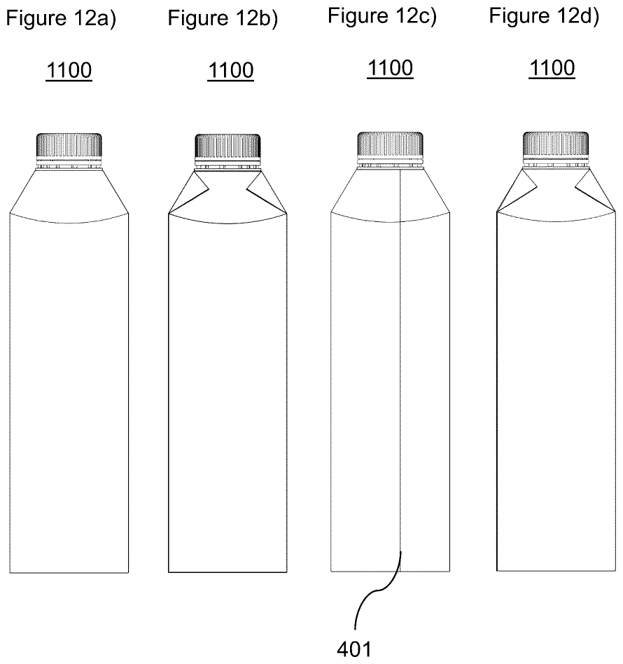

FIG. 12a) to 12d) schematic side views of the container according to the invention from FIG. 11;

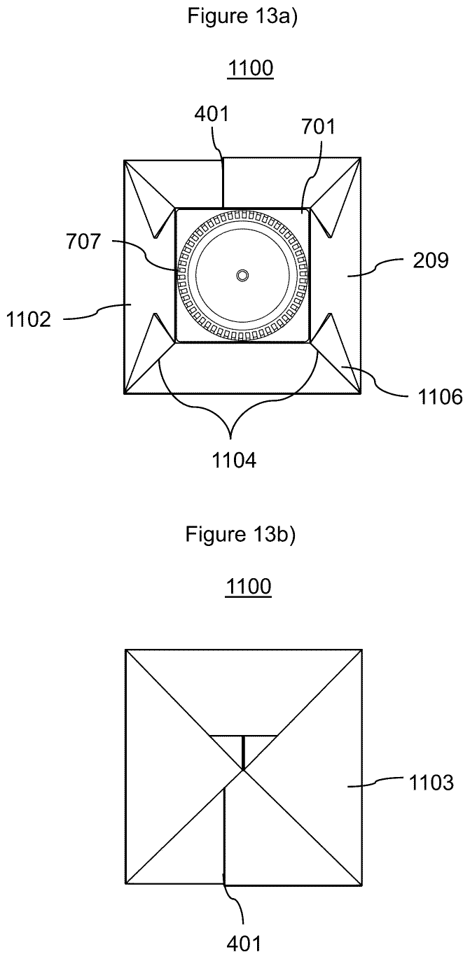

FIG. 13a) a schematic top view of the container according to the invention from FIG. 11;

FIG. 13b) a schematic bottom view of the container according to the invention from FIG. 11;

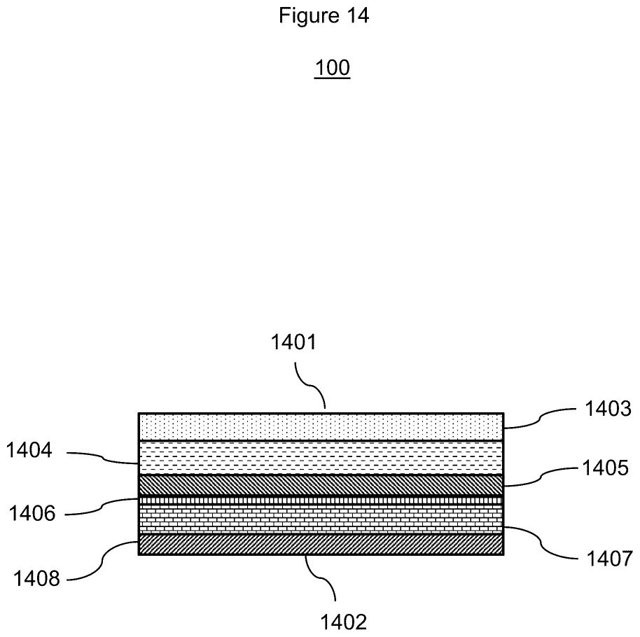

FIG. 14 a schematic partial representation of a section through the planar composite of FIG. 1;

FIG. 15 a schematic section through the longitudinal seam of a container according to the invention;

FIG. 16 a schematic section through the longitudinal seam of a further container according to the invention;

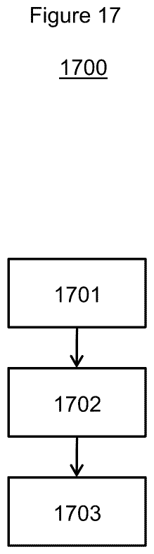

FIG. 17 a flow chart of a process according to the invention of making a container;

FIGS. 18a) to 18f) illustrations of the preparation of a closed container to determine the angle α of a pair of steep edges;

FIG. 19 an illustration of the test method for determining the angle α of a pair of steep edges;

FIG. 20 a test setup to determine compression stability;

FIG. 21 a test setup to determine the grip stiffness;

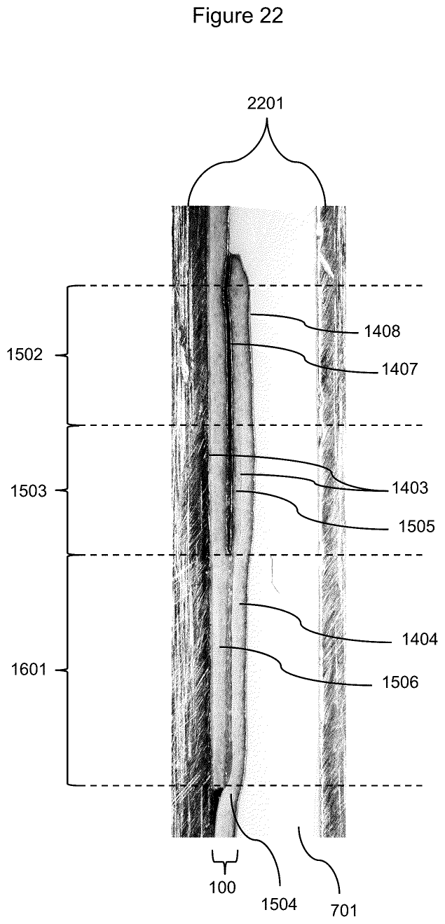

FIG. 22 a microscope image of a section through the longitudinal seam of a container according to the invention;

FIGS. 23a) to 23f) illustrations of a process of preparing a container precursor; and

FIG. 24 a schematic section through the longitudinal seam of a container not according to the invention.

FIG. 1 shows a schematic top view of a planar composite 100 in form of a web-shaped laminate 100. The web-shaped laminate 100 is a semi-endless roll material, of which here only a section can be shown. The web-shaped laminate 100 comprises a first plurality of grooves 101 and more than 50 further pluralities of grooves 102.

FIG. 2 shows a schematic representation of a further planar composite 100. This is a blank 200 of the planar composite 100 of FIG. 1. The blank 200 is designed to produce the container 1100 of FIG. 11. This production includes folding the blank 200 to obtain a folded planar composite 805. For this purpose, the blank 200 includes the first plurality of grooves 101. These grooves are arranged and configured such that by folding the blank 200 along the grooves of the first plurality of grooves 101 and joining portions of the blank 200, a part of a container wall 1101 surrounding a container interior 1501 of the container 1100 is obtainable. This part is referred to herein as further part of the container wall 1101. The container 1100 includes a standing base 1103 and, in a longitudinal direction 201, extending along a length of the container 1100, opposite the standing base 1103, a head portion 1102. The longitudinal direction 201 is also referred to herein as first direction. The first plurality of grooves 101 includes grooves 204 in a first transverse margin 207 to form the standing base 1103 and grooves 203 in a further transverse margin 208 to form the head portion 1102. Furthermore, the first plurality of grooves 101 includes exactly 4 longitudinal grooves 213 for forming 4 longitudinal edges 1107 of the container 1100. The latter includes 4 head side surfaces 209 formed from the blank 200. The head side surfaces 209 are inclined to each other in the longitudinal direction 201 in such a way that the container 1100 tapers in the head portion 1102. The 4 head side surfaces 209 together form substantially a lateral surface of the head portion 1102, which is substantially in the shape of a regular truncated pyramid with a square base. The 4 base edges 1105 of the regular truncated pyramid are convexly curved towards the standing base 1103, relative to their respective head side surfaces 209. The first plurality of grooves 101 includes 4 corresponding grooves 212 for forming the 4 base edges 1105. A perimeter of each of the 4 head side surfaces 209 is formed by a respective plurality of side edges of the head portion 1102. Each of these pluralities of side edges includes a pair of steep edges 1104 opposing each other in a circumferential direction 202 of the container 1100 perpendicular to the longitudinal direction 201. Each pair of steep edges 1104 is formed along a pair of grooves 210 of the first plurality of grooves 101. The grooves of each of these pairs of grooves 201 extend in a plane of planar extension of the blank 200 at an angle 211 in the range of 40 to 60° with respect to each other. Accordingly, in the container 1100, the steep edges of each of the pairs of steep edges 1104 also include the angle 211 in the range of 40 to 60°. This angle 211 is also referred to herein as a. The blank 200 has a first longitudinal margin 205, a further longitudinal margin 206 opposite thereto in the circumferential direction 202, the first transverse margin 207 and the further transverse margin 208 opposite thereto in the longitudinal direction 201. Each of the first longitudinal margin 205, the further longitudinal margin 206, the first transverse margin 207 and the further transverse margin 208 includes a cut edge of the blank 200. A bending stiffness of the blank 200 for bending in a first composite direction 214 is greater than for bending in a further composite direction 215 perpendicular to the first composite direction 214. Therein, the first composite direction 214 as well as the further composite direction 215 lie in the plane of planar extension of the blank 200. The further transverse margin 208 is arranged and configured to provide a first part of the head portion 1102 of the container 1100 by folding the further transverse margin 208 along grooves of the first plurality of grooves 101 and joining portions of the further transverse margin 208 with one another. The edge 216 of the further transverse margin 208 surrounds an element 701 other than the folded planar composite 805 of the container 1100, which forms a further part of the head portion 1102 in the container 1100. The edge 216 runs along its entire length parallel to the first composite direction 214 (cf. FIG. 11). The first plurality of grooves 101 further comprises 4 auxiliary grooves 217. Each of the auxiliary grooves 217 is arranged next to one of the longitudinal grooves 213 in first the transverse margin 207 such that a bending radius of a longitudinal fold along this longitudinal groove 213 is increased at least in sections of the longitudinal fold. Further, each of the auxiliary grooves 217 is curved away from the respective longitudinal groove 213. Furthermore, each of the auxiliary grooves 217 is arranged on a side of the respective longitudinal groove 213 which faces away from a centre of the blank 200, based on the circumferential direction 202. Forming the standing base 1103 includes particularly severe folding of the blank 200. The auxiliary grooves 217 described above allow to reduce mechanical stress to the blank 200 upon forming the standing base 1103. This helps to reduce the risk of leaks at the bottom of the container 1100 and, thus, contributes to a long shelf life.

FIG. 3 shows a schematic perspective view of the blank 200 of FIG. 2.

FIG. 4 shows a schematic top view of a container precursor 400. This includes the blank 200 of FIG. 2. Here, the blank 200 has a first longitudinal fold 402 and a further longitudinal fold 403, both along longitudinal grooves 213. The container precursor 400 is folded flat along these longitudinal folds. The first longitudinal margin 205 has been hem-sealed and sealed to the further longitudinal margin 206 of the blank 200 in order to obtain a longitudinal seam 401 of the container precursor 400. The geometry of the longitudinal seam 401 is the one shown in FIG. 16. Herein, in the context of the container precursor 400, the first wall region 1502 is referred to as first composite region, the second wall region 1503 is referred to as second composite region and the third wall region 1601 is referred to as third composite region.

FIG. 5 shows a further schematic top view of the container precursor 400 of FIG. 4. Here, the container precursor 400, which continues to be folded flat, can be seen from the side opposite the longitudinal seam 401.

FIG. 6 shows a schematic perspective view of the container precursor 400 of FIG. 4.

FIG. 7a) shows a schematic perspective view of an element 701 other than the folded planar composite 805 and a cap 707. The element 701 other than the folded planar composite 805 is a non-planar component. The non-planar component is an injection-moulded component. The element 701 other than the folded planar composite 805 is designed to form a first part of the container wall 1101 of the container 1100 in FIG. 11, while the blank 200 of FIG. 2 in folded state forms a further part of this container wall 1101, which is an open, cup-shaped container, so that the container 1100 is closed as shown in FIG. 11. The first part of the container wall 1101 is encompassed by the head portion 1102 of the container 1100. The element 701 other than the folded planar composite 805 bounds the container interior 1501 in the longitudinal direction 201 of the container 1100 and forms a top surface of the truncated pyramid-shaped head portion 1102. The element 701 other than the folded planar composite 805 is made of HDPE, comprises a base member 702 and a spout 703 arranged thereon, a pouring aperture 804 (see FIG. 8) of which is covered by the cap 707. The latter is screwed onto the spout 703. The cap 707 is also made of HDPE. The base member 702 comprises a base plate 704 and exactly 4 side walls 705.

The spout 703 is arranged on a first side of the base plate 704. The side walls 705 are arranged on a further side of the base plate 704 opposite the first side. In each case, 2 of the side walls 705 adjoin one another forming a side edge 706 of the base member 702. The element 701 other than the folded planar composite 805 is formed in one piece and is obtainable by injection moulding. Further, the side walls 705 are inclined towards each other in a longitudinal direction 708 of the element 701 other than the folded planar composite 805 extending from the base member 702 to the spout 703 so that each of the side walls 705 is inclined at an angle γ 712 in a range of from 55 to 70° to the longitudinal direction 708. In regard of the container 1100 of FIG. 11, the longitudinal direction 708 of the element 701 other than the folded planar composite 805 is the same as the longitudinal direction 201 of the container 1100. A circumferential direction 709 of the non-planar component 701 is perpendicular to the longitudinal direction 708. A first sealant reservoir 710 is arranged on an outer side of each of the side walls 705, respectively. Each of these first sealant reservoirs 710 is elongated in the circumferential direction 709 of the element 701 other than the folded planar composite 805. Further, each of the first sealant reservoirs 710 is formed as 4 lamellae. A further sealant reservoir 711 is arranged on each side edge 706 of the base member 702, respectively. Each of the further sealant reservoirs 711 is arranged and formed to stand fin-like on the respective side edge 706. In FIG. 11, the element 701 other than the folded planar composite 805 has been heat-sealed to the folded planar composite 805 with a sealant that has been provided at least in part by the first 710 and further sealant reservoirs 711 of the element 701 other than the folded planar composite 805.

FIG. 7b) shows a schematic top view of the element 701 other than the folded planar composite 805 of FIG. 7a).

FIG. 8 shows a schematic sectional view of the element 701 other than the folded planar composite 805 of FIG. 7a). Here, it can be seen that an opening aid 801 in the form of a cutting ring 801 is arranged in the spout 703. The cutting ring 801 is made of PP. Furthermore, the element 701 other than the folded planar composite 805 here is joined to the blank 200 of FIG. 2 which has been folded along grooves of the first plurality of grooves 101 to obtain a folded planar composite 805. The element 701 other than the folded planar composite 805 and the folded planar composite 805, obtained from the blank 200, together form the container wall 1101 of the container 1100 of FIG. 11. It can be seen that the head side surfaces 209 of the container 1100 are inclined to each other in the longitudinal directions 201 in such a way that they include an angle 802 in a range from 55 to 70° with the longitudinal direction 201. This angle 802 is also referred to herein as β. Further, FIG. 8 shows that the spout 703 includes a screw thread 803 for screwing on the cap 707. A pouring aperture 804 of the spout 703 is covered by the cap 707. In addition, the pouring aperture 804 is closed by a closure element 806 which is a plastic foil.

FIG. 9a) shows a schematic partial view of a further section through the element 701 other than the folded planar composite 805 of FIG. 7a).

FIG. 9b) shows an enlarged partial representation of the circled area of FIG. 9a).

FIG. 10a) shows a schematic representation of the cap 707 of FIG. 7a) with the opening aid 801.

FIG. 10b) shows a schematic representation of the opening aid 801 from FIG. 10a).

FIG. 11 shows a schematic perspective view of a container 1100 according to the invention. The container 1100 comprises the blank 200 of FIG. 2, which has been folded along grooves of the first plurality of grooves 101 to obtain a folded planar composite 805. The container 1100 further comprises the element 701 other than the folded planar composite 805 of FIG. 7a). A container wall 1101 completely surrounds a container interior 1501. Thus, the container 1100 is a closed and liquid-tight foodstuff container. A first part of the container wall 1101 is formed by the element 701 other than the folded planar composite 805. A further part of the container wall 1101 is formed by the folded planar composite 805. The folded planar composite 805 and the element 701 other than the folded planar composite 805 are joined to one another by heat sealing with hot air. The container 1100 includes a standing base 1103 and, in the longitudinal direction 201, extending along the length of the container 1100, opposite the standing base 1103, a head portion 1102. The head portion 1102 includes exactly 4 head side surfaces 209 formed from the folded planar composite 805, which are inclined relative to each other in the longitudinal direction 201 such that the container 1100 tapers in the head portion 1102 in the longitudinal direction 201. A perimeter of each of the head side surfaces 209 is respectively formed by a plurality of side edges of the head portion 1102. Each of these pluralities of side edges includes a pair of steep edges 1104 opposing each other in a circumferential direction 202 of the container 1100, which runs perpendicular to the longitudinal direction 201. The steep edges of each pair of steep edges 1104 of each of the head side surfaces 209 extend in a plane of the respective head side surface 209 at an angle α in the range from 40 to 60° with respect to each other. This angle corresponds to the angle α 211 in FIG. 2, and may be determined as shown in FIGS. 18a) to 18f) and 19. The container 1100 has 4 longitudinal edges 1107. Each of the head side surfaces 209 includes an angle β 802 (cf. FIG. 8) in the range from 55 to 70° with the longitudinal direction 201. The 4 head side surfaces 209 together form substantially a lateral surface of the head portion 1102, which is substantially in the form of a regular truncated pyramid with a square base. The 4 base edges 1105 of the regular truncated pyramid are convexly curved towards the standing base 1103, relative to their respective head side surfaces 209. Fold protrusions 1106, also referred to as ears 1106, are sealed to the head side surfaces 209 by hot air sealing. FIG. 11 shows the first part of the head portion 1102 obtained by folding the further transverse margin 208 of the blank 200 of FIG. 2 along grooves 203 of the first plurality of grooves 101 and joining portions of the further transverse margin 208 to one another. In the container 1100, the edge 216 of the further transverse margin 208 surrounds the further part of the head portion 1102. This further part of the head portion 1102 is formed by the element 701 other than the folded planar composite 805. The edge 216 runs along its entire length parallel to the first composite direction 214.

FIGS. 12a) to 12d) show schematic side views of the container 1100 of the invention from FIG. 11 from all 4 sides. FIG. 12c) shows the longitudinal seam 401 of the container 1100. The schematic section in FIG. 16 shows the geometry of this longitudinal seam 401.

FIG. 13a) shows a schematic top view of the container 1100 according to the invention from FIG. 11.

FIG. 13b) shows a schematic bottom view of the container 1100 of FIG. 11 according to the invention.

FIG. 14 shows a schematic partial representation of a section through the web-shaped laminate 100 of FIG. 1. The web-shaped laminate 100 comprises, as superimposed layers of a layer sequence in the direction from an outer side 1401 of the web-shaped laminate 100 to an inner side 1402 of the web-shaped laminate 100, an outer polymer layer 1403, a carrier layer 1404, an intermediate polymer layer 1405, an adhesion promoter layer 1406, a barrier layer 1407 and an inner polymer layer 1408. The blank 200 of FIG. 2 and also the folded planar composite 805 of FIG. 11 each share the aforementioned layer structure with the web-shaped laminate 100. The carrier layer 1404 consists of cardboard. A main fibre direction of the cardboard in the container 1100 runs approximately parallel to the edge 216 of the further transverse margin 208. Further, the carrier layer 1404 renders the container wall 1101 and, thus, the container 1100 dimensionally stable.

FIG. 15 shows a schematic section through the longitudinal seam 401 of a container 1100 according to the invention. This container 1100 comprises a folded planar composite 805 and an element 701 other than the folded planar composite 805. This folded planar composite 805 has the layer structure shown in FIG. 14. Of the layers of this layer structure, FIG. 15 only shows the carrier layer 1404 and the inner polymer layer 1408. Further, folded planar composite 805 together with the element 701 other than the folded planar composite 805 forms a container wall 1101 which surrounds a container interior 1501. The container wall 1101 comprises a first wall region 1502 and a second wall region 1503 which together form the longitudinal seam 401. The first wall region 1502 has a first width 1507 of 2 mm in a circumferential direction 202 of the container 1100 perpendicular to the length of the container 1100. The second wall region 1503 has a second width 1508 of 2 mm in the circumferential direction 202. The first wall region 1502 comprises, as superimposed layers of a first layer sequence in a direction outward from the container interior 1501, a first ply 1504 of the folded planar composite 805, a second ply 1505 of the folded planar composite 805, and a third ply 1506 of the folded planar composite 805. Each of the first to third plies has the layer structure shown in FIG. 14. In the first wall region 1502, the second ply 1505 has been joined to the third ply 1506 ultrasonic sealing with a sealant provided by the inner polymer layer 1408. In the first wall region 1502, the first ply 1504 is not joined to the second ply 1505 as these plies face one another with their outer sides from which the outer polymer layer 1403 has been removed by skiving. Rather, the first and second plies face one another with surfaces of the carrier layer 1404. Thus, there is no sealant between the first and second plies which could join those plies to one another in the first wall region 1502. The second wall region 1503 also comprises, as superimposed layers of a second layer sequence in the direction outward from the container interior 1501, the first ply 1504, the second ply 1505, and the third ply 1506. Here, the first ply 1504 has not been skived. Thus, it faces the second ply 1505 with the outer polymer layer 1403. Accordingly, the first ply 1504 has been joined to the second ply 1505 in the second wall region 1503 with a sealant provided by the outer polymer layer 1403 in the second ply 1505. Further, in the second wall region 1503, the second ply 1505 has been joined to the third ply 1506 with a sealant provided by the inner polymer layer 1408 in the second and third plies. As a result of skiving, the carrier layer 1404, in the first wall region 1502, has a greater layer thickness in the third ply 1506 than in each of the first ply 1504 and the second ply 1505. Further, the carrier layer 1404, in the second wall region 1503, has a smaller layer thickness in the second ply 1505 than in each of the first ply 1504 and the third ply 1506. The first ply 1504, on its inner side facing the container interior 1501, has been heat sealed with hot air to the element 701 other than the folded planar composite 805 in the first wall region 1502 and in the second wall region 1503.

FIG. 16 shows a schematic section through the longitudinal seam 401 of the container 1100 of FIG. 11. What has been said about FIG. 15 holds identically for FIG. 16. Here, however, the longitudinal seam 401 is formed by a third wall region 1601 in addition to the first wall region 1502 and the second wall region 1503. This third wall region 1601 comprises, as superimposed layers of a third layer sequence in the direction outward from the container interior 1501, the first ply 1504 and the third ply 1506, but not the second ply 1505. In the third wall region 1601, the first ply 1504 has directly been joined to the third ply 1506 with a sealant provided by the outer polymer layer 1403 in the first ply 1504 and by the inner polymer layer 1408 in the third ply 1506. The third wall region 1601 has a third width 1602 of 3 mm in the circumferential direction 202 of the container 1100. The first ply 1504, on its inner side facing the container interior 1501, has been heat sealed with hot air to one of 4 side walls 705 of the element 701 other than the folded planar composite 805 in the first wall region 1502, the second wall region 1503 and the third wall region 1601. Further, the inner side 1402 of the folded planar composite 805 has also been heat sealed to the other 3 side walls 705 of the element 701 other than the folded planar composite 805 as well as to its sides edges 706.

FIG. 17 shows a flow chart of a process 1700 according to the invention of making a container 1100. In a process step a) 1701, the container precursor 400 of FIG. 4 and the element 701 other than the folded planar composite 805 from FIG. 7a) are provided. In a subsequent process step b) 1702, the inner side 1402 of the folded planar composite 805 is heat sealed to 4 side walls 705 and the 4 side edges 706 of the element 701 other than the folded planar composite 805. For this purpose, the inner polymer layer 1408 of the folded planar composite 805, the 4 first sealant reservoirs 710 and the 4 further sealant reservoirs 711 are softened by heating with hot air to provide a sealant. The process step b) 1702 comprises a first pressing step and a further pressing step. In the first pressing step, opposing sides of the folded planar composite 805 are pressed to side walls 705 of the element 701 other than the folded planar composite 805 at a first contact pressure of 1.7 bar. In FIG. 11, these opposing sides of the folded planar composite 805 are the ones to which the ears 1106 have been sealed. In the further pressing step, the side of the folded planar composite 805 which includes the longitudinal seam 401 and the opposite side are pressed to side walls 705 of the element 701 other than the folded planar composite 805 at a further contact pressure of 2.8 bar. As a result of the heating with hot air and the first and further pressing steps, in each of the first composite region, the second composite region and the third composite region, the inner side of the first ply 1504 of the folded planar composite 805 is joined to one of the 4 side walls 705 of the element 701 other than the folded planar composite 805 to obtain a container, which is still open at its bottom. In order to obtain the container 1100 of FIG. 11, the standing base 1103 needs to be formed and closed by further folding the folded planar composite 805 and sealing folding surfaces of the folded planar composite 805 to one another. This is accomplished in a process step c) 1703.

FIGS. 18a) to 18f) show illustrations of the preparation of a closed container for determining the angle α 211 of a pair of steep edges 1104.

FIG. 19 shows an illustration of the test method for determining the angle α 211 of a pair of steep edges 1104.

FIG. 20 shows a test setup 2000 with a universal tensile testing machine TIRA test 28025 with force transducer 1000 N as measuring device 2001 for determining the compression stability of the container 1100.

FIG. 21 shows a test setup 2100 with a universal tensile testing machine TIRA test 28025 with force transducer 1000 N as measuring device 2001 for determining the grip stiffness of the container 1100. The tensile testing machine was equipped with 2 non-elastic plastic balls 2101 for this purpose. The closed container 1100 was positioned by means of an XY-coordinate table 2102.

FIG. 22 shows a microscope image of a section through the longitudinal seam 401 of the container 1100 of FIG. 11. In addition to what can be seen schematically in FIG. 16, FIG. 22 provides a truncated view on pressing tools 2201 which are used to press the folded planar composite 805 and the element 701 other than the folded planar composite 805 to one another in the further pressing step of the process step b) 1702 of the process 1700 of FIG. 17.

FIGS. 23a) to 23f) show illustrations of a process of preparing the container precursor 400 from the blank 200 of FIG. 2. In FIG. 23a), the planar composite 100 of FIG. 2 in form of a blank 200 is provided. In FIG. 23b), the blank 200 has been skived on the outer side 1401 in the first longitudinal margin 205 with the rotating pot knife of a Model VN 50 from Fortuna Spezialmaschinen GmbH, Weil der Stadt, Germany. Thereby, the carrier layer 1404 has been reduced to half of its thickness. A skived region 2301 has been obtained. In the FIG. 23c), a fold 2302 is introduced in the skived region 2301. Here, part of the skived region 2301 is folded towards the unskived region which is adjacent the skived region 2301. In FIG. 23d), a hem seal has been created by joining the part of the skived region 2301 to the adjacent unskived region via a sealing joint 2303 by hot air sealing. In FIG. 23e), 4 longitudinal folds 2304 have been introduced. These include the first longitudinal fold 402 and the further longitudinal fold 403. In FIG. 23f), further sealing joints 2303 have been created by hot air sealing to join the hem sealed first longitudinal margin 205 to the further longitudinal margin 206, thereby obtaining the longitudinal seam 401. In order to, eventually, obtain the container precursor 400 of FIG. 4, the container precursor 400 in FIG. 23f) can be folded flat along the first longitudinal fold 402 and the further longitudinal fold 403.

FIG. 24 shows a schematic section 2400 through the longitudinal seam 401 of a container not according to the invention.

### LIST OF REFERENCE SIGNS

100 Planar composite/web-shaped laminate
101 First plurality of grooves
102 Further plurality of grooves
200 Planar composite/blank
201 First direction/longitudinal direction of the container
202 Circumferential direction of the container
203 Grooves for forming a head portion
204 Grooves for forming a standing base
205 First longitudinal margin
206 Further longitudinal margin
207 First transverse margin
208 Further transverse margin
209 Head side surface
210 Pair of grooves for forming a pair of steep edges
211 Angle α of the grooves for the pair of steep edges
212 Groove for forming a base edge
213 Longitudinal groove
214 First composite direction
215 Further composite direction
216 Edge of the further transverse margin
217 Auxiliary groove
400 Container precursor
401 Longitudinal seam
402 First longitudinal fold
403 Further longitudinal fold
701 Element other than the folded planar composite
702 Base member
703 Spout
704 Base plate
705 Side wall
706 Side edge
707 Cap
708 Longitudinal direction of the element other than the folded planar composite
709 Circumferential direction of the element other than the folded planar composite
710 First sealant reservoir/lamellae
711 Further sealant reservoir
712 Angle γ between side walls and longitudinal direction
801 Opening aid/cutting ring
802 Angle β between head side surfaces and longitudinal direction
803 Screw thread
804 Pouring aperture
805 Folded planar composite
806 Closure element
1100 Container according to the invention
1101 Container wall
1102 Head portion
1103 Standing base
1104 Pair of steep edges
1105 Base edge
1106 Fold protrusion/ear
1107 Longitudinal edge
1401 Outer side
1402 Inner side
1403 Outer polymer layer
1404 Carrier layer
1405 Intermediate polymer layer
1406 Adhesion promoter layer
1407 Barrier layer
1408 Inner polymer layer
1501 Container interior
1502 First wall region
1503 Second wall region
1504 First ply
1505 Second ply
1506 Third ply
1507 First width
1508 Second width
1601 Third wall region
1602 Third width
1700 Process according to the invention of making a container
1701 Process step a)
1702 Process step b)
1703 Process step c)
1900 Illustration of the test method for determining the angle of the grooves of a pair of steep edges
2000 Test setup for determining the compression stability
2001 Measuring device universal tensile testing machine TIRA test 28025 with force transducer 1000 N
2100 Test setup for determining the grip stiffness
2101 Non-elastic plastic balls
2102 XY-coordinate table
2201 Pressing tool
2301 Skived region
2302 Fold
2303 Sealed joint
2304 Longitudinal fold
2400 Section through longitudinal seam of a container not according to the invention

1. A container comprising
a folded planar composite, and
an element other than the folded planar composite;
wherein the folded planar composite
comprises a carrier layer, and
together with the element other than the folded planar composite forms a container wall at least partially surrounding a container interior;
wherein the container wall comprises a first wall region and a second wall region;
wherein the first wall region comprises, as superimposed layers of a first layer sequence in a direction outward from the container interior, a first ply of the folded planar composite, a second ply of the folded planar composite, and a third ply of the folded planar composite;
wherein the second ply is joined to the third ply in the first wall region;
wherein the second wall region comprises, as superimposed layers of a second layer sequence in the direction outward from the container interior, the first ply, the second ply, and the third ply;
wherein the first ply is joined to the second ply in the second wall region and the second ply is joined to the third ply in the second wall region;
wherein the carrier layer in the first wall region has a greater layer thickness in the third ply than in the first ply, or than in the second ply, or than in each of them;
wherein the carrier layer in the second wall region has a smaller layer thickness in the second ply than in the first ply, or than in the third ply, or than in each of them;
wherein the first ply on its inner side facing the container interior is joined to the element other than the folded planar composite in the first wall region, or in the second wall region, or in each of these two.

2. The container according to claim 1, wherein the layer thickness of the carrier layer in the first ply is smaller in the first wall region than in the second wall region.

3. The container according to claim 1, wherein a minimum layer thickness of the carrier layer in the first wall region in one selected from the group consisting of the first ply, the second ply, and the third ply, or in each ply of a combination of at least two of the foregoing plies, is not more than 50% smaller than a maximum layer thickness of the carrier layer in the same ply of the first wall region, based on said maximum layer thickness.

4. The container according to claim 1, wherein a minimum layer thickness of the carrier layer in the second wall region in one selected from the group consisting of the first ply, the second ply, and the third ply, or in each ply of a combination of at least two of the foregoing plies, is not more than 50% smaller than a maximum layer thickness of the carrier layer in the same ply of the second wall region, based on said maximum layer thickness.

5. The container according to claim 1, wherein the layer thickness of the carrier layer in the first wall region in the third ply is 1.1 to 20-times as high as in the first ply, or in the second ply, or in each of these two.

6. The container according to claim 1, wherein the layer thickness of the carrier layer in the second wall region in the second ply is 0.05 to 0.9-times as high as in the first ply, or in the third ply, or in each of these two.

7. The container according to claim 1, wherein the container wall additionally comprises a third wall region;
wherein the third wall region comprises, as superimposed layers of a third layer sequence in the direction outward from the container interior, the first ply and the third ply;
wherein the first ply is joined to the third ply in the third wall region.

8. The container according to claim 1, wherein the first wall region is adjacent to the second wall region, or the third wall region is adjacent to the second wall region, or both.

9. The container according to claim 1, wherein the element other than the folded planar composite comprises
a base member, and
a spout arranged on the base member.

10. The container according to claim 9, wherein the base member comprises
a base plate, and
at least 3 side walls;
wherein the spout is arranged on a first side of the base plate;
wherein the side walls are arranged on a further side of the base plate opposite to the first side.

11. The container according to claim 10, wherein the side walls are inclined towards each other in a longitudinal direction of the element other than the folded planar composite extending from the base member to the spout;
wherein each of the side walls is at an angle in a range from 55 to 700 to the longitudinal direction.

12. The container according to claim 10, wherein the first ply on its inner side facing the container interior is joined to one of the side walls of the base member in the first wall region, or in the second wall region, or in each of these two.

13. A process comprising as process steps
a) providing
a container precursor comprising a folded planar composite, and
an element other than the folded planar composite;
wherein the folded planar composite comprises
a carrier layer,
a first composite region, and
a second composite region;
wherein the first composite region comprises, as superimposed layers of a first layer sequence in a direction from an inner side of the container precursor to an outer side of the container precursor, a first ply of the folded planar composite, a second ply of the folded planar composite, and a third ply of the folded planar composite;
wherein the second ply is joined to the third ply in the first composite region;
wherein the second composite region comprises, as superimposed layers of a second layer sequence in the direction from the inner side of the container precursor to the outer side of the container precursor, the first ply, the second ply, and the third ply;
wherein the first ply is joined to the second ply in the second composite region and the second ply is joined to the third ply in the second composite region;
wherein the carrier layer in the first composite region has a greater layer thickness in the third ply than in the first ply, or than in the second ply, or than in each of them;
wherein the carrier layer in the second composite region in the second ply has a smaller layer thickness than in the first ply, or than in the third ply, or than in each of them;
b) joining the first ply of the folded planar composite in the first composite region, or in the second composite region, or in each of them, in each case on the inner side of the container precursor, to the element other than the folded planar composite to obtain a container.

14. The process according to claim 13, wherein the folded planar composite and the element other than the folded planar composite in the process step b) are pressed to each other in a first pressing direction at a first contact pressure and in a further pressing direction at a further contact pressure;
wherein the first contact pressure is less than the further contact pressure.

15. A use of a container precursor and an element other than a folded planar composite for producing a foodstuff container;
wherein the container precursor comprises the folded planar composite;
wherein the folded planar composite comprises
a carrier layer
first composite region, and
second composite region;
wherein the first composite region comprises, as superimposed layers of a first layer sequence in a direction from an inner side of the container precursor to an outer side of the container precursor, a first ply of the folded planar composite, a second ply of the folded planar composite, and a third ply of the folded planar composite;
wherein the second ply is joined to the third ply in the first composite region;
wherein the second composite region comprises, as superimposed layers of a second layer sequence in the direction from the inner side of the container precursor to the outer side of the container precursor, the first ply, the second ply, and the third ply;
wherein the first ply is joined to the second ply in the second composite region and the second ply is joined to the third ply in the second composite region;
wherein the carrier layer in the first composite region has a greater layer thickness in the third ply than in the first ply, or than in the second ply, or than in each of them;
wherein the carrier layer in the second composite region in the second ply has a smaller layer thickness than in the first ply, or than in the third ply, or than in each of them.
